(19) United States
(12) Patent Application Publication
(10) Pub. No.: US 2013/0018802 A1
(43) Pub. Date: Jan. 17, 2013

(54) SYSTEM, METHOD, AND COMPUTER-READABLE MEDIA FOR COMMERCIALIZATION OF A PHARMACEUTICAL PRODUCT

(71) Applicant: Liana McCormick, Hoboken, NJ (US)

(72) Inventor: Liana McCormick, Hoboken, NJ (US)

(73) Assignee: PhilyX, LLC

(21) Appl. No.: 13/183,779

(22) Filed: Jul. 15, 2011

(51) Int. Cl. G06Q 10/00

(52) U.S. Cl. 705/301

(57) ABSTRACT

A computer-implemented method, apparatus, and system for commercialization of a pharmaceutical product may be provided. Pharmaceutical product date information, resource name information, and resource allocation may be received. One or more execution dates may be calculated using the received date information. Tasks, milestones, and deliverables may be calculated using multiple stages of pharmaceutical commercialization, one or more execution dates, the resource name information, and the resource allocation information. Linkages between the tasks, the milestones, or the deliverables may be calculated, wherein the linkages may include dependencies, predecessors, or successors that may schedule the commercialization of the pharmaceutical product. A workflow structure may be calculated using the resource name information, tasks, milestones, deliverables, resource allocation information, and the date information. The workflow structure may be customized to accommodate the needs of each product launch, for example.

### BACKGROUND

1. Field of Invention

Embodiments of the present invention relate generally to marketing, and more particularly to a system, method, and/or software designed to assist in commercialization of a pharmaceutical product.

2. Background

Traditional pharmaceutical companies may form silo like structures by favoring division by subject matter expertise whose language, priorities, and success metrics do not necessarily overlap. Yet, to be most successful, pharmaceutical launches should converge functional departments and related activities in a congruent manner.

With pharmaceuticals research and development (R&D) productivity in decline, cost of development on the increase, and fewer products being approved by the Food and Drug Administration (FDA), the pharmaceutical new product launch and the period of up to one year post-launch may represent a critical inflexion point in the life of every pharmaceutical company. The key factors and decisions influencing a product's degree of market penetration may be crafted during the new product launch phase and may have a permanent impact on the lifetime success of a product. The growth rate and market share gained in the first year after launch largely determine the sales that can subsequently be achieved by a pharmaceutical brand. Thus, this period attracts the majority of promotional resources relative to any other year in the lifecycle.

Given the importance of the new product launch in the pharmaceutical industry, pharmaceutical product launches unlike other product launches may have to address multiple target audiences simultaneously, some of them having at times asynchronous goals and criteria. While the launch of a consumer product involves activities connecting the product developer and the consumer at times intermediated through the distribution channel, the launch of a pharmaceutical product may involve the following constituencies: 1) pharmaceutical product developer/the company, 2) regulatory entity (e.g., the FDA), 3) the doctors/hospitals (e.g., prescribers), 4) the patients (users/beneficiaries), 5) managed care organizations/and government (e.g., payers), 6) the distribution channel. The need to conduct numerous activities to address the needs and expectations of these constituencies may turn a pharmaceutical new product launch into a large project with a high degree of complexity, high level of risk, and need for high degree of alignment and coordination.

New pharmaceutical product launches may be characterized by two opposing and equally powerful dynamics. On one end there may be a strict, regimented, and highly regulated set of activities that relate to the FDA regulations, file approval, and product labeling, for example, and on the other the need of high customization of launch components predicated by the needs of the six constituencies mentioned above. To further complicate matters, the hundreds of tasks, milestones, and deliverables that constitute a launch may be executed by a combination of in-house staff, outside vendors, and consultants of varied levels of experience and expertise in new product launches. Not everybody working on a new product launch has experienced one in their career and may not be aware of the launch path and/or best practices.

Given all these high level needs, the team charged with the launch of a pharmaceutical product would benefit from a project organizing method and system that would inform, organize, schedule, track, customize, monitor, and communicate tasks, milestones, and deliverables needed for the successful launch of a pharmaceutical product.

Currently, there are no clear processes or best practice guidelines for pharmaceutical and bio-tech companies to follow as they prepare for a critical new product launch. Furthermore, launch experience may vary from company to company and brand to brand. A successful launch should comprise all the “must have,” and “must execute by the book” activities on one side and the strategically customized activities needed to assure the commercialization objectives of the launch.

### SUMMARY

Currently, there are no clear processes or best practice guidelines for pharmaceutical Aspects of the invention may involve systems, methods, and computer readable medium. In one embodiment, a computer-implemented method for commercialization of a pharmaceutical product may include: receiving pharmaceutical product date information by a computer; receiving pharmaceutical product resource name information by the computer; receiving pharmaceutical product resource allocation information by the computer; calculating, by the computer, one or more execution dates based on the date information; calculating, by the computer, tasks, milestones, and deliverables based on multiple stages of pharmaceutical commercialization, the one or more execution dates, the resource name information, and the resource allocation information; calculating linkages between the tasks, the milestones, or the deliverables, wherein the linkages comprise dependencies, predecessors, or successors to schedule the commercialization of the pharmaceutical product; and calculating, by the computer, a workflow structure using the resource name information, the tasks, the milestones, the deliverables, resource allocation information, and the date information.

In another embodiment, a tangible non-transitory computer-readable storage media for storing computer-executable instructions executable by processing logic may exist. The media may store one or more instructions including: receiving pharmaceutical product data by a computer, wherein the pharmaceutical product data comprises information on pharmaceutical functional areas, dates, and resource name information; calculating, by the computer, tasks, milestones, and deliverables based on multiple stages of pharmaceutical commercialization and the pharmaceutical product data; calculating linkages between the tasks, the milestones, or the deliverables; creating a pharmaceutical commercialization report using the tasks, the milestones, or the deliverables based on specialized pharmaceutical functional areas, wherein the pharmaceutical commercialization report comprises multiple stages of pharmaceutical commercialization and a brand centric approach to the pharmaceutical commercialization; and transmitting the pharmaceutical commercialization report.

In yet another embodiment, a computer-implemented system for managing commercialization of a pharmaceutical product may include: a storage device; an input device configured to receive pharmaceutical product data, wherein the pharmaceutical product data comprises pharmaceutical dates and pharmaceutical product name information based on pharmaceutical functional areas; a processor configured to: calculate tasks, milestones, or deliverables based on multiple stages of pharmaceutical commercialization and the pharmaceutical product data; calculate dependencies or predecessors between the tasks, the milestones, or the deliverables to execute the commercialization of the pharmaceutical product; calculate a timeline using the tasks, the milestones, or the deliverables based on pharmaceutical dates; calculate a pharmaceutical commercialization report using the tasks, the milestones, or the deliverables based on a stage of commercialization of the multiple stages of pharmaceutical commercialization and pharmaceutical functional area; and an output device configured to display a visual representation of the commercialization of the pharmaceutical product depicting the stage of commercialization.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 depicts an example processing system configured to practice an illustrative embodiment for commercialization of a pharmaceutical product;

FIG. 2 depicts an example computer screen shot illustrating an example project screen;

FIG. 3 depicts an example computer screen shot illustrating an example owner screen;

FIG. 4 depicts an example computer screen shot illustrating an example dashboard screen;

FIG. 5 depicts an example workflow for use with an illustrative method of providing commercialization of a pharmaceutical product;

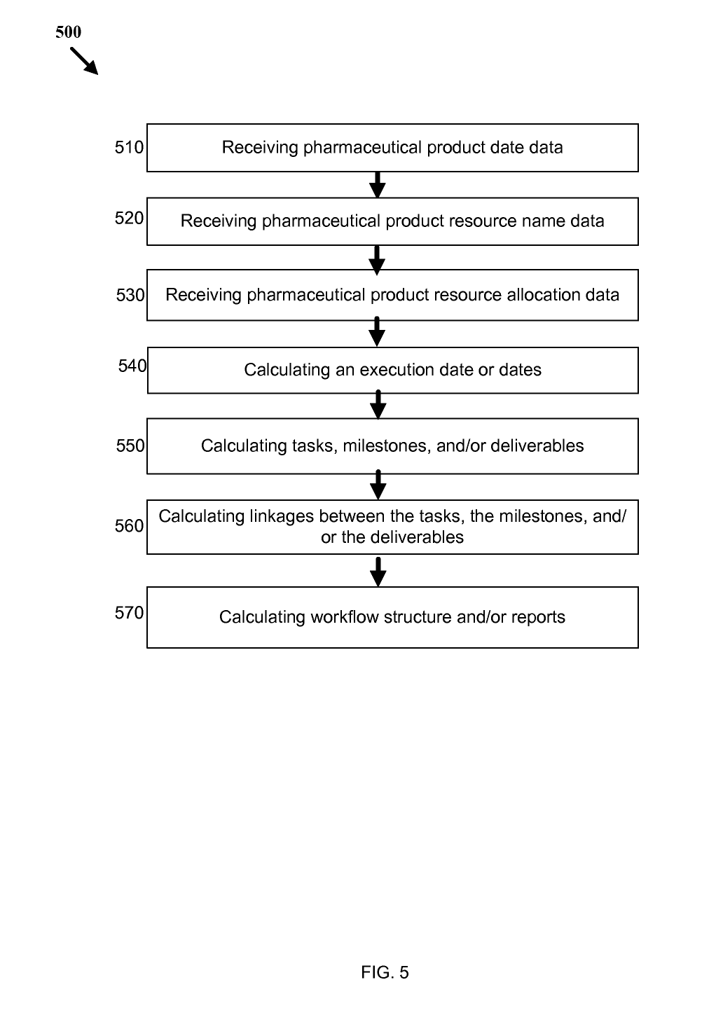

FIG. 6 depicts an example computer system configured to practice an illustrative embodiment for commercialization of a pharmaceutical product.

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples. The term “product” may refer to both products and services.

Introduction

Traditional pharmaceutical companies may insulate each department (e.g., marketing, regulatory, sales, research and development, communications, medical affairs, managed markets, supply chain, etc.) and therefore may have a silo approach to commercialization of a pharmaceutical product. Such a silo structure may favor division by subject matter expertise whose language, priorities, and/or success metrics may not overlap. Yet, for a pharmaceutical product launch to be efficient and successful all functional departments and related activities may need to converge in a congruent manner.

To further complicate matters, there may be an absence of pharmaceutical specific, user-friendly tools or platforms that would assist and integrate the hundreds of activities in a comprehensive, cohesive, and seamless manner.

In an embodiment of the current invention, proprietary customized software, for example, may be provided, which may provide assistance in the commercialization of pharmaceutical products. The software, for example, may be based on personal, practical, and/or comprehensive launch experience. The functionality of the software may be driven through, for example, a graphical user interface (GUI) such as a dashboard that may give access to the various functions of the launch software. The launch software may be stored or executed, for example, on an FTP site, hard drive, company server, web server, or cloud computing platform.

The software may be customized for the pharmaceutical industry to be used by, for example, a dedicated project manager or leader to plan, direct, examine, communicate with, and/or monitor the project team involved in pharmaceutical product commercialization activities such as launch, re-launch, new product indications, line extensions, pharmaceutical repositioning, business development, etc.

In one embodiment, pharmaceutical launch, re-launch, brand extension, brand related special project related tasks, milestones, and/or deliverables may be laid out horizontally in a brand-centric manner, for example. The progression may be, for example, from strategic to operational.

Tasks, milestones, and/or deliverables that may be specific to pharmaceutical products and industry, may be layered vertically from task, milestone, deliverable to subtasks and subcomponents in a succession that is specific to the pharmaceutical industry and may be determined by a regulatory processes.

Tasks, milestones and/or deliverables may be a pre-packaged launch kit or may be customized to adjust to the specific launch processes and resources of the individual company, for example.

Tasks, milestones and/or deliverables may be interlinked to help manage complexity and to comply with particular government (e.g. Federal Drug Administration (FDA)) rules and/or internal company policies and/or procedures. The interlinking may be configurable to adjust and adapt to new rules, regulations, and/or policy changes.

Timelines may be clearly defined and designed to optimize the timeliness in spite of complexity. Timelines may be adopted as a pre-packaged launch kit or may be customized to a specific company.

Single subject matter expert (SME) or cross-functional accountability may be assigned to each task, milestone, and/or deliverable. Entering an SME name may associate certain tasks, milestones, and/or deliverables with the entered SME.

A project manager may track a completion level for each tasks, milestone and/or deliverable and may enter in data and/or receive data for reporting purposes. Managers may also be able to update the current status of task, milestones, and/or deliverables (activities) based on delays or acceleration in activities. Delays may be caused by unforeseen events such as weather related disturbances regulatory delays, publication delays, organizational priorities and inefficiencies, manufacturing delays, budgetary restrictions, etc. Updating current activities may cause all future activities to reflect the change and adjust accordingly.

Reports and project related analytics may be generated for personnel such as project team and executive level staff.

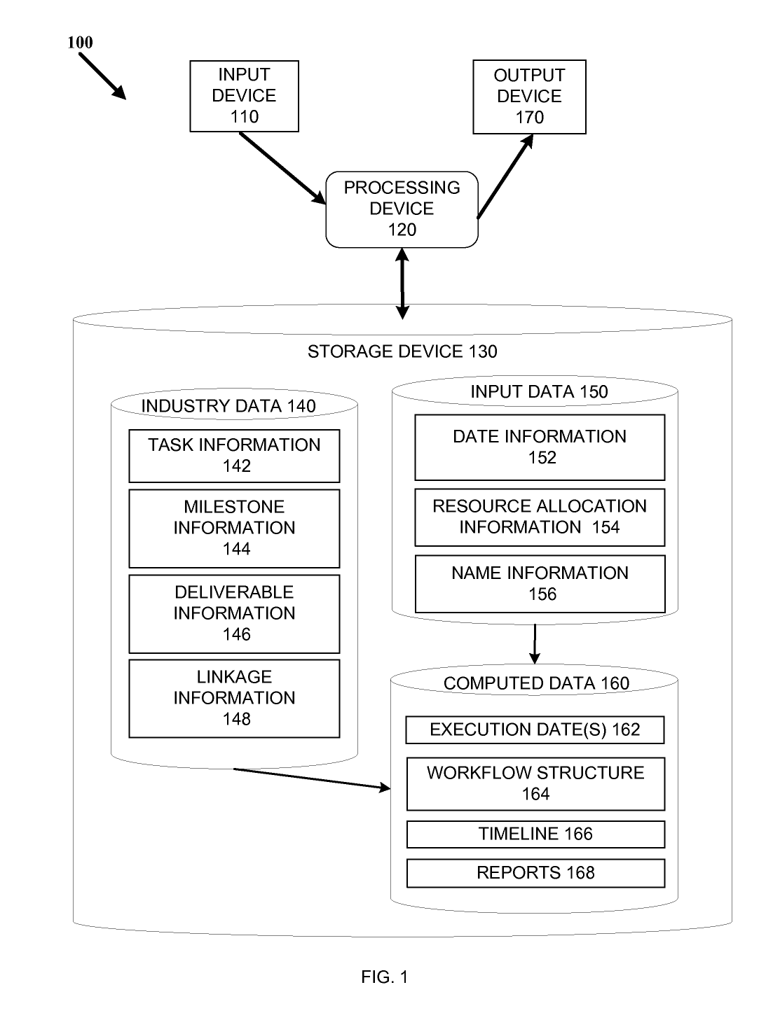

FIG. 1 illustrates example processing system 100 configured to practice an illustrative embodiment for commercialization of a pharmaceutical product. In the illustrative embodiment of FIG. 1, system 100 may include input device 110, processing device 120, storage device 130, and/or output device 170. Storage device 130 may contain industry data 140 (also referred to as multiple stages of pharmaceutical commercialization), input data 150, and/or computed data 160.

Industry data 140 may include, for example, task information 142, milestone information 144, deliverable information 146, and/or linkage information 148. Task information 142, milestone information 144, and/or deliverable information 146 may contain names, duration, and default resource names. Linkage information 144 may associate dependencies, successor, predecessors of tasks, milestones, and/or dependencies and may associate default resource names with tasks, milestones, and/or dependencies.

Input data 150 may include, for example, date information 152, resource allocation information 154, and/or name information 156.

Computed data 160 may include, for example, execution date 162, workflow structure 164, timeline 166, and/or reports 168.

Input device 110 may include a device for providing inputs to processing device 120. For example, input device 110 may receive input from a user or another device. Input device 110 may include, for example, a keyboard, track ball, touch sensitive display, haptic device, microphone, human-computer interface, etc.

Processing device 120 may include logic configured to execute computer-executable instructions that implement illustrative embodiments. The instructions may reside in storage device 130. An example processing device that may be used includes, but is not limited to, the Pentium processor available from Intel Corporation, Santa Clara, Calif.

Output device 170 may include a device for providing outputs from processing device 120. Output device 170 may include, for example, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), tactile devices, haptic devices, audio speakers, etc. Alternatively, output device 170 may include a transmission device to transmit data to another system or display screen.

Storage device 130 may include one or more tangible non-transitory computer-readable media that may be configured to store instructions configured to implement illustrative embodiments of the invention. Storage 130 may be a primary storage accessible to processor 120 and may include a random-access memory (RAM) that may include RAM devices, such as, for example, Dynamic RAM (DRAM) devices, flash memory devices, Static RAM (SRAM) devices, etc. Storage device 130 may also include a secondary storage device such as a magnetic disk (e.g., hard disk) and/or optical disk and its corresponding drive for storing information and/or instructions.

Input device 110 may allow, for example, input of date information 152. Date information may include, for example, a project start date, a new drug application (NDA) date, a prescription drug user fee act date (PDUFA), a product launch date, and/or a duration of time between two of more tasks, milestones, or deliverables.

Input device 110 may also allow input of, for example, resource allocation information 154. Resource allocation information 154 may include, for example, pharmaceutical product launch funding information, company resource information, company funding information, and/or company personnel information.

Input device 110 may also allow input of, for example, name information 156. Name information 156 may include, for example, project title, subproject title, product name, company name, project leader name, subproject director names, resource names, and/or manager names.

Once input data 150, for example, has been received, processing device 120 may use industry data 140 along with input data 150 to create computed data 160, for example.

Input device 110 may receive updates to information stored in storage device 130. Updated information may include updates to, for example, industry data 140 or input data 150. Processing device 120 may verify the updates and may alter the data stored in storage device 130 with the updated data. Once updates are complete, processing device 120 may re-create or update computed data 160, for example.

Input device 110 may receive a request for information. Processing device 120 may analyze the request for information and may provide the requested content from or using computed data 160. Processing device 120 may transmit, using output device 170, computed data 160 such as workflow structure 164, timeline 166, execution date, 162, and/or reports 166. Additionally, processing device 120 may present general reports, results, and/or appraisals using output device 170.

Alternatively, input device 110 and output device 170 may be remote to processing system 100. Processing device 120 may receive data, as described above regarding input device 110, from a remote location, for example. Processing device 120 may transmit data, such as described above with regards to output device 170, to a remote location, for example. Input device 110 may receive data over a network, for example. Output device 170 may transmit data over a network, for example.

### Illustrative Examples

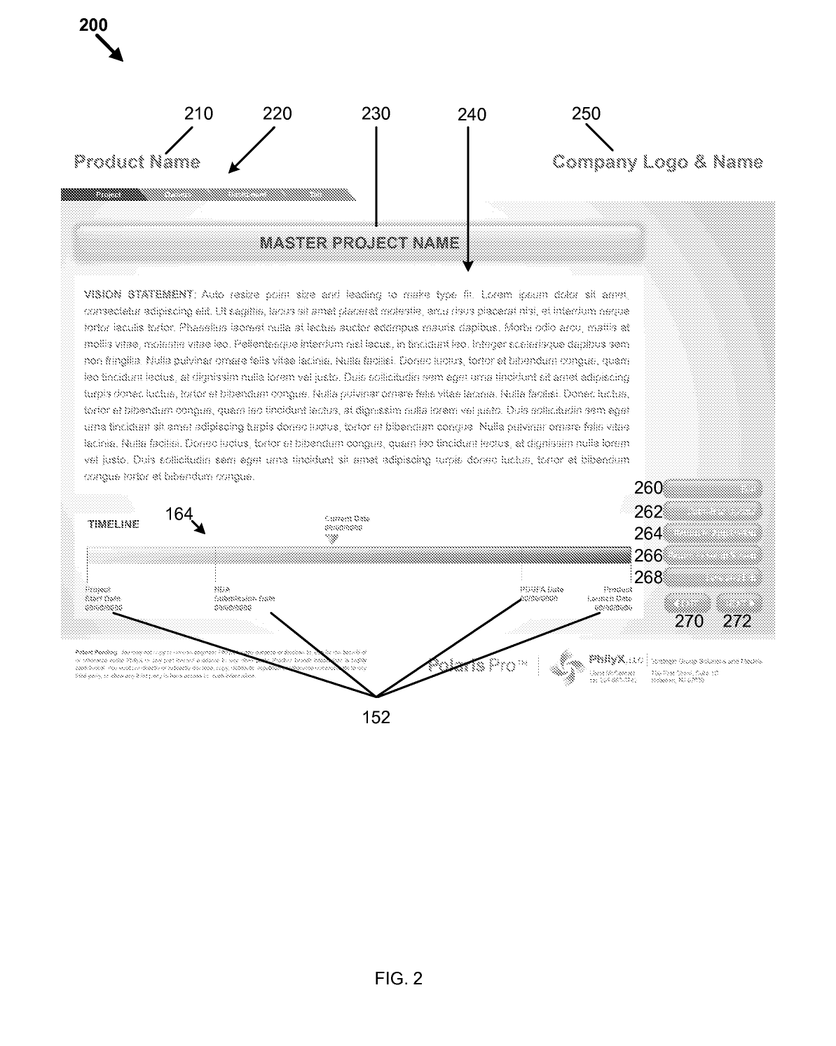

FIG. 2 depicts an example computer screen shot illustrating an example project screen 200. The project screen 200 may display product name 210, tab bar 220, master project name 230, vision statement 240, company logo and/or name 250. Project screen 200 may also display a visual representation of timeline 164. Visual timeline 164 may depict key tasks, milestones, and/or deliverables such as dates 152 (e.g., project start date, NDA submission date, PDUFA date, product launch date, etc.).

Project screen 200 may also contain navigation Buttons such as edit 260, submit to update 262, return to application 264, return to setup screen 266, save and exit 268, exit 270 and/or next 272.

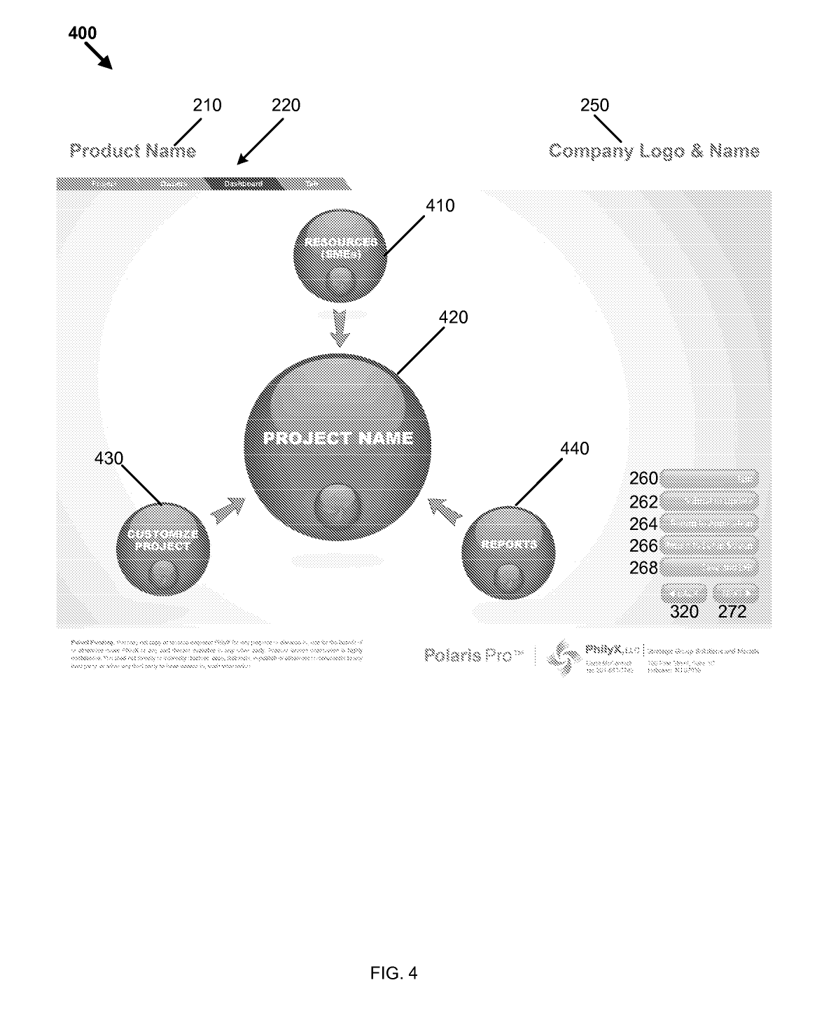

Edit 260 command button, when clicked, may display the dashboard screen (see FIG. 4) for access to specific (sub) project files, reports and resource modification and addition. Next 272 command button when clicked may display the next screen. The next screen may be, for example, dashboard Screen (see, FIG. 4, 400). The “next screen” button allows the user to move to the next screen and is akin to a forward arrow symbol. Exit 270 command button when clicked may close the application. Save and exit 268, when clicked, may save the current work and the open sub project files and then close the application.

Prior to project screen 200, a project setup screen may allow a system administrator or their designee to enter, modify and validate data required to initiate or modify specific project data, for example. Completion of the project setup screen worksheet may update the date fields (e.g., project start date, NDA submission date, PDUFA date, the product launch date, etc.), provide name information and logos (e.g., project, product, company, etc.) for display, and/or may identify key project personnel. The system administrator or one or more designated users may have exclusive access to the setup screen

Data entry fields may appear on the setup screen and may be completed when the user clicks on a save or submit button, for example. The setup screen may allow input of the following: project name, project launch date, NDA submission Date, PDUFA date, product launch date, product name, sponsoring company name, specific company logo, vision statement, names of Project Executive Sponsors, and/or names of sub project sponsors.

Once the project launch date is entered, the data may be copied to, for example, the start field of the following activities: Brand, at Activity 1, Communications at Activity 1, Managed Markets at Activity 1, Medical Affairs (e.g., Medical Activities and Publications) at Activity 1, Regulatory at Activity 1, Supply Chain at Activity 1, and/or Sales, Activity 1, for example (see Tables 1-7).

Once the NDA submission date is entered, the data may be copied to, for example, the start field of the following activities: Brand, at Activity 2, Communications at Activity 2, Managed Markets at Activity 2, Medical Affairs at Activity 2, Regulatory at Activity 2, Supply Chain at Activity 2, and/or Sales, Activity 2, for example (see Tables 1-7).

Once the PDUFA date is entered, the data may be copied to, for example, the start field of the following activities: Brand, at Activity 3, Communications at Activity 3, Managed Markets at Activity 3, Medical Affairs at Activity 3, Regulatory at Activity 3, Supply Chain at Activity 3, and/or Sales, Activity 3, for example (see Tables 1-7).

Once the product launch date is entered, the data may be copied to, for example, the start field of the following activities: Brand, at Activity 4, Communications at Activity 4, Managed Markets at Activity 4, Medical Affairs at Activity 4, Supply Chain at Activity 4, and/or Sales, Activity 4, for example (see Tables 1-4 and 6-7).

Once the product name is entered, the data may be displayed in the project screen 200, owners screen 300, dashboard screen 400, and/or report screens, for example.

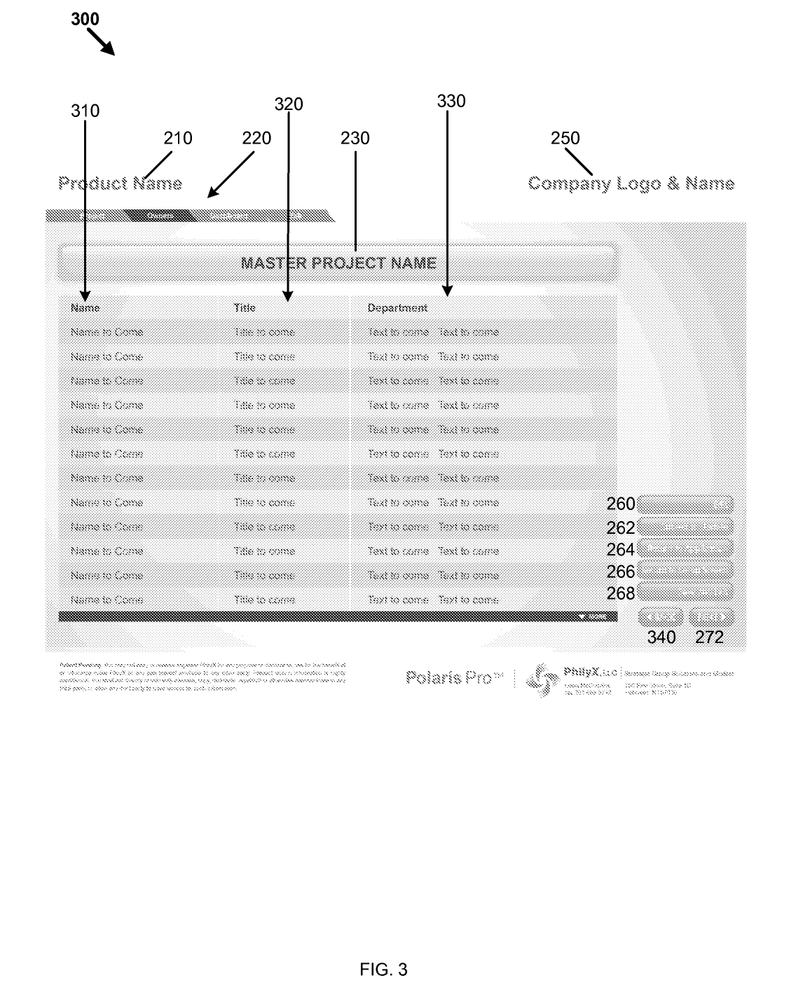

Once the sponsoring company name is entered, the data may be displayed in the project screen 200, owners screen 300 (FIG. 3), dashboard screen 400 (FIG. 4), and/or report screens, for example.

Once the specific company logo is entered, the data may be displayed in the project screen 200, owners screen 300, dashboard screen 400, and/or report screens, for example.

Once the vision statement is entered, the data may be displayed in the project screen 200.

Once the names of project executive sponsors and sub project sponsors are entered, the data may be displayed as a text table with three columns and at least two rows. The three columns may be, for example, name, title, and department. As there may be more than two key personnel (e.g., Directors, Sub Project Managers, etc.), the number of rows expands as names are added. The table may be displayed in the owners screen 300.

Once the entry fields on the setup screen have been completed, the system administrator or delegated user may click on one of four command buttons.

The four command buttons may include save and continue, clear, cancel and close, and save and close. The save and continue button may update and save the sub project files using the data on the setup worksheet and move the system administrator or delegated user to project screen 200. The clear command button may remove the data on the setup worksheet and may move the cursor to the first field on the setup worksheet to reenter all of the data. The cancel and close command button may clear the data from the setup worksheet and close the application without saving any data. The save and close command button may update the data and save and close the sub project files, save and close the form, and exit the application.

FIG. 3 depicts an example computer screen shot illustrating an example owner screen 300. Owner screen 300 may contain a list of project directors and executive sponsors. Owner screen 300 may show a name column 310, a title column 320, and/or a department column 330. Additionally, owner screen 300 may also have a back button 340, which may move the user to the previous screen. Owner screen 300 may emphasize the cross-functional nature and the high organizational visibility of a pharmaceutical new product launch. It may also illustrate the importance of the launch to the organization as accountability and ownership ultimately resides at the functional leader level in the organization. Owner screen 300 may display the names of the directors and vice-presidents, for example, in the organization whose subject matter experts have been delegated to execute the project.

FIG. 4 depicts an example computer screen shot illustrating an example dashboard screen 400. Dashboard screen 400 may have resources button 410, center button 420, customize project button 430 and reports button 440. Dashboard screen 400, may allow a user to, for example, manage the sub project files, access reports, change or add resources, access the master project, etc. Dashboard screen 400 may be made up of buttons that allow certain functions of the software to take place. For example, some buttons may reveal information stored such as the center button 420, while others may allow customization like the resource button 410 where resource names may be changed from generic to specific people names.

Resources button 410, may allow a user to add, edit, or remove resources such as a subject matter expert (SME). For example, specific names of each resource category may be entered. The specific names for each resource category may correspond to individuals who may be responsible for the task, milestone, and/or deliverable (activity). The user may be prompted to enter a resource name for each generic resource currently available in the master project. The master project may be the base project or blueprint contained in an embodiment of the invention (e.g., Polaris Pro™) before customization may take place. For example the master project may have a generic resource identified as “Medical Director,” but an embodiment of the invention may allow a specific medical director inside a specific company to be added to each activity that may require a medical director. Once a resource name is entered, the master project may automatically associate the entered name with activities where that resource may be required. By associating names with the activities, ownership of the activity may be established and may be visually seen through reports.

When a user clicks on resources button 410 the resource pool file may be opened in the resource view and displayed in the update resource table view. Additionally, navigation buttons may appear on the bottom right corner of the screen. The resource pool file may be a separate customizable file containing a table of generic functional roles that are typically part of a pharmaceutical product launch such as a “Medical Director” “Ad Agency” etc. The resource view may include a table and may allow a project manager, for example, to customize the resource pool file. The updated resource table view may include, for example, a generic resource name, as data (e.g., field: name), a generic resource name, as text (e.g., field: text 3), a sub team name, and/or as data (e.g., field: group).

When the resources button 410 is pressed and the table is displayed, a text balloon to the right of the table, for example, may appear. The text balloon may contain text such as:
i. “To change a resource name from the Generic Name to a Project Specific name overwrite the Generic Name with the Project Specific name and if needed change the Sub Team Name.”
ii. “To add a new resource scroll to the first blank resource record, and enter the name of the new Resource Name, the Generic Resource Name and Sub Project Team of the new resource.”
iii. “As a resource name is changed or a new resource is added in one project sub file it is automatically added to the Shared Resource Pool and is available to each project.”

The user may change, for example, the resource name. Once the resource name has been changed, the resource name change may be updated and the dialog box may close. The sub project file may be saved and closed using the navigation buttons at the bottom right of the screen, for example. Once complete, the user may return to dashboard screen 400.

Center button 420, may allow a user to access the master project. Center button 420 may contain the project in its entirety. The project is organized in sub-files that may contain the activities of each functional area (i.e., Regulatory, Supply chain, Medical affairs, etc) center button 420 may allow a user to get to the entire master project where all the activities appear together. (e.g., in the form of a Master Project, “Polaris Pro™ Integrated Product Launch Project”). For example, when center button 420 is selected a file such as the “Polaris Pro™ Integrated Product Launch Project” may open and the user may open any or all of the files for edit and review. Center button 420 navigation screen may the following command buttons:

1. “Save and Return” to save the current work and return to the dashboard screen 400.

2. “Save and Close” to save the current work and close the file and close the application.

3. “Exit without saving” Command Button: On Click application is closed and not saved.

Customize project button 430, may allow a user to access sub project files directly for editing and customization, for example. After clicking the customize project button 430, a dialog box may appear with a list of project sub files. The user may click on a file name. The file may open and the user may have access to the file, by default the files may be opened using a shared resource sheet, for example. Additionally, the navigation screen may appear in the bottom right corner of the screen while the user is editing the sub project file, for example. The sub project file may be displayed in the task view using, for example, Polaris Pro™ Entry Table for this function. The Entry Table may be a table listing all the project sub-files or (functional sub-files) which may allow a user to access the sub-folder needed for customization, for example.

Through the customize project button 430, a user may be able to access individual subprojects, modify activities, modify dates, modify duration, modify predecessors, modify actual task completion percentage, modify task assigned total budget, etc.

The navigation screen may appear on the lower right corner of the screen while the user is working directly with the sub project files. The navigation screen may replace dashboard Screen 400. After pressing customize project button 430, a navigation screen may display the following command buttons:

1. “Save and Return” to save the current work and return to dashboard screen 400

2. “Save and Close,” to save the current work and close the file and close the application

Reports button 440, may allow a user to generate new reports and/or view existing reports. When reports button 440 is pressed, a reports screen may appear. The reports screen may be, for example, the access page for reports. In one embodiment, the reports screen may supply a table of available reports and a user may be able to select one or more reports for display or to transmit via, for example, email. In another embodiment, the reports screen may contain a list box populated with the names of the sub project files, for example. On click, the list button may open a list of all of the sub project files. The user may select a file name from the list and the file may be opened in the background, for example. The user may move the cursor to a report name and select a report from the Report Name text list box, for example. As the user moves the cursor to a report name, the report may illuminate and a thumbnail view of the report may appear (e.g., a Microsoft PowerPoint screen shot of a generic sample of the report). On click, the report parameters dialog boxes may be generated (e.g., as an inherent MS-Project functionality, for example). The report may then be prepared. The user may select the “Print” command button to print the report or “Close Report w/o Printing” command button to close the report without printing, for example. The reports button 440 navigation screen may also display the following command buttons:

1. “Back” Command Button: On Click move the User to the previous screen

2. “Exit” Command Button: On Click application is closed

3. “Save and Exit” Command Button: On Click the current work is saved and the open Sub Project Files are saved and closed.

Reports button 440 may provide the following types of reports, tracking Gantt chart, spotlight report, current activities, what should start in the next time frame (e.g., one week, two weeks, one month, two months, etc), what is late, baseline vs. actual, work portfolio by subject matter expert, work portfolio by sub team, etc.

Tables 8-12 depict example reports which may vary depending on the current status of the commercialization of the pharmaceutical product. For example, table 8 depicts a late to finish report, which may be run to determine which activities will not or did not complete on schedule. Such a report may show, for example, the activity name, the start date, the projected or actual finish date, the current percentage of work completed, and/or the resource names.

Table 9 depicts a late to start report, which may be run to determine which activities did not start on schedule. Such a report may show, for example, the activity name, the duration time, the projected or actual start date, the projected or actual finish date, and/or the resource names.

Table 10 depicts a work portfolio report by subject matter expert (SME), which may be run to provide detail on the activities handled by particular SMEs. Such a report may show, for example, the SME and the projected or actual start and finish dates of the first and last activity that the SME is responsible for as well as the total percent of work completed by the SME. Additionally, activities of the SME may also be displayed showing the projected or actual start and finish dates as well as the percent work complete for that activity.

Table 11 depicts a work starting in the next two weeks report, which may be run to provide detail on activities that are scheduled to start in the next two weeks. Such a report may show, for example, the activity name, the duration time, the projected start date, the projected finish date, and/or the resource names.

Table 12 depicts a spotlight report, which may be run to provide a graphic representation of the percent of work complete. The graphic representation of a spotlight may be in the form of a color, for example. In one embodiment, for example, where the work complete percentage is low the color may be red, indicating a possible problem. Colors may shift, for example, from red (possibly indicating an issue), to yellow (indicating less of an issue), to green indicating that the work is complete. The color key may be provided and may be customizable for the particular company or report audience. In addition to a spotlight graphic, the report may also show, for example, the activity name, the projected or actual start date, the projected or actual finish date, the percentage of work complete, and/or the resource names.

Reports may be displayed or transmitted. Reports may be transmitted via, for example, email. Displayed reports may be selectable for copying and pasting into other applications, for example. Reports may be displayed such that the user may zoom in and out to achieve the desired perspective and detail.

In one embodiment, the system may be tied into an alerting mechanism. For example, at the triggering of an event (e.g., an approaching deadline), the resource name or names associated with the triggered activity may be alerted. Such alert may be sent electronically via email, telephonically, facsimile, simple messaging service (SMS), etc.

Example Workflow

An embodiment of the invention may provide a computer system providing for commercialization of a pharmaceutical product, comprising some or all of the following components:

Pharmaceutical product dates may be a limited number of user entered dates from which a set of dates for tasks, milestones, and/or deliverables may be created. In other words, given several initial dates, a timeline and/or workflow structure may be created using developed time and duration between tasks, milestones, and/or deliverables. The pharmaceutical product dates may include, for example, a project start date, a new drug application (NDA) date, a prescription drug user fee act date (PDUFA), and/or a product launch date.

The execution date may be calculated from the dates. Execution date may be the date or time period when a task, milestone and/or deliverable is to be executed according to the project activities sequencing needs. In one embodiment, the execution date is the date when a task, milestone and/or deliverable has to be executed.

Multiple stages of pharmaceutical commercialization may include a set of data that includes recommended tasks, milestones, and/or deliverables (activities), the linkages between each activity (e.g., the dependencies, predecessors and/or successors of each activity, concurrent activities, etc), the time for each activity, the duration between the activities, etc. Broadly accepted practices may also contain default resource names associated with activities. The multiple stages of pharmaceutical commercialization are those activities, processes, and steps taken by a pharmaceutical company in the course of a product launch to address the three critical factors of the launch: clinical competitiveness, marketplace dynamics, and promotional tactics. The approximately 1500 activities contained in an embodiment such as Polaris Pro™, for example, their sequencing and linkages reflect experience driven multiple stages of pharmaceutical commercialization and broadly accepted practices. For example, see tables 1-7.

Resource names may include, for example, project title, subproject title, product name, company name, project leader name, subproject director names, and/or manager names. Furthermore, resource names may be associated with one or more activities.

Workflow structure may include the activities organized chronologically by date. Workflow structure may include the entries that make up the sub-files as shown in tables 1-7. Also called work breakdown structure (WBS) in project management lingo.

Commercialization may include, for example, launching a pharmaceutical product, pharmaceutical product strategy change, a line extension of the pharmaceutical product, a new indication for the pharmaceutical product, etc.

Resource allocation information may include, for example, pharmaceutical product launch funding information, company resource information, company funding information, company personnel information, etc.

Pharmaceutical functional areas may include, for example, brand management, sales, compliance, medical affairs, regulatory affairs, communications, managed markets supply chain, etc.

Brand centric approach may refer to viewing the pharmaceutical product from the consumer perspective and not necessarily from any particular functional area.

Tasks may include, for example, develop target product profile, develop patient treatment flow, develop market map, national advisory boards, brand plan, clinical publications planning; conventions strategy, events strategy, etc.

Milestones may include, for example, brand name, government approval of product labeling, product launch meeting, sales force training, sales force certification, quality controlled (QCed) product available for distribution, product approval press release, etc.

Deliverables may include, for example, publications of pivotal studies, promotional visual aid, journal ads, pharmacy monograph, speaker bureau presentation deck, mechanism of action video, distribution channel sell sheets, etc.

An example high-level workflow is shown in FIG. 5500. Pharmaceutical product date data may be received (block 510). The date data may include a project start date, a new drug application (NDA) date, a prescription drug user fee act date (PDUFA), and/or a product launch date, for example. Pharmaceutical product date data may be received via input device 110, for example.

Pharmaceutical product resource name data may be received (block 520). Resource name data may include, for example, project title, subproject title, product name, company name, project leader name, subproject director names, and/or manager names. The name data may be used later in assigning responsibility to various tasks, milestones, and/or deliverables. Pharmaceutical product resource name data may be received via input device 110, for example.

Pharmaceutical product resource allocation data may be received (block 530). Resource allocation data may include, for example, pharmaceutical product launch funding information, company resource information, company funding information, company personnel information, etc. In other words, the resource allocation data may be an amount of resources (e.g., personnel, financial, etc.) that a company, for example, may be able and/or willing to allocate to various tasks, milestones, and/or deliverables (activities). If, for example, a company is willing to dedicate a large amount of financial resources into a particular activity, that activity may have a lower duration of time compared to a company that invests a typical amount of financial resources. On the other hand, a company that indicates a lower investment of resources into a particular activity, may cause the activity time duration to increase. Pharmaceutical product resource allocation data may be received via input device 110, for example.

An execution date may be calculated (block 540). The execution date may be calculated by factoring in the number of days needed to execute the activity added to the start day and potentially determined by the predecessor or successor activity if a predecessor/successor activity is indicated. Execution date may be calculated via processing device 120. Multiple execution dates may be calculated for multiple activities.

Tasks, milestones, and/or deliverables may be calculated (block 550). Using pharmaceutical industry data 140 (e.g., multiple stages of pharmaceutical commercialization), the execution date(s) 162 calculated in block 540, the resource name data 156 received in block 520, and the resource allocation data 154 received in block 530, tasks, milestones, and/or deliverables (activities) may be calculated. The tasks, milestones, and/or deliverables may be calculated via processing device 120.

Linkages between the tasks, milestones, and/or deliverables may be calculated (block 560). The activities may be linked, for example, to execute the commercialization of the pharmaceutical product. For example, the linking of the activities may be based on multiple stages of pharmaceutical commercialization. The linkages may include dependencies, predecessors, and/or successors to create a schedule for commercialization of the pharmaceutical product. The linkages may be calculated via processing device 120.

A workflow structure 164 and/or reports 168 may be calculated (block 570). The workflow structure 164 and/or reports 168 may be calculated using the tasks, milestones, and/or deliverables calculated in block 550, the date data 152 received in block 510, the resource allocation data 154 received in block 530, and the resource name data 156 received in 520. For example, the workflow structure 164 may assign one or more resource names 156 to one or more activities. The workflow structure 164 may be arranged chronologically by date, for example. Alternatively, the workflow structure 164 may be sorted and/or viewed by pharmaceutical functional area, for example. Workflow structure may be calculated via processing device 120. One or more reports 168 may be created based on workflow structure 164. Reports 168 may display data, such as the tasks, milestones, and/or deliverables, according to various criteria.

The workflow structure 164 and/or one or more reports 168 may be transmitted. Workflow structure 164 and/or one or more reports 168 may be transmitted to output device 170 or may be transmitted to another device via a network.

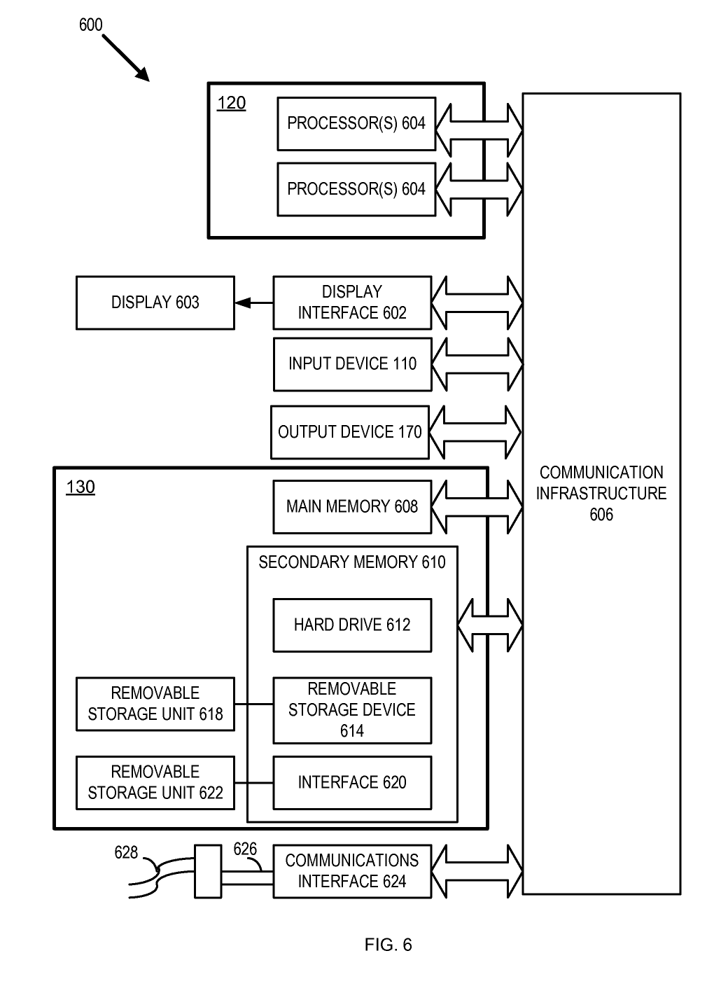

FIG. 6 depicts an illustrative computer system that may be used in implementing an illustrative embodiment of the present invention. Specifically, FIG. 6 depicts an illustrative embodiment of a computer system 600 that may be used in computing devices such as, e.g., but not limited to, standalone or client or server devices. FIG. 6 depicts an illustrative embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 600 is shown in FIG. 6, depicting an illustrative embodiment of a block diagram of an illustrative computer system useful for implementing the present invention. Specifically, FIG. 6 illustrates an example computer 600, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/etc. available from MICROSOFT® Corporation of Redmond, Wash., U.S.A. or an Apple computer executing MAC® OS from Apple® of Cupertino, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 600 is shown in FIG. 6. Other components of the invention, such as, e.g., (but not limited to) a computing device, a communications device, a telephone, a personal digital assistant (PDA), an iPhone, a 3G wireless device, a wireless device, a personal computer (PC), a handheld PC, a laptop computer, a digital notepad, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 6. In an illustrative embodiment, services may be provided on demand using, e.g., an interactive television device (iTV), a video on demand system (VOD), via a digital video recorder (DVR), and/or other on demand viewing system.

The computer system 600 may include one or more processors, such as, e.g., but not limited to, processor(s) 604. Processor(s) 604 may be connected to a communication infrastructure 606 (e.g., but not limited to, a communications bus, cross-over bar, interconnect, or network, etc.). Processor 604 may include any type of processor, microprocessor, or processing logic that may interpret and execute instructions (e.g., for example, a field programmable gate array (FPGA)). Processor 604 may comprise a single device (e.g., for example, a single core) and/or a group of devices (e.g., multi-core). Processing device 120 may include processor(s) 604. Processor 604 may include logic configured to execute computer-executable instructions configured to implement one or more embodiments. The instructions may reside in main memory 608, secondary memory 610. Storage device 130 may include main memory 608 and/or secondary memory 610. Processors 604 may also include multiple independent cores, such as a dual-core processor or a multi-core processor. Processors 604 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

Computer system 600 may include a display interface 602 that may forward, e.g., but not limited to, graphics, text, and other data, etc., from the communication infrastructure 606 (or from a frame buffer, etc., not shown) for display on the display unit 603. The display unit 603 may be, for example, a television, a computer monitor, or a mobile phone screen. The output may also be provided as sound through a speaker. Output device 170 may include display interface 602 and/or display unit 603.

The computer system 600 may also include, e.g., but is not limited to, a main memory 608, random access memory (RAM), and a secondary memory 610, etc. Main memory 608, random access memory (RAM), and a secondary memory 610, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc. Storage device 130 may include main memory 608, random access memory (RAM), and a secondary memory 610, etc.

The secondary memory 610 may include, for example, (but is not limited to) a hard disk drive 612 and/or a removable storage drive 614, representing a floppy diskette drive, a magnetic tape drive, an optical disk drive, a compact disk drive CD-ROM, flash memory, etc. The removable storage drive 614 may, e.g., but is not limited to, read from and/or write to a removable storage unit 618 in a well known manner. Removable storage unit 618, also called a program storage device or a computer program product, may represent, e.g., but is not limited to, a floppy disk, magnetic tape, optical disk, compact disk, etc. which may be read from and written to removable storage drive 614. As will be appreciated, the removable storage unit 618 may include a computer usable storage medium having stored therein computer software and/or data.

In alternative illustrative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 622 and interfaces 620, which may allow software and data to be transferred from the removable storage unit 622 to computer system 600.

Computer 600 may also include an input device 110 which may include any mechanism or combination of mechanisms that may permit information to be input into computer system 600 from, e.g., a user. Input device 110 may include logic configured to receive information for computer system 600 from, e.g. a user. Examples of input device 101 may include, e.g., but not limited to, a mouse, pen-based pointing device, or other pointing device such as a digitizer, a touch sensitive display device, and/or a keyboard or other data entry device (none of which are labeled). Other input devices 101 may include, e.g., but not limited to, a biometric input device, a video source, an audio source, a microphone, a web cam, a video camera, and/or other camera.

Computer 600 may also include output devices 170 which may include any mechanism or combination of mechanisms that may output information from computer system 600. Output device 170 may include logic configured to output information from computer system 600. Embodiments of output device 170 may include, e.g., but not limited to, display 603, and display interface 602, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc.

Computer 600 may include input/output (I/O) devices such as, e.g., (but not limited to) communications interface 624, cable 628 and communications path 626, etc. These devices may include, e.g., but are not limited to, a network interface card, and/or modems. Communications interface 624 may allow software and data to be transferred between computer system 600 and external devices.

Computer 600 may execute various software applications. One software application may include an embodiment of the functionality to execute the method and/or computer readable medium described herein. Furthermore, computer 600 may execute software applications such as Microsoft Project which may be used as a software platform to assist in implementation of an embodiment of the invention.

In this document, the terms “computer program medium” and “computer readable medium” may be used to generally refer to media such as, e.g., but not limited to, removable storage drive 614, a hard disk installed in hard disk drive 612, flash memories, removable discs, non-removable discs, etc. In addition, it should be noted that various electromagnetic radiation, such as wireless communication, electrical communication carried over an electrically conductive wire (e.g., but not limited to twisted pair, CAT5, etc.) or an optical medium (e.g., but not limited to, optical fiber) and the like may be encoded to carry computer-executable instructions and/or computer data that embodiments of the invention on e.g., a communication network. These computer program products may provide software to computer system 600. It should be noted that a computer-readable medium that comprises computer-executable instructions for execution in a processor may be configured to store various embodiments of the present invention.

Example Pharmaceutical Product Commercialization Workflows

The following tables (tables 1-7) represent example tasks, milestones, or deliverables (e.g., activities). Various activities are shown and may include linkages (e.g., predecessors, dependencies, successors, etc.) between the activities. For example, if a second activity is dependent on a first activity, the second activity may not start until the first activity is complete.

Also shown is a start and finish time. A duration field may be displayed indicating the time an activity is expected to take. Additionally, example resource names are associated with the various activities. The resource name may be, for example, a subject matter expert, an individual, an agency, a group, a government entity, a contractor, a sub-contractor, company department, a third-party, etc. assigned to the activity

In one embodiment, entry or changing of the dates may alter the activity dates accordingly in all tables. Entry or change of resource names may alter the corresponding resource name in all tables.

In tables 1-7, tasks, milestones, or deliverables may be listed in the second column. The names of all the tasks, milestones, or deliverables may be customized according to desired language (e.g., the activity name may be changed to match the language inherent to an organization or company). The exact language used for a task, milestone, or deliverable may change but the scope or content of the task, milestone, or deliverable may remain static. For example, if two words sufficiently describe a task, milestone, or deliverable to the satisfaction of a client, for example, then those two words may suffice. On the other hand, if more words are needed then more words may be added to describe the task.

In one embodiment, if an activity is designed to gain customer insight, for example, then this activity may be described in a number of ways, such as: a) Market Research-Customer Insight, or b) Develop Customer Insight through Primary Market Research, or c) Primary Research Customer Insight. All three may, for example, represent a task name, depending on the approach the subject matter expert wants to take. All three may describe the same action (e.g., developing customer insight) but with different words (e.g., the displayed words are customizable).

TABLE 1
BRAND PERSPECTIVE

| ID | Task Name | Duration | | Start | Finish | Predecessors | Resource Names |
|---|---|---|---|---|---|---|---|
| 1 | 1 Phillyx Brand Sub Project | 314 | days? | Fri Jan. 21, 2011 | Wed Apr. 4, 2012 | | |
| 2 | 1.1 Project Kickoff | 0 | days | Wed Jun. 1, 2011 | Wed Jun. 1, 2011 | | |
| 3 | 1.2 NDA submission | 0 | days | Wed Jun. 1, 2011 | Wed Jun. 1, 2011 | 2 | Regulatory |
| 4 | 1.3 PDUFA Day | 0 | days | Wed Apr. 4, 2012 | Wed Apr. 4, 2012 | 3FS + 27.5 mons | |
| 5 | 1.4 Establish Project Team | 0 | days | Wed Jun. 1, 2011 | Wed Jun. 1, 2011 | 3 | |
| 6 | 1.5 Formulate launch project sub teams | 0 | days | Wed Jun. 1, 2011 | Wed Jun. 1, 2011 | 5 | Brand Management |
| 7 | 1.6 Brand name | 158.13 | days? | Fri Jan. 21, 2011 | Wed Aug. 31, 2011 | | |
| 8 | 1.6.1 Brand name | 0 | days? | Wed Jun. 1, 2011 | Wed Jun. 1, 2011 | 2 | |
| 9 | 1.6.2 Brand Name Research | 1.25 | mons | Fri Jan. 21, 2011 | Thu Feb. 3, 2011 | | Brand Management, Agency-Brand Name |
| 10 | 1.6.3 Brand Name Development | 1.25 | mons | Wed Jun. 1, 2011 | Wed Jun. 15, 2011 | 3 | Brand Management, Agency-Brand Name |
| 11 | 1.6.4 Brand name Testing | 1.25 | mons | Wed Jun. 15, 2011 | Wed Jun. 29, 2011 | 10 | Brand Management, Agency-Brand Name |
| 12 | 1.6.5 Brand Name Approved for NDA Submission | 0 | days? | Wed Jun. 29, 2011 | Wed Jun. 29, 2011 | 11 | Brand Management, Executive Management, Regul [symbol] |
| 13 | 1.6.6 Brand Name Approval | 22.5 | wks | Wed Jun. 29, 2011 | Wed Aug. 31, 2011 | 12 | FDA |
| 14 | 1.7 Brand Logo development | 65 | days? | Thu Jul. 28, 2011 | Thu Oct. 27, 2011 | | |
| 15 | 1.7.1 Brand Logo development | 0 | days? | Thu Jul. 28, 2011 | Thu Jul. 28, 2011 | 2FS + 20.5 wks | |
| 16 | 1.7.2 Agency submission | 10 | days | Wed Aug. 31, 2011 | Wed Sep. 14, 2011 | 13 | |
| 17 | 1.7.3 Create logo | 5 | days | Wed Sep. 14, 2011 | Wed Sep. 21, 2011 | 16 | Ad Agency |
| 18 | 1.7.4 Marketing comments | 5 | days | Wed Sep. 21, 2011 | Wed Sep. 28, 2011 | 17 | Ad Agency |
| 19 | 1.7.5 Create Logo | 5 | days | Wed Sep. 28, 2011 | Wed Oct. 5, 2011 | 18 | Ad Agency |
| 20 | 1.7.6 LMR submission for review and approval | 1 | day | Wed Oct. 5, 2011 | Thu Oct. 6, 2011 | 19 | Ad Agency |
| 21 | 1.7.7 LMR Approval comments | 6 | days | Thu Oct. 6, 2011 | Fri Oct. 14, 2011 | 20 | Ad Agency |
| 22 | 1.7.8 Final Approval submission | 3 | days | Fri Oct. 14, 2011 | Wed Oct. 19, 2011 | 21 | Ad Agency |
| 23 | 1.7.9 Final Approval received | 5 | days | Wed Oct. 19, 2011 | Wed Oct. 26, 2011 | 22 | Ad Agency |
| 24 | 1.7.10 Agency Release | 1 | day | Wed Oct. 26, 2011 | Thu Oct. 27, 2011 | 23 | Ad Agency |
| 25 | 1.7.11 Delivery Date for product | 0 | days | Thu Oct. 27, 2011 | Thu Oct. 27, 2011 | 24 | Ad Agency |
| 26 | 2 Data Generation (Marketing) | 286 | days? | Wed Jun. 8, 2011 | Thu Jul. 12, 2012 | | |
| 27 | 2.1 Data Generation (Marketing) | 0 | days? | Thu Jun. 9, 2011 | Thu Jun. 9, 2011 | 2FS + 3 wks | |
| 28 | 2.2 MARKET RESEARCH PROJECTS | 286 | days? | Wed Jun. 8, 2011 | Thu Jul. 12, 2012 | | |
| 29 | 2.2.1 MARKET RESEARCH PROJECTS | 0 | days? | Thu Jun. 9, 2011 | Thu Jun. 9, 2011 | 27 | |
| 30 | 2.2.2 Target Product Profile | 2.5 | mons | Wed Jun. 8, 2011 | Wed Jul. 6, 2011 | 6FS + 2.5 wks | Brand Management, Medical Director, Market Rese [symbol] |
| 31 | 2.2.3 Patient Treatment Flow (US/Global) | 2.5 | mons | Wed Jun. 8, 2011 | Wed Jul. 6, 2011 | 30SS | Brand Management, Medical Director, Market Rese [symbol] |
| 32 | 2.2.4 Procedure Flow | 2.5 | mons | Wed Jun. 8, 2011 | Wed Jul. 6, 2011 | 31SS | Brand Management |
| 33 | 2.2.5 Buying Process and Value driver customer | 5 | mons | Wed Jul. 6, 2011 | Wed Aug. 31, 2011 | 32 | Managed Markets, Market Research, Brand Manag [symbol] |
| | research | | | | | | |
| 34 | 2.2.6 Identify Key Influencers | 2.5 | mons | Wed Aug. 31, 2011 | Wed Sep. 28, 2011 | 33 | Brand Management, Medical Director, Market Rese [symbol] |
| 35 | 2.2.7 Market Mapping (US/Global) | 120 | days | Wed Jul. 6, 2011 | Wed Dec. 21, 2011 | | |
| 36 | 2.2.7.1 Physician (Market) insight exploratory [symbol] | 5.25 | mons | Wed Jul. 6, 2011 | Fri Sep. 2, 2011 | 30 | Market Research |
| 37 | 2.2.7.2 Preliminary Market Scan: US and ROW | 40 | wks | Wed Jul. 6, 2011 | Wed Oct. 26, 2011 | 31 | Brand Management |
| 38 | 2.2.7.3 Identify Key Oppurtunities | 5 | mons | Wed Oct. 26, 2011 | Wed Dec. 21, 2011 | 37 | Brand Management |
| 39 | 2.2.8 Market Access/Managed Markets Research | 18.25 | mons | Wed Dec. 21, 2011 | Thu Jul. 12, 2012 | 38 | Brand Management, Managed Markets |
| 40 | 2.2.9 Brand Promise Testing-Qualitative | 56 | days | Wed Jul. 6, 2011 | Thu Sep. 22, 2011 | | |
| 41 | 2.2.9.1 Agency development/review and appr [symbol] | 5 | wks | Wed Jul. 6, 2011 | Wed Jul. 20, 2011 | 32 | Market Research, Ad Agency |
| 42 | 2.2.9.2 Fielding of US research | 5 | days | Wed Aug. 31, 2011 | Wed Sep. 7, 2011 | 33 | Market Research |
| 43 | 2.2.9.3 Debrief of US research | 1 | day | Fri Sep. 16, 2011 | Mon Sep. 19, 2011 | 42FS + 7 days | Market Research |
| 44 | 2.2.9.4 Revise and finalize the creative brief | 1 | day | Mon Sep. 19, 2011 | Tue Sep. 20, 2011 | 43 | Market Research, Ad Agency |
| 45 | 2.2.9.5 Presentation and approval of CB | 1 | day | Wed Sep. 21, 2011 | Thu Sep. 22, 2011 | 44FS + 1 day | Brand Management |
| 46 | 2.2.9.6 Collect data and develop Global presen [symbol] | 1 | day | Wed Sep. 21, 2011 | Thu Sep. 22, 2011 | 45FS − 1 day | Market Research |
| 47 | 2.2.9.7 Final Presentation | 0.5 | days | Wed Sep. 21, 2011 | Wed Sep. 21, 2011 | 46FS − 1 day | Market Research |
| 48 | 2.2.10 Segmentation/key drivers Market Resea [symbol] | 110 | days | Wed Jun. 8, 2011 | Wed Nov. 9, 2011 | | |
| 49 | 2.2.10.1 Segmentation Study: Physicans/NURP | 5.63 | mons | Wed Jul. 6, 2011 | Wed Sep. 7, 2011 | 30 | Market Research |
| 50 | 2.2.10.2 Physician Insight Mining | 4.38 | mons | Wed Aug. 31, 2011 | Wed Oct. 19, 2011 | 34SS | Market Research |
| 51 | 2.2.10.3 Physician Insight: Preference Share Dr [symbol] | 5 | mons | Wed Sep. 7, 2011 | Wed Nov. 2, 2011 | 49 | Market Research |
| 52 | 2.2.10.4 Identify key opportunities | 2.5 | wks | Wed Nov. 2, 2011 | Wed Nov. 9, 2011 | 51 | Market Research, Brand Management |
| 53 | 2.2.10.5 Web and Publication Research | 2.5 | mons | Wed Jun. 8, 2011 | Wed Jul. 6, 2011 | 30SS | Brand Management, Medical Director, Market Rese [symbol] |
| 54 | 2.2.11 KOL Influence Map | 15 | wks | Wed Jul. 6, 2011 | Wed Aug. 17, 2011 | 53 | |
| 55 | 2.2.12 Baseline Awareness Trial and Usage | 47 | days | Wed Sep. 21, 2011 | Fri Nov. 25, 2011 | | |
| | Study (ATU) | | | | | | |
| 56 | 2.2.12.1 Guide development and approval | 31 | days | Wed Sep. 21, 2011 | Thu Nov. 3, 2011 | 47 | Market Research |
| 57 | 2.2.12.2 Fielding | 7.5 | wks | Thu Nov. 3, 2011 | Thu Nov. 24, 2011 | 56 | Market Research |
| 58 | 2.2.12.3 File Report and presentation | 1 | day | Thu Nov. 24, 2011 | Fri Nov. 25, 2011 | | Market Research |
| 59 | 2.2.12.3.1 Final presentation | 1 | day | Thu Nov. 24, 2011 | Fri Nov. 25, 2011 | 57 | Market Research |
| 60 | 3 National Advisory Boards 1-3 (Brand) | 118.88 | days? | Wed Jul. 6, 2011 | Mon Dec. 19, 2011 | | |
| 61 | 3.1 Ad Board Initial Planning (Brand) | 5.5 | days? | Wed Jul. 6, 2011 | Wed Jul. 13, 2011 | | Brand Management, Medical Director |
| 62 | 3.1.1 Available funding and budget availability re [symbol] | 1.5 | days | Wed Jul. 6, 2011 | Thu Jul. 7, 2011 | 53 | Brand Management, Medical Director |
| 63 | 3.1.2 Commitment to conducting the meeting | 0 | days | Thu Jul. 7, 2011 | Thu Jul. 7, 2011 | 62 | Brand Management, Medical Director |
| 64 | 3.1.3 Complete/Submit Meeting Request Form t [symbol] | 1 | day | Thu Jul. 7, 2011 | Fri Jul. 8, 2011 | 63 | Brand Management, Medical Director |
| 65 | 3.1.4 Develop Meeting Objectives and Agenda | 1 | day | Fri Jul. 8, 2011 | Mon Jul. 11, 2011 | 64 | |
| 66 | 3.1.5 Meeting specifics and budget reviewed and | 1 | day | Mon Jul. 11, 2011 | Tue Jul. 12, 2011 | 65 | Brand Management, Medical Director |
| 67 | 3.1.6 Identify KOL's | 1 | day? | Tue Jul. 12, 2011 | Wed Jul. 13, 2011 | 66 | |
| 68 | 3.2 Ad Board Activity Content Development (Bran [symbol] | 49 | days | Tue Jul. 12, 2011 | Mon Sep. 19, 2011 | | |
| 69 | 3.2.1 Objectives and Agenda | 12 | days | Tue Jul. 12, 2011 | Thu Jul. 28, 2011 | 66 | Medical Director, Brand Management, Ad Agency |
| 70 | 3.2.2 Schedule clinical presentations | 1 | day | Thu Jul. 28, 2011 | Fri Jul. 29, 2011 | 69 | Medical Director, Brand Management |
| 71 | 3.2.3 Identify speakers | 3 | days | Fri Jul. 29, 2011 | Wed Aug. 3, 2011 | 70 | Medical Director, Brand Management |
| 72 | 3.2.4 Determine which materials to provide (liter [symbol] | 10 | days | Thu Jul. 28, 2011 | Thu Aug. 11, 2011 | 69 | Medical Director, Brand Management, Ad Agency |
| 73 | 3.2.5 Ad Board Questions-prepare draft | 7.5 | wks | Thu Jul. 28, 2011 | Thu Aug. 18, 2011 | 69 | Medical Director, Brand Management, Ad Agency |
| 74 | 3.2.6 Ad Board Questions-Revise Draft | 5 | wks | Thu Aug. 18, 2011 | Thu Sep. 1, 2011 | 73 | Medical Director, Brand Management, Ad Agency |
| 75 | 3.2.7 Ad Board Deck-Regulatory and Legal Revie [symbol] | 5 | wks | Thu Sep. 1, 2011 | Thu Sep. 15, 2011 | 74 | Medical Director, Brand Management, Ad Agency |
| 76 | 3.2.8 Ad Board Materials-Finalize | 2 | days | Thu Sep. 15, 2011 | Mon Sep. 19, 2011 | 75 | Medical Director, Brand Management, Ad Agency |
| 77 | 3.3 Ad Board Meeting Planning (Brand) | 60 | days? | Tue Jul. 12, 2011 | Tue Oct. 4, 2011 | | |
| 78 | 3.3.1 Ad Board Meeting Planning (Brand) | 0 | days? | Tue Jul. 12, 2011 | Tue Jul. 12, 2011 | 66 | |
| 79 | 3.3.2 Create and source RFP for the meeting | 21 | days | Tue Jul. 12, 2011 | Wed Aug. 10, 2011 | | |
| 80 | 3.3.2.1 RFP is drafted | 2 | days | Tue Jul. 12, 2011 | Thu Jul. 14, 2011 | 66 | |
| 81 | 3.3.2.2 Distribute RFP to vendors | 2 | days | Thu Jul. 14, 2011 | Mon Jul. 18, 2011 | 80 | Meeting Planning |
| 82 | 3.3.2.3 Compile list of responses to the RFP an [symbol] | 3 | days | Mon Jul. 18, 2011 | Thu Jul. 21, 2011 | 81 | Meeting Planning |
| 83 | 3.3.2.4 Present to Medical Director and Marke [symbol] | 2 | days | Thu Jul. 21, 2011 | Mon Jul. 25, 2011 | 82 | Meeting Planning |
| 84 | 3.3.2.5 Negotiations are conducted with the v [symbol] | 5 | days | Mon Jul. 25, 2011 | Mon Aug. 1, 2011 | 83 | Meeting Planning |
| 85 | 3.3.2.6 Contract is then routed to procuremen [symbol] | 5 | days | Mon Aug. 1, 2011 | Mon Aug. 8, 2011 | 84 | Legal, Meeting Planning |
| 86 | 3.3.2.7 Circulated for final signature and appro [symbol] | 1 | day | Mon Aug. 8, 2011 | Tue Aug. 9, 2011 | 85 | Legal, Procurement, Meeting Planning |
| 87 | 3.3.2.8 Agreement is routed to venue for signa [symbol] | 1 | day | Tue Aug. 9, 2011 | Wed Aug. 10, 2011 | 86 | Legal, Meeting Planning, Procurement |
| 88 | 3.3.3 Invitations/Letters | 39 | days | Wed Aug. 10, 2011 | Tue Oct. 4, 2011 | | |
| 89 | 3.3.3.1 Invitations/Letters-Prepare Drafts | 3 | days | Wed Aug. 10, 2011 | Mon Aug. 15, 2011 | 87 | Meeting Planning |
| 90 | 3.3.3.2 Invitations/Letters-Legal Review of Dr [symbol] | 3 | days | Mon Aug. 15, 2011 | Thu Aug. 18, 2011 | 89 | Meeting Planning |
| 91 | 3.3.3.3 Invitations/Letters-Finalize | 2 | days | Thu Aug. 18, 2011 | Mon Aug. 22, 2011 | 90 | Meeting Planning |
| 92 | 3.3.3.4 Send Out Invitation to Group 1 | 3 | days | Mon Aug. 22, 2011 | Thu Aug. 25, 2011 | 91 | Meeting Planning |
| 93 | 3.3.3.5 Invitation turnaround | 2 | ewks | Thu Aug. 25, 2011 | Thu Sep. 8, 2011 | 92 | |
| 94 | 3.3.3.6 Consultancy Agreements for Attendees | 2 | days | Thu Sep. 8, 2011 | Mon Sep. 12, 2011 | 93 | Meeting Planning |
| 95 | 3.3.3.7 Evaluate Group 1 Responses to Invitati [symbol] | 1 | day | Mon Sep. 12, 2011 | Tue Sep. 13, 2011 | 94 | Brand Management, Medical Director |
| 96 | 3.3.3.8 Send Out Invitation to Wave 2 (if appli [symbol] | 2 | ewks | Tue Sep. 13, 2011 | Tue Sep. 27, 2011 | 95 | Meeting Planning |
| 97 | 3.3.3.9 Evaluate Group 2 Responses to Invitati [symbol] | 1 | day | Tue Sep. 27, 2011 | Wed Sep. 28, 2011 | 96 | Brand Management, Medical Director |
| 98 | 3.3.3.10 Follow-Up to Medical director and M [symbol] | 1 | day | Wed Sep. 28, 2011 | Thu Sep. 29, 2011 | 97 | Meeting Planning |
| 99 | 3.3.3.11 Confirmation Letters to Attendees Gr [symbol] | 1 | day | Thu Sep. 29, 2011 | Fri Sep. 30, 2011 | 98 | Meeting Planning |
| 100 | 3.3.3.12 Ticket Mailing Letters to Attendees | 1 | day | Fri Sep. 30, 2011 | Mon Oct. 3, 2011 | 99 | Meeting Planning |
| 101 | 3.3.3.13 Consultancy Agreement for External [symbol] | 1 | day | Mon Oct. 3, 2011 | Tue Oct. 4, 2011 | 100 | Meeting Planning |
| 102 | 3.4 Conduct Advisory Board (Brand) | 36 | days | Sat Oct. 29, 2011 | Mon Dec. 19, 2011 | | Medical Director, Brand Management, Ad Agency |
| 103 | 3.4.1 Advisory Board 1 (Brand) | 0 | days | Sat Oct. 29, 2011 | Sat Oct. 29, 2011 | 101FS + 3.3 wks | |
| 104 | 3.4.2 Advisory Board 2 (Brand) | 0 | days | Sun Nov. 20, 2011 | Sun Nov. 20, 2011 | 103FS + 3.6 wks | |
| 105 | 3.4.3 Advisory Board 3 (Brand) | 0 | days | Sun Dec. 11, 2011 | Sun Dec. 11, 2011 | 104FS + 3 wks | |
| 106 | 3.4.4 Advisory Board and Consultant input | 0 | wks | Mon Oct. 31, 2011 | Mon Dec. 19, 2011 | 103 | Brand Management, Medical Director |
| 107 | 3.4.5 Advisory Boards Report/Feedback Loop | 0 | wks | Mon Oct. 31, 2011 | Mon Dec. 19, 2011 | 103 | Medical Director, Brand Management, Ad Agency |
| 108 | 3.4.6 Update the KOL Infulence Map | 0 | wks | Mon Oct. 31, 2011 | Mon Dec. 19, 2011 | 103 | Brand Management, Medical Director |
| 109 | 4 Develop Local Brand Plan | 79.1 | days? | Tue Dec. 20, 2011 | Mon Apr. 9, 2012 | | |
| 110 | 4.1 Conduct Research, gather data and analyze the | 0 | days | Tue Dec. 20, 2011 | Thu Jan. 5, 2012 | 106 | Brand Management, Market Research |
| | results in preparation for the development of the | | | | | | |
| | Local Brand Plan | | | | | | |
| 111 | 4.2 Develop Planning Cycle analytical tool | 0 | days | Thu Jan. 5, 2012 | Thu Jan. 12, 2012 | 110 | Executive Management |
| 112 | 4.3 Strategic Planning | 62 | days | Thu Jan. 12, 2012 | Mon Apr. 9, 2012 | | |
| 113 | 4.3.1 Situation Analysis/SWOT | 20 | days | Thu Jan. 12, 2012 | Thu Feb. 9, 2012 | 111 | Brand Management, Ad Agency, Strategic Planner |
| 114 | 4.3.2 Strategic War Games | 0 | days | Thu Feb. 9, 2012 | Fri Feb. 10, 2012 | 113 | Brand Management, Ad Agency, Strategic Planner |
| 115 | 4.3.3 Strategic Scenario Planning | 0 | days | Fri Feb. 10, 2012 | Mon Feb. 13, 2012 | 114 | Brand Management, Ad Agency, Strategic Planner |
| 116 | 4.3.4 Brainstorming Meeting | 0 | days | Mon Feb. 13, 2012 | Tue Feb. 14, 2012 | 115 | Brand Management, Ad Agency, Strategic Planner |
| 117 | 4.3.5 Brainstorming Meeting Follow-up | 0 | days | Tue Feb. 14, 2012 | Wed Feb. 15, 2012 | 116 | Brand Management, Ad Agency, Strategic Planner |
| 118 | 4.3.6 Balance Scorecard | 0 | days | Wed Feb. 15, 2012 | Thu Feb. 16, 2012 | 117 | Brand Management, Ad Agency, Strategic Planner |
| 119 | 4.3.7 First Draft of the Local Brand Plan | 0 | days | Thu Feb. 16, 2012 | Thu Mar. 1, 2012 | 118 | Brand Management |
| 120 | 4.3.8 1st Draft Budget Slides Due | 0 | days | Thu Feb. 16, 2012 | Thu Mar. 8, 2012 | 119SS | Brand Management |
| 121 | 4.3.9 Comments on the first draft of the Budget | 0 | days | Thu Mar. 8, 2012 | Mon Mar. 19, 2012 | 120 | Brand Management |
| | Slides will be provided to all sub team leaders | | | | | | |
| 122 | 4.3.10 Second Draft of the Local Brand Plan | 0 | wks | Mon Mar. 19, 2012 | Mon Mar. 26, 2012 | 121 | Brand Management |
| 123 | 4.3.11 Final Local Brand Plan | 0 | wks | Mon Mar. 26, 2012 | Mon Apr. 9, 2012 | 122 | Brand Management |
| 124 | 4.4 Product Positioning | 30 | days? | Thu Jan. 5, 2012 | Thu Feb. 16, 2012 | | |
| 125 | 4.4.1 Product Positioning | 0 | days? | Thu Jan. 5, 2012 | Thu Jan. 5, 2012 | 110 | |
| 126 | 4.4.2 Developing Positioning Options | 0 | days | Thu Jan. 5, 2012 | Thu Jan. 12, 2012 | 125 | Brand Management, Ad Agency, Market Research |
| 127 | 4.4.3 Qualitative Positioning Research | 0 | wks | Thu Jan. 12, 2012 | Thu Feb. 2, 2012 | 126 | Brand Management, Ad Agency, Market Research |
| 128 | 4.4.4 Quantitative Positioning Research | 0 | wks | Thu Feb. 2, 2012 | Thu Feb. 16, 2012 | 127 | Brand Management, Ad Agency, Market Research |
| 129 | 5 Worldwide Strategic Alignment | 322.98 | days | Wed Mar. 9, 2011 | Mon Jun. 4, 2012 | | |
| 130 | 5.1 Interface with core countries | 0 | days | Mon Apr. 9, 2012 | Tue Apr. 10, 2012 | 123 | Brand Management, Executive Management |
| 131 | 5.2 Establish Country KPI Score Cards | 0 | days | Tue Apr. 10, 2012 | Tue Apr. 17, 2012 | 130 | Brand Management |
| 132 | 5.3 Preliminary recommendation to Management | 0 | days | Tue Apr. 17, 2012 | Tue Apr. 24, 2012 | 131 | Brand Management |
| 133 | 5.4 Monitor US/Global Strategy Reconciliation | 0 | days | Tue Apr. 24, 2012 | Fri Apr. 27, 2012 | 132 | Brand Management |
| 134 | 5.5 Results from strategy validation research | 0 | days | Fri Apr. 27, 2012 | Fri May 4, 2012 | 133 | Brand Management |
| 135 | 5.6 Final approval of strategy | 0 | days | Wed May 9, 2012 | Thu May 10, 2012 | 134FS + 3 days | Brand Management |
| 136 | 5.7 Communicate the strategy to core Countries | 0 | days | Thu May 10, 2012 | Tue May 15, 2012 | 135 | Brand Management |
| | and Commercial Team | | | | | | |
| 137 | 5.8 Strategic Alignment (US/Global) | 0 | days | Thu May 10, 2012 | Mon Jun. 4, 2012 | 135 | Brand Management |
| 138 | 5.9 Competitive landscape | 20 | days | Wed Mar. 9, 2011 | Wed Apr. 6, 2011 | 2FS − 7.5 mons | |
| 139 | 5.10 Unmet Needs/Attributes (seg) | 1 | day | Wed Jul. 6, 2011 | Thu Jul. 7, 2011 | 30 | Market Research |
| 140 | 6 Worldwide Strategic Rollout | 0 | days | Fri Jan. 21, 2011 | Fri Jan. 21, 2011 | | |
| 141 | 7 Messaging US | 72.33 | days | Thu Feb. 2, 2012 | Mon May 14, 2012 | | |
| 142 | 7.1 Messaging project kickoff meeting | 0 | days | Thu Feb. 2, 2012 | Fri Feb. 3, 2012 | 127 | Medical, Ad Agency, Brand Management |
| 143 | 7.2 Messaging workshop | 0 | days | Fri Feb. 3, 2012 | Mon Feb. 6, 2012 | 142 | Medical, Ad Agency, Brand Management |
| 144 | 7.3 Promotional message development | 0 | mons | Mon Feb. 6, 2012 | Mon Mar. 5, 2012 | 143 | Medical, Ad Agency, Brand Management, Market R [symbol] |
| 145 | 7.4 Message Testing-Qualitative | 0 | days | Mon Mar. 5, 2012 | Mon Apr. 16, 2012 | 144 | Medical, Ad Agency, Brand Management |
| 146 | 7.5 Share messaging data with Managed Markets | 0 | days | Mon Mar. 26, 2012 | Mon Mar. 26, 2012 | 145FS − 7.5 wks | |
| 147 | 7.6 Message Testing-Quantitative (US) | 0 | days | Mon Apr. 16, 2012 | Thu May 10, 2012 | 145 | Medical, Ad Agency, Brand Management |
| 148 | 7.7 Final Messages | 0 | days | Thu May 10, 2012 | Mon May 14, 2012 | 147 | Medical Director, Ad Agency, Brand Management |
| 149 | 8 Creative Concept | 88 | days | Thu Feb. 16, 2012 | Tue Jun. 19, 2012 | | |
| 150 | 8.1 Final US Brand Promise Debrief | 68 | days | Thu Feb. 16, 2012 | Tue May 22, 2012 | | |
| 151 | 8.1.1 Revised creative brief from Agency | 0 | days | Thu Feb. 16, 2012 | Fri Feb. 17, 2012 | 128 | Ad Agency, Market Research |
| 152 | 8.1.2 Wave 1 | 0 | days | Fri Feb. 17, 2012 | Fri Feb. 17, 2012 | | |
| 153 | 8.1.2.1 Approvals completed | 0 | days | Fri Feb. 17, 2012 | Fri Feb. 17, 2012 | 151 | Brand Management, Market Research |
| 154 | 8.1.3 Agency to begin concept work | 0 | days | Thu Feb. 16, 2012 | Thu Mar. 1, 2012 | 128 | Ad Agency |
| 155 | 8.1.4 Marketing Submission and Comment | 3 | days | Thu Mar. 1, 2012 | Tue Mar. 6, 2012 | 154 | Ad Agency, Brand Management |
| 156 | 8.1.5 Agency Release for Testing | 0 | days | Thu Mar. 1, 2012 | Tue Mar. 6, 2012 | 154 | |
| 157 | 8.1.6 Internal Review and comments | 0 | days | Tue Mar. 20, 2012 | Wed Mar. 21, 2012 | 155FS + 10 days | Ad Agency |
| 158 | 8.1.7 Agency incorporates changes | 0 | days | Wed Apr. 4, 2012 | Thu Apr. 12, 2012 | 157FS + 10 days | Ad Agency |
| 159 | 8.1.8 Agency second presentation | 0 | days | Thu Apr. 12, 2012 | Fri Apr. 13, 2012 | 158 | Ad Agency |
| 160 | 8.1.9 Agency changes and approvals | 0 | days | Fri Apr. 13, 2012 | Wed Apr. 18, 2012 | 159 | Ad Agency |
| 161 | 8.1.10 LMR Approval Review | 0 | days | Wed Apr. 18, 2012 | Wed Apr. 25, 2012 | 160 | Ad Agency |
| 162 | 8.1.11 Agency incorporates changes | 0 | days | Wed Apr. 25, 2012 | Wed May 2, 2012 | 161 | Ad Agency |
| 163 | 8.1.12 Fielding of US research Wave 1 | 0 | days | Wed May 2, 2012 | Tue May 8, 2012 | 162 | Ad Agency |
| 164 | 8.1.13 Debrief of US Concept Testing | 0 | days | Wed May 9, 2012 | Thu May 10, 2012 | 163FS + 1 day | Market Research, Ad Agency, Brand Management |
| 165 | 8.1.14 Submisison to LMR Approval for | 0 | days | Mon May 14, 2012 | Tue May 15, 2012 | 164FS + 2 days | Ad Agency |
| | comment, review and approval | | | | | | |
| 166 | 8.1.15 LMR Approval Review complete | 0 | days | Tue May 15, 2012 | Tue May 22, 2012 | 165 | Ad Agency |
| 167 | 8.2 Wave 2: US | 19 | days | Wed May 23, 2012 | Tue Jun. 19, 2012 | | |
| 168 | 8.2.1 Agency incorporates changes | 0 | days | Wed May 23, 2012 | Mon May 28, 2012 | 166FS + 1 day | Ad Agency |
| 169 | 8.2.2 Agency presents updates and new | 0 | days | Mon May 28, 2012 | Tue May 29, 2012 | 168 | Ad Agency |
| | concepts if needed | | | | | | |
| 170 | 8.2.3 Week of internal review and approval | 0 | days | Tue May 29, 2012 | Fri Jun. 1, 2012 | 168FS + 1 day | Ad Agency |
| 171 | 8.2.4 Wave 2 US fielding | 0 | days | Tue May 29, 2012 | Mon Jun. 4, 2012 | 170SS | Ad Agency |
| 172 | 8.2.5 LMR Approval review, comment and | 0 | days | Fri Jun. 1, 2012 | Fri Jun. 8, 2012 | 170 | Ad Agency |
| | approval | | | | | | |
| 173 | 8.2.6 Agency incorporates changes | 0 | days | Fri Jun. 8, 2012 | Tue Jun. 12, 2012 | 172 | Ad Agency |
| 174 | 8.2.7 US debrief | 0 | days | Tue Jun. 12, 2012 | Tue Jun. 19, 2012 | 173 | Ad Agency |
| 175 | 9 Pre DDMAC Visual Aid | 76 | days | Thu Jan. 12, 2012 | Thu Apr. 26, 2012 | | |
| 176 | 9.1 Agency begins development | 0 | days | Thu Jan. 12, 2012 | Thu Jan. 12, 2012 | 4FS − 7.5 mons | |
| 177 | 9.2 Marketing submission | 0 | days | Thu Jan. 12, 2012 | Thu Feb. 2, 2012 | 176 | Ad Agency |
| 178 | 9.3 Marketing comments | 0 | days | Fri Feb. 3, 2012 | Thu Mar. 1, 2012 | 177 | Ad Agency |
| 179 | 9.4 LMR Approval submission | 0 | days | Fri Mar. 2, 2012 | Fri Mar. 2, 2012 | 178 | Ad Agency |
| 180 | 9.5 LMR Approval review, comment and approval | 0 | days | Mon Mar. 5, 2012 | Fri Mar. 9, 2012 | 179 | Ad Agency |
| 181 | 9.6 Final Approval submission | 0 | days | Fri Mar. 23, 2012 | Thu Mar. 29, 2012 | 180FS + 9 days | |
| 182 | 9.7 Final Marketing approval | 0 | days | Tue Apr. 3, 2012 | Tue Apr. 3, 2012 | 181FS + 2 days | Ad Agency |
| 183 | 9.8 Agency disk Release | 0 | days | Wed Apr. 4, 2012 | Thu Apr. 5, 2012 | 182 | Ad Agency |
| 184 | 9.9 Agency develops the Pre DDMAC visual aid | 0 | days | Fri Apr. 6, 2012 | Thu Apr. 12, 2012 | 183 | Ad Agency |
| 185 | 9.10 Development of item by Agency | 0 | days | Fri Apr. 13, 2012 | Thu Apr. 26, 2012 | 184 | Ad Agency |
| 186 | 9.11 Brand/Marketing Review | 0 | days | Fri Apr. 13, 2012 | Thu Apr. 19, 2012 | 184 | Brand Management, Ad Agency, Reglatory, Medical |
| 187 | 9.12 LMR Approval Review | 0 | days | Fri Apr. 20, 2012 | Thu Apr. 26, 2012 | 186 | Medical, Reglatory, Legal |
| 188 | 10 Pre DDMAC AnnotatedVisual Aid | 71 | days | Fri Apr. 13, 2012 | Fri Jul. 20, 2012 | | |
| 189 | 10.1 Agency begins development | 0 | days | Fri Apr. 13, 2012 | Thu Apr. 26, 2012 | 184 | |
| 190 | 10.2 Marketing submission | 0 | days | Fri Apr. 27, 2012 | Fri May 18, 2012 | 189 | Ad Agency |
| 191 | 10.3 Marketing comments | 0 | days | Mon May 21, 2012 | Fri Jun. 15, 2012 | 190 | Ad Agency |
| 192 | 10.4 LMR Approval submission | 0 | days | Tue Jun. 19, 2012 | Fri Jun. 22, 2012 | 191FS + 1 day | Ad Agency |
| 193 | 10.5 LMR Approval review, comment and approval | 0 | days | Mon Jun. 25, 2012 | Mon Jul. 2, 2012 | 192 | Ad Agency |
| 194 | 10.6 Final Approval submission | 0 | days | Mon Jul. 16, 2012 | Mon Jul. 16, 2012 | 193FS + 9 days | |
| 195 | 10.7 Final Marketing approval | 0 | days | Thu Jul. 19, 2012 | Thu Jul. 19, 2012 | 194FS + 2 days | Ad Agency |
| 196 | 10.8 Agency disk Release | 0 | days | Fri Jul. 20, 2012 | Fri Jul. 20, 2012 | 195 | Ad Agency |
| 197 | 11 Promotional Visual Aid | 109 | days | Thu Apr. 5, 2012 | Tue Sep. 4, 2012 | | |
| 198 | 11.1 Agency begins linking concept to Pre DDMAC | 0 | days | Tue Jun. 12, 2012 | Wed Jul. 11, 2012 | 173 | Market Research, Ad Agency |
| | vis aid | | | | | | |
| 199 | 11.2 Marketing submission | 0 | days | Wed Jul. 11, 2012 | Thu Jul. 12, 2012 | 198 | Market Research, Ad Agency |
| 200 | 11.3 Marketing comments | 0 | days | Thu Apr. 5, 2012 | Wed Apr. 11, 2012 | 4 | Ad Agency |
| 201 | 11.4 LMR Approval Submisison | 0 | days | Thu Apr. 12, 2012 | Fri Apr. 13, 2012 | 200 | Ad Agency |
| 202 | 11.5 Marketing Approval | 0 | days | Mon Apr. 16, 2012 | Tue Apr. 24, 2012 | 201 | Ad Agency |
| 203 | 11.6 Agency refinements | 0 | days | Tue May 1, 2012 | Thu May 3, 2012 | 202FS + 4 days | Ad Agency |
| 204 | 11.7 Conduct US research | 0 | days | Thu May 10, 2012 | Fri May 11, 2012 | 203FS + 4 days | Ad Agency |
| 205 | 11.8 US debrief | 0 | days | Mon May 14, 2012 | Mon May 14, 2012 | 204 | Ad Agency |
| 206 | 11.9 Internal changes and Agency updates to US | 0 | days | Thu May 17, 2012 | Tue May 22, 2012 | 205FS + 2 days | Ad Agency |
| 207 | 11.10 LMR Approval Review and approval (2 weeks | 0 | days | Fri May 25, 2012 | Mon Jun. 4, 2012 | 206FS + 2 days | Regulatory, Medical Director, Legal, Brand Manage [symbol] |
| | for LMR Approval review and approval) | | | | | | |
| 208 | 11.11 Final approvals | 0 | days | Mon Jun. 4, 2012 | Mon Jun. 4, 2012 | 207 | Executive Management |
| 209 | 11.12 Prepare for submission to DDMAC to | 0 | days | Tue Jun. 5, 2012 | Mon Jun. 11, 2012 | 208 | Brand Management, Regulatory |
| | Regulatory | | | | | | |
| 210 | 11.13 Submission to Regulatory for inclusion in the | 0 | days | Tue Jun. 12, 2012 | Tue Jun. 12, 2012 | 209FS + 1 day | Regulatory, Brand Management, Market Research |
| | IPC (DDMAC) | | | | | | |
| 211 | 11.14 Receive DDMAC response | 0 | days | Tue Sep. 4, 2012 | Tue Sep. 4, 2012 | 210FS + 7.5 mons | |
| 212 | 12 Annotated Visual Aid | 623 | days | Fri Jan. 21, 2011 | Tue Jun. 11, 2013 | | |
| 213 | 12.1 Agency begins linking concept to Pre DDMAC v | 21 | days | Fri Jan. 21, 2011 | Fri Feb. 18, 2011 | | Market Research, Ad Agency |
| 214 | 12.2 Marketing submission | 1 | day | Mon Feb. 21, 2011 | Mon Feb. 21, 2011 | 213 | Market Research, Ad Agency |
| 215 | 12.3 Marketing comments | 5 | days | Fri Jan. 21, 2011 | Thu Jan. 27, 2011 | 213SS | Ad Agency |
| 216 | 12.4 LMR Approval Submisison | 2 | days | Fri Jan. 28, 2011 | Mon Jan. 31, 2011 | 215 | Ad Agency |
| 217 | 12.5 Marketing Approval | 7 | days | Tue Feb. 1, 2011 | Wed Feb. 9, 2011 | 216 | Ad Agency |
| 218 | 12.6 Agency refinements | 3 | days | Wed Feb. 16, 2011 | Fri Feb. 18, 2011 | 217FS + 4 days | Ad Agency |
| 219 | 12.7 Conduct US research | 2 | days | Fri Feb. 25, 2011 | Mon Feb. 28, 2011 | 218FS + 4 days | Ad Agency |
| 220 | 12.8 US debrief | 1 | day | Tue Mar. 1, 2011 | Tue Mar. 1, 2011 | 219 | Ad Agency |
| 221 | 12.9 Internal changes and Agency updates to US | 4 | days | Fri Mar. 4, 2011 | Wed Mar. 9, 2011 | 220FS + 2 days | Ad Agency |
| 222 | 12.10 LMR Approval Review and approval (2 weeks | 7 | days | Mon Mar. 14, 2011 | Tue Mar. 22, 2011 | 221FS + 2 days | Regulatory, Medical Director, Legal, Brand Manage [symbol] |
| 223 | 12.11 Final approvals | 0 | days | Tue Mar. 22, 2011 | Tue Mar. 22, 2011 | 222 | Executive Management |
| 224 | 12.12 Prepare for submission to DDMAC to Regulat [symbol] | 5 | days | Wed Mar. 23, 2011 | Tue Mar. 29, 2011 | 223 | Brand Management, Regulatory |
| 225 | 12.13 Submission to Regulatory for inclusion in the | 0 | days | Wed Mar. 30, 2011 | Wed Mar. 30, 2011 | 224FS + 1 day | Regulatory, Brand Management, Market Research |
| 226 | 12.14 Receive DDMAC response | 0 | days | Wed Jun. 22, 2011 | Wed Jun. 22, 2011 | 225FS + 7.5 mons | |
| 227 | 12.15 Brand Reminders (File and Go) | 0 | mons | Wed Sep. 5, 2012 | Tue Jun. 11, 2013 | 211 | Market Research, Brand Management |
| 228 | 13 Launch Journal Ads | 113.5 | days | Thu Apr. 5, 2012 | Tue Sep. 11, 2012 | | |
| 229 | 13.1 Agency begins development | 0 | days | Thu Apr. 5, 2012 | Wed May 2, 2012 | 4 | |
| 230 | 13.2 Marketing submission | 0 | days | Thu May 3, 2012 | Fri May 11, 2012 | 229 | Ad Agency |
| 231 | 13.3 Marketing comments received | 0 | days | Mon May 14, 2012 | Wed May 23, 2012 | 230 | Ad Agency |
| 232 | 13.4 LMR Approval submission | 0 | days | Wed May 23, 2012 | Wed May 23, 2012 | 231 | |
| 233 | 13.5 LMR Approval review, comment and approval | 0 | days | Wed May 30, 2012 | Tue Jun. 5, 2012 | 232FS + 4 days | Ad Agency |
| 234 | 13.6 Final Marketing submission | 0 | days | Fri Jun. 8, 2012 | Thu Jun. 14, 2012 | 233FS + 2 days | Ad Agency |
| 235 | 13.7 Final Marketing approval | 0 | days | Thu Jun. 14, 2012 | Tue Jun. 19, 2012 | 234 | Ad Agency |
| 236 | 13.8 Submission to regulatory for review prior to | 0 | days | Tue Jun. 19, 2012 | Tue Jun. 26, 2012 | 235 | Ad Agency |
| | submissin to DDMAC | | | | | | |
| 237 | 13.9 Agency disk Release | 0 | days | Tue Jun. 26, 2012 | Wed Jun. 27, 2012 | 236 | Ad Agency |
| 238 | 13.10 Submission to DDMAC as File & Go | 0 | days | Tue Sep. 11, 2012 | Tue Sep. 11, 2012 | 235FS + 60 days | Ad Agency, Regulatory |
| 239 | 14 Now Available Journal Ads | 75.5 | days? | Thu Apr. 5, 2012 | Thu Jul. 19, 2012 | | |
| 240 | 14.1 Agency submission | 0 | days | Thu Apr. 5, 2012 | Fri Apr. 6, 2012 | 4 | Ad Agency |
| 241 | 14.2 Marketing comments received | 0 | days | Wed Apr. 18, 2012 | Thu Apr. 26, 2012 | 240FS + 7 days | Ad Agency |
| 242 | 14.3 LMR Approval submission | 0 | days | Mon Apr. 30, 2012 | Mon Apr. 30, 2012 | 241FS + 1 day | |
| 243 | 14.4 LMR Approval review, comment and approval | 0 | days | Fri May 4, 2012 | Thu May 10, 2012 | 242FS + 3 days | Ad Agency |
| 244 | 14.5 Final Approval submission | 0 | days | Thu May 10, 2012 | Wed May 16, 2012 | 243FS − 1 day | Ad Agency |
| 245 | 14.6 Final Approval received | 0 | days | Wed May 16, 2012 | Wed May 16, 2012 | 244 | Ad Agency |
| 246 | 14.7 Agency disk Release | 0 | days | Wed May 16, 2012 | Wed May 16, 2012 | 245FF | Ad Agency |
| 247 | 14.8 Submit to DDMAC as a File & Go | 0 | days? | Thu Jul. 19, 2012 | Thu Jul. 19, 2012 | 246FS + 45 days | Ad Agency, Regulatory |
| 248 | 15 File Card | 48 | days | Thu Apr. 5, 2012 | Mon Jun. 11, 2012 | | |
| 249 | 15.1 Agency begins development | 0 | days | Thu Apr. 5, 2012 | Wed May 2, 2012 | 4 | |
| 250 | 15.2 Marketing submission | 0 | days | Thu Apr. 5, 2012 | Fri Apr. 20, 2012 | 4 | Ad Agency |
| 251 | 15.3 Marketing comments received | 0 | days | Mon Apr. 23, 2012 | Fri May 11, 2012 | 250 | Ad Agency |
| 252 | 15.4 LMR Approval submission | 0 | days | Mon May 14, 2012 | Mon May 14, 2012 | 251 | Ad Agency |
| 253 | 15.5 LMR Approval review, comment and approval | 0 | days | Fri May 18, 2012 | Fri May 25, 2012 | 252FS + 3 days | Ad Agency |
| 254 | 15.6 Final Marketing submission | 0 | days | Tue May 29, 2012 | Wed May 30, 2012 | 253FS + 1 day | Ad Agency |
| 255 | 15.7 Final Marketing approval | 0 | days | Thu May 31, 2012 | Tue Jun. 5, 2012 | 254 | Ad Agency |
| 256 | 15.8 Agency disk Release | 0 | days | Wed Jun. 6, 2012 | Wed Jun. 6, 2012 | 255 | Ad Agency |
| 257 | 15.9 Submission to regulatory for review prior to | 0 | days | Wed Jun. 6, 2012 | Mon Jun. 11, 2012 | 256SS | Ad Agency |
| | submissin to DDMAC | | | | | | |
| 258 | 15.10 Submission to DDMAC as a File and Go | 0 | days | Mon Jun. 11, 2012 | Mon Jun. 11, 2012 | 257 | Ad Agency, Regulatory |
| 259 | 16 Dosing Card | 47 | days | Thu Apr. 5, 2012 | Fri Jun. 8, 2012 | | |
| 260 | 16.1 Agency begins development | 0 | days | Thu Apr. 5, 2012 | Wed Apr. 18, 2012 | 4 | |
| 261 | 16.2 Marketing submission | 0 | days | Thu Apr. 5, 2012 | Wed Apr. 11, 2012 | 4 | Ad Agency |
| 262 | 16.3 Marketing comments received | 0 | days | Thu Apr. 12, 2012 | Tue Apr. 24, 2012 | 261 | Ad Agency |
| 263 | 16.4 LMR Approval submission | 0 | days | Wed Apr. 25, 2012 | Wed Apr. 25, 2012 | 262 | Ad Agency |
| 264 | 16.5 LMR Approval review, comment and approval | 0 | days | Tue May 1, 2012 | Tue May 8, 2012 | 263FS + 3 days | Ad Agency |
| 265 | 16.6 Final Marketing submission | 0 | days | Mon May 21, 2012 | Mon May 21, 2012 | 264FS + 8 days | Ad Agency |
| 266 | 16.7 Final Marketing approval | 0 | days | Tue May 29, 2012 | Tue May 29, 2012 | 265FS + 5 days | Ad Agency |
| 267 | 16.8 Agency disk Release | 0 | days | Fri Jun. 1, 2012 | Fri Jun. 1, 2012 | 266FS + 2 days | Ad Agency |
| 268 | 16.9 Submission to regulatory for review prior to | 0 | days | Mon Jun. 4, 2012 | Fri Jun. 8, 2012 | 267 | Ad Agency |
| | submissin to DDMAC | | | | | | |
| 269 | 16.10 Submission to DDMAC as a File and Go | 0 | days | Fri Jun. 8, 2012 | Fri Jun. 8, 2012 | 268 | Ad Agency, Regulatory |
| 270 | 17 Reprint Carrier | 57.5 | days | Thu Apr. 5, 2012 | Mon Jun. 25, 2012 | | |
| 271 | 17.1 Agency begins development | 0 | days | Thu Apr. 5, 2012 | Wed May 2, 2012 | 4 | |
| 272 | 17.2 Marketing submission | 0 | days | Thu May 3, 2012 | Fri May 18, 2012 | 271 | Ad Agency |
| 273 | 17.3 Marketing comments received | 0 | days | Mon May 21, 2012 | Tue May 22, 2012 | 272 | Ad Agency |
| 274 | 17.4 LMR Approval submission | 0 | days | Fri May 25, 2012 | Fri May 25, 2012 | 273FS + 2 days | |
| 275 | 17.5 LMR Approval review, comment and approval | 0 | days | Thu May 31, 2012 | Thu Jun. 7, 2012 | 274FS + 3 days | Ad Agency |
| 276 | 17.6 Final Marketing submission | 0 | days | Mon Jun. 11, 2012 | Mon Jun. 11, 2012 | 275FS + 1 day | Ad Agency |
| 277 | 17.7 Final Marketing approval | 0 | days | Fri Jun. 15, 2012 | Tue Jun. 19, 2012 | 276FS + 3 days | Ad Agency |
| 278 | 17.8 Agency disk Release | 0 | days | Wed Jun. 20, 2012 | Wed Jun. 20, 2012 | 277 | Ad Agency |
| 279 | 17.9 Submission to regulatory for review prior to | 0 | days | Thu Jun. 21, 2012 | Mon Jun. 25, 2012 | 278 | Ad Agency, Regulatory |
| | submissoin to DDMAC | | | | | | |
| 280 | 17.10 Approval DDMAC as a File and Go | 0 | days | Mon Jun. 25, 2012 | Mon Jun. 25, 2012 | 279 | |
| 281 | 18 Now Available Convention Panels | 68.5 | days? | Thu Apr. 5, 2012 | Tue Jul. 10, 2012 | | |
| 282 | 18.1 Agency begins development | 0 | days | Thu Apr. 5, 2012 | Wed May 9, 2012 | 4 | |
| 283 | 18.2 Marketing submission | 0 | days | Thu May 10, 2012 | Fri May 11, 2012 | 282 | Ad Agency |
| 284 | 18.3 Marketing comments received | 0 | days | Mon May 14, 2012 | Fri May 18, 2012 | 283 | Ad Agency |
| 285 | 18.4 LMR Approval submission | 0 | days | Fri Jun. 8, 2012 | Fri Jun. 8, 2012 | 284FS + 14 days | Ad Agency |
| 286 | 18.5 LMR Approval review, comment and approval | 0 | days | Wed Jun. 13, 2012 | Wed Jun. 20, 2012 | 285FS + 2 days | Ad Agency |
| 287 | 18.6 Final Approval submission | 0 | days | Thu Jun. 21, 2012 | Fri Jun. 22, 2012 | 286 | Ad Agency |
| 288 | 18.7 Final Marketing approval | 0 | days | Mon Jun. 25, 2012 | Fri Jun. 29, 2012 | 287 | Ad Agency |
| 289 | 18.8 Agency disk Release | 0 | days | Mon Jul. 2, 2012 | Mon Jul. 2, 2012 | 288 | Ad Agency |
| 290 | 18.9 Submission to Regulatory for review | 0 | days | Tue Jul. 3, 2012 | Mon Jul. 9, 2012 | 289 | Ad Agency |
| 291 | 18.10 Submit to DDMAC as a File and Go | 0 | days? | Tue Jul. 10, 2012 | Tue Jul. 10, 2012 | 290 | Ad Agency, Regulatory |
| 292 | 19 Table Top Panels | 113.5 | days | Thu Apr. 5, 2012 | Tue Sep. 11, 2012 | | |
| 293 | 19.1 Agency begins development | 0 | days | Thu Apr. 5, 2012 | Wed May 9, 2012 | 4 | |
| 294 | 19.2 Marketing submission | 0 | days | Thu May 10, 2012 | Fri May 25, 2012 | 293 | Ad Agency |
| 295 | 19.3 Marketing comments received | 0 | days | Mon May 28, 2012 | Fri Jun. 8, 2012 | 294 | Ad Agency |
| 296 | 19.4 LMR Approval submission | 0 | days | Wed Jun. 13, 2012 | Wed Jun. 13, 2012 | 295FS + 2 days | Ad Agency |
| 297 | 19.5 LMR Approval review, comment and approval | 0 | days | Tue Jun. 19, 2012 | Tue Jun. 26, 2012 | 296FS + 3 days | |
| 298 | 19.6 Final Marketing submission | 0 | days | Wed Jun. 27, 2012 | Thu Jun. 28, 2012 | 297 | Ad Agency |
| 299 | 19.7 Final Marketing approval | 0 | days | Fri Jun. 29, 2012 | Mon Jul. 2, 2012 | 298 | Ad Agency |
| 300 | 19.8 Agency disk Release | 0 | days | Tue Jul. 3, 2012 | Tue Jul. 3, 2012 | 299 | Ad Agency |
| 301 | 19.9 Submission to regulatory for review prior to | 0 | days | Tue Jul. 3, 2012 | Thu Jul. 5, 2012 | 299 | Ad Agency, Regulatory |
| | submissin to DDMAC | | | | | | |
| 302 | 19.10 Submission to DDMAC as a File and Go | 0 | days | Tue Sep. 11, 2012 | Tue Sep. 11, 2012 | 301FS + 48 days | |
| 303 | 20 Promotional Convention Panel (8) | 260.5 | days | Thu Jun. 30, 2011 | Thu Jun. 28, 2012 | | |
| 304 | 20.1 Agency begins development | 0 | days | Thu Apr. 5, 2012 | Wed May 9, 2012 | 4 | |
| 305 | 20.2 Marketing submission | 0 | days | Thu Apr. 5, 2012 | Fri Apr. 20, 2012 | 4 | Ad Agency |
| 306 | 20.3 Marketing comments received | 0 | days | Mon Apr. 23, 2012 | Fri May 4, 2012 | 305 | Ad Agency |
| 307 | 20.4 LMR Approval submission | 0 | days | Wed May 9, 2012 | Wed May 9, 2012 | 306FS + 2 days | |
| 308 | 20.5 LMR Approval review, comment and approval | 0 | days | Tue May 15, 2012 | Tue May 22, 2012 | 307FS + 3 days | |
| 309 | 20.6 Final Marketing submission | 0 | days | Wed May 23, 2012 | Wed May 23, 2012 | 308 | Ad Agency |
| 310 | 20.7 Final Marketing approval | 0 | days | Thu May 24, 2012 | Mon May 28, 2012 | 309 | Ad Agency |
| 311 | 20.8 Agency disk Release | 0 | days | Tue May 29, 2012 | Tue May 29, 2012 | 310 | Ad Agency |
| 312 | 20.9 Submission to regulatory for review prior to | 0 | days | Tue May 29, 2012 | Thu May 31, 2012 | 310 | Ad Agency, Regulatory |
| | submissin to DDMAC | | | | | | |
| 313 | 20.10 Submission to DDMAC as a File and Go | 0 | days | Thu Jun. 28, 2012 | Thu Jun. 28, 2012 | 312FS + 20 days | |
| 314 | 20.11 Pre Market Theraputic | 22.5 | mons | Thu Jun. 30, 2011 | Wed Mar. 7, 2012 | 4FF − 2.5 mons | Ad Agency, Medical Director |
| | Pub/Advertorials/Disease State Publication 1 | | | | | | |
| 315 | 20.12 Pre Market Theraputic | 20 | mons | Thu Jun. 30, 2011 | Wed Feb. 8, 2012 | 4FF − 5 mons | Ad Agency, Medical Director |
| | Pub/Advertorials/Disease State Publication 2 | | | | | | |
| 316 | 21 US Product Monograph | 271.88 | days? | Wed Aug. 24, 2011 | Thu Sep. 6, 2012 | | |
| 317 | 21.1 Submitted to client | 1 | day? | Wed Aug. 24, 2011 | Thu Aug. 25, 2011 | 2FS + 7.5 mons | Ad Agency |
| 318 | 21.2 Comments received from Medical | 13 | days | Thu Aug. 25, 2011 | Tue Sep. 13, 2011 | 317 | Ad Agency, Medical |
| 319 | 21.3 Comments due back from Brand | 3.33 | days | Tue Sep. 13, 2011 | Fri Sep. 16, 2011 | 318 | Ad Agency, Medical, Brand Management |
| 320 | 21.4 Incorporate Brand Comments | 3 | days | Fri Sep. 16, 2011 | Wed Sep. 21, 2011 | 319 | Ad Agency, Medical |
| 321 | 21.5 Submit to editorial for review | 1 | day? | Wed Sep. 21, 2011 | Thu Sep. 22, 2011 | 320 | Ad Agency, Medical |
| 322 | 21.6 Editorial review complete | 4 | days | Thu Sep. 22, 2011 | Wed Sep. 28, 2011 | 321 | Ad Agency, Medical |
| 323 | 21.7 Internal scientific review complete | 6 | days | Wed Sep. 28, 2011 | Thu Oct. 6, 2011 | 322 | Medical |
| 324 | 21.8 LMR Approval review | 5 | days | Thu Oct. 6, 2011 | Thu Oct. 13, 2011 | 323 | Ad Agency, Legal, Brand Management, Reglatory, Sa [symbol] |
| 325 | 21.9 Incorporate LMR Approval comments | 1 | day? | Thu Oct. 13, 2011 | Fri Oct. 14, 2011 | 324 | Ad Agency |
| 326 | 21.10 LMR Approval resubmission with | 6 | days | Fri Oct. 14, 2011 | Mon Oct. 24, 2011 | 325 | Ad Agency, Legal, Brand Management, Regulatory, [symbol] |
| | incorporated comments | | | | | | |
| 327 | 21.11 LMR Approval review | 4 | days | Mon Oct. 24, 2011 | Fri Oct. 28, 2011 | 326 | Ad Agency, Legal, Brand Management, Regulatory, [symbol] |
| 328 | 21.12 Begin layout | 1 | day? | Fri Oct. 28, 2011 | Mon Oct. 31, 2011 | 327 | Ad Agency |
| 329 | 21.13 Align content with the final Pi | 0 | wks | Thu Apr. 5, 2012 | Wed Apr. 11, 2012 | 4 | |
| 330 | 21.14 Editorial review | 0 | days | Thu Apr. 12, 2012 | Thu Apr. 19, 2012 | 329 | Ad Agency |
| 331 | 21.15 Final Agency Internal Review | 0 | days | Fri Apr. 20, 2012 | Wed Apr. 25, 2012 | 330 | Ad Agency |
| 332 | 21.16 Layout to LMR Approval | 0 | days | Thu Apr. 26, 2012 | Mon Apr. 30, 2012 | 331 | Ad Agency, Legal, Brand Management, Regulatory, [symbol] |
| 333 | 21.17 LMR Approval review | 0 | days | Tue May 1, 2012 | Mon May 7, 2012 | 332 | Ad Agency, Legal, Brand Management, Regulatory, [symbol] |
| 334 | 21.18 Disk Release with specification sheet | 0 | days | Tue May 8, 2012 | Wed May 9, 2012 | 333 | Ad Agency, Legal, Brand Management, Regulatory, [symbol] |
| 335 | 21.19 Submit to DDMAC as File and Go | 0 | days | Wed Sep. 5, 2012 | Thu Sep. 6, 2012 | 211 | |
| 336 | 22 Brand MOA Animation | 263.88 | days? | Wed Jun. 1, 2011 | Mon Jun. 4, 2012 | | |
| 337 | 22.1 Agency develops script outline | 23 | days | Wed Jun. 1, 2011 | Mon Jul. 4, 2011 | 2 | Medical Agency |
| 338 | 22.2 Agency submits script outline to client | 5 | days | Mon Jul. 4, 2011 | Mon Jul. 11, 2011 | 337 | Medical Agency, Brand Management, Medical Dire [symbol] |
| 339 | 22.3 Agency receives consolidated comments | 1 | day | Mon Jul. 11, 2011 | Tue Jul. 12, 2011 | 338 | Ad Agency |
| 340 | 22.4 Script Development with Storyboards | 202.88 | days | Tue Jul. 12, 2011 | Thu Apr. 19, 2012 | | |
| 341 | 22.4.1 Agency develops 1st draft script and | 5 | days | Tue Jul. 12, 2011 | Tue Jul. 19, 2011 | 339 | Medical Agency |
| | characters | | | | | | |
| 342 | 22.4.2 Agency submits script and characters to | 0 | days | Tue Jul. 19, 2011 | Tue Jul. 19, 2011 | 341 | Medical Agency |
| | client | | | | | | |
| 343 | 22.4.3 Agency receives consolidated comments | 2 | days | Tue Jul. 19, 2011 | Thu Jul. 21, 2011 | 342 | Medical Agency |
| 344 | 22.4.4 Agency updates script and characters | 0 | days | Thu Apr. 5, 2012 | Mon Apr. 9, 2012 | 4 | Medical Agency |
| 345 | 22.4.5 Agency submits script and characters to | 0 | days | Mon Apr. 9, 2012 | Mon Apr. 9, 2012 | 344 | Medical Agency |
| | client | | | | | | |
| 346 | 22.4.6 Agency receives consolidated comments | 0 | days | Tue Apr. 10, 2012 | Wed Apr. 11, 2012 | 345 | Medical Agency |
| 347 | 22.4.7 Agency updates script with storyboards | 0 | days | Thu Apr. 12, 2012 | Tue Apr. 17, 2012 | 346 | Medical Agency |
| | and submits to LMR Approval | | | | | | |
| 348 | 22.4.8 LMR Approval Review | 0 | days | Thu Apr. 12, 2012 | Thu Apr. 19, 2012 | 346 | Medical Agency, Legal, Brand Management, Regulat [symbol] |
| 349 | 22.5 MOA video production | 43 | days? | Thu Apr. 5, 2012 | Mon Jun. 4, 2012 | | |
| 350 | 22.5.1 Agency receives final script approval | 0 | days? | Thu Apr. 5, 2012 | Thu Apr. 5, 2012 | 4 | Medical Agency |
| 351 | 22.5.2 LMR Approval Review | 0 | days | Fri Apr. 6, 2012 | Fri Apr. 13, 2012 | 350 | Medical Agency, Legal, Brand Management, Regulat [symbol] |
| 352 | 22.5.3 Develop MOA rough cut | 0 | days | Mon Apr. 16, 2012 | Thu May 31, 2012 | 351 | Medical Agency |
| 353 | 22.5.4 Agency submits rough cut to client | 0 | days? | Fri Jun. 1, 2012 | Fri Jun. 1, 2012 | 352 | Medical Agency |
| 354 | 22.5.5 Agency receives consolidated comments | 0 | days? | Mon Jun. 4, 2012 | Mon Jun. 4, 2012 | 353 | Medical Agency |
| | of rough cut | | | | | | |
| 355 | 22.5.6 Agency updates based on client | 0 | days | Thu Apr. 5, 2012 | Thu Apr. 19, 2012 | 4 | Medical Agency |
| | comments and PI | | | | | | |
| 356 | 22.5.7 Agency submits fine cut for final LMR | 0 | days? | Thu Apr. 19, 2012 | Thu Apr. 19, 2012 | 355FS − 1 day | Medical Agency |
| | Approval Review | | | | | | |
| 357 | 22.5.8 LMR Approval Review of Final MOA | 0 | days? | Wed Apr. 25, 2012 | Wed Apr. 25, 2012 | 356FS + 3 days | Medical Director, Legal, Brand Management, Regula [symbol] |
| 358 | 22.5.9 Agency updates and submits final MOA to | 0 | days | Thu Apr. 26, 2012 | Wed May 2, 2012 | 357 | Medical Agency |
| | client | | | | | | |
| 359 | 23 Conventions and Exhibits | 57 | days | Wed Jun. 1, 2011 | Fri Aug. 19, 2011 | | |
| 360 | 23.1 Conventions and Events Strategy | 10 | days | Wed Jun. 1, 2011 | Wed Jun. 15, 2011 | | |
| 361 | 23.1.1 Develop convention schedule | 10 | days | Wed Jun. 1, 2011 | Wed Jun. 15, 2011 | | |
| 362 | 23.1.1.1 Convention 1 | 5 | wks | Wed Jun. 1, 2011 | Wed Jun. 15, 2011 | 3 | Ad Agency, Brand Management, Convention Servic [symbol] |
| 363 | 23.1.1.2 Convention 2 | 5 | wks | Wed Jun. 1, 2011 | Wed Jun. 15, 2011 | 3 | Ad Agency, Brand Management, Convention Servic [symbol] |
| 364 | 23.1.1.3 Convention 3 | 5 | wks | Wed Jun. 1, 2011 | Wed Jun. 15, 2011 | 3 | Ad Agency, Brand Management, Convention Servic [symbol] |
| 365 | 23.1.1.4 Convention 4 | 5 | wks | Wed Jun. 1, 2011 | Wed Jun. 15, 2011 | 3 | Ad Agency, Brand Management, Convention Servic [symbol] |
| 366 | 23.2 Special marketing Initiatives | 57 | days | Wed Jun. 1, 2011 | Fri Aug. 19, 2011 | | |
| 367 | 23.2.1 Marketing submission | 2 | days | Wed Jun. 1, 2011 | Fri Jun. 3, 2011 | 2 | |
| 368 | 23.2.2 Marketing comments | 10 | days | Fri Jun. 3, 2011 | Fri Jun. 17, 2011 | 367 | Ad Agency |
| 369 | 23.2.3 LMR Approval submission | 8 | days | Tue Jun. 28, 2011 | Fri Jul. 8, 2011 | 368FS + 7 days | Ad Agency |
| 370 | 23.2.4 LMR Approval comments | 10 | days | Fri Jul. 8, 2011 | Fri Jul. 22, 2011 | 369 | Ad Agency |
| 371 | 23.2.5 Approval submission | 0 | days | Fri Jul. 22, 2011 | Fri Jul. 22, 2011 | 370 | Ad Agency, Regulatory, Medical, Brand Manageme [symbol] |
| 372 | 23.2.6 Agency Release | 10 | wks | Fri Jul. 22, 2011 | Fri Aug. 19, 2011 | 371 | Ad Agency, Brand Management, Convention Servic [symbol] |
| 373 | 24 Launch Meeting | 137 | days? | Thu Jan. 26, 2012 | Fri Aug. 3, 2012 | | |
| 374 | 24.1 Site Selection Evaluation | 51 | days | Thu Jan. 26, 2012 | Thu Apr. 5, 2012 | | |
| 375 | 24.1.1 Agency/Brand input session | 0 | days | Thu Jan. 26, 2012 | Thu Jan. 26, 2012 | 4FS − 6.25 mons | Brand Management, Production Agency, Meeting P [symbol] |
| 376 | 24.1.2 Brand answers outstanding questions | 0 | days | Fri Jan. 27, 2012 | Thu Feb. 16, 2012 | 375 | Brand Management, Production Agency, Meeting P [symbol] |
| | from planners | | | | | | |
| 377 | 24.1.3 Agencies develop pitch presentation | 0 | days | Fri Feb. 17, 2012 | Wed Feb. 29, 2012 | 376 | Brand Management, Production Agency, Meeting P [symbol] |
| 378 | 24.1.4 Agencies pitch presentation | 0 | days | Thu Mar. 1, 2012 | Thu Mar. 1, 2012 | 377 | Brand Management, Production Agency, Meeting P [symbol] |
| 379 | 24.1.5 Launch Meeting Contract Process | 0 | mons | Fri Mar. 9, 2012 | Thu Apr. 5, 2012 | 378FS + 5 days | Brand Management, Production Agency, Meeting P [symbol] |
| 380 | 24.2 Agenda Creation (Brand Management and | 50 | days | Fri Feb. 17, 2012 | Thu Apr. 26, 2012 | | |
| | Sales) | | | | | | |
| 381 | 24.2.1 Development and finalization of Meeting | 0 | wks | Fri Feb. 17, 2012 | Thu Mar. 1, 2012 | 376 | |
| | Agenda | | | | | | |
| 382 | 24.2.2 Development of workshops | 0 | days | Fri Mar. 2, 2012 | Thu Apr. 5, 2012 | 381 | Ad Agency, Brand Management, Meeting Planning, [symbol] |
| 383 | 24.2.3 Senior Management approval of | 0 | wks | Fri Apr. 6, 2012 | Thu Apr. 26, 2012 | 382 | Brand Management |
| | workshops | | | | | | |
| 384 | 24.3 Agency Deliverables | 12.7 | days | Fri Apr. 27, 2012 | Tue May 15, 2012 | | |
| 385 | 24.3.1 Agency submits SOW | 0 | days | Fri Apr. 27, 2012 | Tue May 1, 2012 | 383 | Production Agency, Sales Training |
| 386 | 24.3.2 SOW is circulated and approved | 0 | days | Tue May 1, 2012 | Thu May 3, 2012 | 385 | Production Agency, Sales Training |
| 387 | 24.3.3 Agency develops launch meeting | 0 | days | Thu May 3, 2012 | Thu May 10, 2012 | 386 | Production Agency, Sales Training |
| | platforms | | | | | | |
| 388 | 24.3.4 Extended Brand Team comments | 0 | days | Thu May 10, 2012 | Fri May 11, 2012 | 387 | Production Agency, Sales Training |
| 389 | 24.3.5 Agency incorporates comments | 0 | days | Mon May 14, 2012 | Mon May 14, 2012 | 388 | Production Agency, Sales Training |
| 390 | 24.3.6 LMR Approval Review | 0 | days | Mon May 14, 2012 | Tue May 15, 2012 | 389 | Production Agency, Legal, Brand Management, Reg [symbol] |
| 391 | 24.4 Global Content Steering Committee Meeting | 87 | days? | Thu Apr. 5, 2012 | Fri Aug. 3, 2012 | | |
| 392 | 24.4.1 Launch Meeting Announcement | 0 | days? | Thu Apr. 5, 2012 | Thu Apr. 5, 2012 | 4 | Executive Management |
| 393 | 24.4.2 Invitations sent/RSVP | 0 | days | Fri Apr. 6, 2012 | Mon May 21, 2012 | 392 | Executive Management |
| 394 | 24.4.3 Develop the Field Play Book | 0 | wks | Fri Apr. 6, 2012 | Thu Apr. 26, 2012 | 392 | Ad Agency, Brand Management |
| 395 | 24.4.4 Submitted for LMR review and approval | 0 | days | Fri Apr. 27, 2012 | Mon May 7, 2012 | 394 | |
| | for Field Palybook | | | | | | |
| 396 | 24.4.5 LMR approval for Field Playbook | 0 | days | Tue May 8, 2012 | Tue May 8, 2012 | 395 | |
| 397 | 24.4.6 Completion of all Slide Decks and the | 0 | days | Fri Jun. 1, 2012 | Fri Jun. 1, 2012 | 396, 410, 417, 425 | Ad Agency, Brand Management, Executive Manage [symbol] |
| | Playbook | | | | | | |
| 398 | 24.4.7 Meeting materials finalized | 0 | days | Mon Jun. 4, 2012 | Fri Jun. 15, 2012 | 397 | Ad Agency, Executive Management, Brand Manage [symbol] |
| 399 | 24.4.8 Submitted for LMR review and approval | 0 | days | Mon Jun. 18, 2012 | Tue Jun. 26, 2012 | 398 | |
| | all Launch Materials | | | | | | |
| 400 | 24.4.9 Approval by LMR for all Launch Materials | 0 | days | Wed Jun. 27, 2012 | Wed Jun. 27, 2012 | 399 | |
| 401 | 24.4.10 Launch Meeting Execution and Product R [symbol] | 0 | days | Tue Jul. 24, 2012 | Fri Jul. 27, 2012 | 400FS + 9 wks | Brand Management, Meeting Planning, Executive [symbol] |
| 402 | 24.4.11 Post-meeting report | 0 | days | Mon Jul. 30, 2012 | Fri Aug. 3, 2012 | 401 | Meeting Planning |
| 403 | 24.4.12 Brand Related Deck | 32 | days? | Fri Apr. 20, 2012 | Mon Jun. 4, 2012 | | |
| 404 | 24.4.12.1 Create label slides | 0 | wks | Fri Apr. 20, 2012 | Thu May 3, 2012 | 383FS − 2.5 wks | Ad Agency |
| 405 | 24.4.12.2 Submit to editorial for review | 0 | days | Fri May 4, 2012 | Tue May 8, 2012 | 404 | Ad Agency |
| 406 | 24.4.12.3 Editroial review complete | 0 | days | Tue May 8, 2012 | Tue May 8, 2012 | 405 | Ad Agency |
| 407 | 24.4.12.4 Internal scientific review | 0 | days | Wed May 9, 2012 | Fri May 11, 2012 | 406SS | Ad Agency |
| 408 | 24.4.12.5 LMR Approval review | 0 | days | Mon May 14, 2012 | Tue May 22, 2012 | 407 | Ad Agency, Legal, Brand Management, Regulatory, [symbol] |
| 409 | 24.4.12.6 Incorporate LMR Approval comment | 0 | days | Tue May 22, 2012 | Tue May 22, 2012 | 408 | Ad Agency |
| 410 | 24.4.12.7 LMR Approval resubmission with | 0 | days | Fri May 25, 2012 | Fri Jun. 1, 2012 | 409FS + 2 days | Ad Agency, Legal, Brand Management, Regulatory, [symbol] |
| | incorporated comments | | | | | | |
| 411 | 24.4.12.8 Disk release (10 Copies to the FDA) | 0 | days? | Mon Jun. 4, 2012 | Mon Jun. 4, 2012 | 410 | Ad Agency |
| 412 | 24.4.13 Training Deck Development | 19 | days? | Fri Apr. 27, 2012 | Wed May 23, 2012 | | Production Agency, Ad Agency, Brand Manageme [symbol] |
| 413 | 24.4.13.1 Development of the Training Deck | 0 | days? | Fri Apr. 27, 2012 | Fri Apr. 27, 2012 | 383 | |
| 414 | 24.4.13.2 Submit to LMR Approval Review (& | 0 | days | Mon Apr. 30, 2012 | Mon Apr. 30, 2012 | 413 | Sales Training |
| | Biometric review) | | | | | | |
| 415 | 24.4.13.3 LMR Approval review | 0 | days | Fri May 4, 2012 | Mon May 14, 2012 | 414FS + 3 days | Ad Agency |
| 416 | 24.4.13.4 Final LMR Approval comments are | 0 | days | Tue May 15, 2012 | Thu May 17, 2012 | 415 | Ad Agency, Legal, Brand Management, Regulatory, [symbol] |
| | incorporated | | | | | | |
| 417 | 24.4.13.5 Final LMR Approval review | 0 | days | Fri May 18, 2012 | Mon May 21, 2012 | 416 | Ad Agency, Legal, Brand Management, Regulatory, [symbol] |
| 418 | 24.4.13.6 Release disk to Project Analyst (10 c [symbol] | 0 | days | Tue May 22, 2012 | Wed May 23, 2012 | 417 | Ad Agency |
| 419 | 24.4.14 Core Slide Deck | 30 | days? | Fri Apr. 20, 2012 | Thu May 31, 2012 | | |
| 420 | 24.4.14.1 First draft for client review | 25 | days | Fri Apr. 20, 2012 | Thu May 24, 2012 | 383FS − 2.5 wks | Production Agency |
| 421 | 24.4.14.2 Client comments due back/LMR | 0 | days | Wed May 2, 2012 | Tue May 15, 2012 | 420FS − 17 days | Medical Agency, Legal, Brand Management, Executi [symbol] |
| | Approval Concept Review | | | | | | |
| 422 | 24.4.14.3 Incorporate Client comments to Dra [symbol] | 0 | days | Wed May 16, 2012 | Tue May 22, 2012 | 421 | Production Agency |
| 423 | 24.4.14.4 Editorial Review | 0 | days | Wed May 23, 2012 | Tue May 29, 2012 | 422 | Production Agency |
| 424 | 24.4.14.5 LMR submission | 0 | days? | Wed May 30, 2012 | Wed May 30, 2012 | 423 | |
| 425 | 24.4.14.6 LMR approval and Release | 0 | days? | Thu May 31, 2012 | Thu May 31, 2012 | 424 | |

[symbol]

indicates data missing or illegible when filed

TABLE 2
COMMUNICATION PERSPECTIVE

| ID | Task Name | Duration | | Start | Finish | Predecessors | Resource Names |
|---|---|---|---|---|---|---|---|
| 1 | 1 Start of Project | 0 | days | Wed Jun. 1, 2011 | Wed Jun. 1, 2011 | | |
| 2 | 2 PDUFA Date | 0 | days | Wed Apr. 4, 2012 | Wed Apr. 4, 2012 | 1FS + 11 mons | |
| 3 | 3 External Public Relations | 315 | days | Thu Jun. 2, 2011 | Wed Aug. 15, 2012 | | |
| 4 | 3.1 Select PR Agency | 75 | days | Thu Jun. 2, 2011 | Wed Sep. 14, 2011 | 1 | |
| 5 | 3.1.1 Draft RFP | 5 | days | Thu Jun. 2, 2011 | Wed Jun. 8, 2011 | 1 | |
| 6 | 3.1.2 Review and approve PR RFP | 10 | days | Thu Jun. 9, 2011 | Wed Jun. 22, 2011 | 5 | Communications Director/PR |
| 7 | 3.1.3 Submit proposed PR RFP to Legal for approval | 10 | days | Thu Jun. 23, 2011 | Wed Jul. 6, 2011 | 6 | Communications Director/PR |
| 8 | 3.1.4 Legal review of PR RFP is conducted and completed | 8 | days | Thu Jul. 7, 2011 | Mon Jul. 18, 2011 | 7 | Communications Director/PR |
| 9 | 3.1.5 PR RFP is approved and vendor proposals are solicited | 10 | days | Tue Jul. 19, 2011 | Mon Aug. 1, 2011 | 8 | Communications Director/PR |
| 10 | 3.1.6 Select PR vendor | 4 | wks | Tue Aug. 2, 2011 | Mon Aug. 29, 2011 | 9 | Communications Director/PR |
| 11 | 3.1.7 Develop Public Relations plan | 3 | wks | Thu Jun. 2, 2011 | Wed Jun. 22, 2011 | 51 | Communications Director/PR |
| 12 | 3.1.8 Press Release plan | 2 | wks | Thu Jun. 9, 2011 | Wed Jun. 22, 2011 | 11FF | Communications Director/PR |
| 13 | 3.1.9 Develop press materials | 1 | mon | Thu Jun. 9, 2011 | Wed Jul. 6, 2011 | 12SS | Communications Director/PR |
| 14 | 3.1.10 Launch activities media plan | 40 | days | Thu Jul. 7, 2011 | Wed Aug. 31, 2011 | 13 | Communications Director/PR |
| 15 | 3.1.11 Media briefings | 40 | days | Thu Jul. 21, 2011 | Wed Sep. 14, 2011 | 14SS + 10 days | Communications Director/PR |
| 16 | 3.2 Media monitoring | 300 | days | Thu Jun. 23, 2011 | Wed Aug. 15, 2012 | 11 | Communications Director/PR |
| 17 | 3.2.1 Select Communications Advisory Committee and disc [symbol] | 300 | days | Thu Jun. 23, 2011 | Wed Aug. 15, 2012 | 51 | Communications Director/PR |
| 18 | 3.2.1.1 Identify and liaison with Professional organization [symbol] | 300 | days | Thu Jun. 23, 2011 | Wed Aug. 15, 2012 | | Communications Director/PR |
| 19 | 3.2.1.2 Spokesperson development and media training | 84 | days | Thu Jun. 23, 2011 | Tue Oct. 18, 2011 | | Communications Director/PR |
| 20 | 3.2.2 Develop Image campaign (media outreach/education [symbol] | 1 | day | Thu Jul. 7, 2011 | Thu Jul. 7, 2011 | 13 | |
| 21 | 3.2.2.1 Pre-brief reporters | 1 | day | Thu Jul. 7, 2011 | Thu Jul. 7, 2011 | 1 | Communication |
| 22 | 3.2.2.2 Media train presenters | 1 | day | Thu Jul. 7, 2011 | Thu Jul. 7, 2011 | 1 | Communication |
| 23 | 3.3 Coordinate communications strategy with the Corporate/E [symbol] | 4.5 | wks | Tue Aug. 2, 2011 | Thu Sep. 1, 2011 | 10SS | Communications Director/PR |
| 24 | 3.4 Issue Management Material development | 8 | mons | Tue Aug. 2, 2011 | Mon Mar. 12, 2012 | 10SS | Communications Director/PR |
| 25 | 3.5 (NDA) Product Approval Press Release or reactive statem [symbol] | 42 | days | Wed Feb. 22, 2012 | Thu Apr. 19, 2012 | | |
| 26 | 3.5.1 Develop Press Kit Fact Sheet | 6 | wks | Wed Feb. 22, 2012 | Tue Apr. 3, 2012 | 2SS − 31 days | |
| 27 | 3.5.2 Circulate Press Kit Contents for Approval by LMR | 11 | days | Wed Apr. 4, 2012 | Wed Apr. 18, 2012 | 26 | Communications Director/PR |
| 28 | 3.5.3 Press Kit folders - approved and sent to the printer | 0 | wks | Wed Apr. 18, 2012 | Wed Apr. 18, 2012 | 27 | Communications Director/PR |
| 29 | 3.5.4 B-Roll Tape edited and finalized | 10 | days | Wed Apr. 4, 2012 | Tue Apr. 17, 2012 | 26 | Communications Director/PR |
| 30 | 3.5.5 Distribute Press Kits | 2 | days | Wed Apr. 18, 2012 | Thu Apr. 19, 2012 | 28SS − 1 day | Communications Director/PR |
| 31 | 3.6 Therapeutic area articles | 8 | wks | Wed Feb. 22, 2012 | Tue Apr. 17, 2012 | 26SS | Publications Manager |
| 32 | 4 Conventions and Events Strategy (PR) | 342 | days | Wed Jun. 1, 2011 | Thu Sep. 20, 2012 | | |
| 33 | 4.1 Conventions | 116 | days | Wed Jun. 1, 2011 | Wed Nov. 9, 2011 | | |
| 34 | 4.1.1 Develop convention schedule | 3 | wks | Wed Jun. 1, 2011 | Tue Jun. 21, 2011 | 51 | Convention Services |
| 35 | 4.1.2 Develop Communication objectives | 20 | days | Wed Jun. 1, 2011 | Tue Jun. 28, 2011 | 34SS | Communications Director/PR |
| 36 | 4.1.3 Create Convention tactics (Communications) | 20 | days | Wed Jun. 29, 2011 | Tue Jul. 26, 2011 | 35 | Communications Director/PR |
| 37 | 4.1.4 Develop plan details | 15 | days | Wed Jul. 27, 2011 | Tue Aug. 16, 2011 | 36 | Convention Services |
| 38 | 4.1.5 Organize planning resources | 10 | days | Wed Aug. 17, 2011 | Tue Aug. 30, 2011 | 37 | Convention Services |
| 39 | 4.1.6 Select graphics/artwork vendor | 10 | days | Wed Aug. 31, 2011 | Tue Sep. 13, 2011 | 38 | Convention Services |
| 40 | 4.1.7 Develop prelaunch graphics/artwork | 20 | days | Wed Sep. 14, 2011 | Tue Oct. 11, 2011 | 39 | Convention Services |
| 41 | 4.1.8 Produce prelaunch graphics | 20 | days | Wed Oct. 12, 2011 | Tue Nov. 8, 2011 | 40 | Convention Services |
| 42 | 4.1.9 Select and recruit MSL Medical staffing for exhibiting | 1 | day | Wed Nov. 9, 2011 | Wed Nov. 9, 2011 | 41 | Convention Services |
| 43 | 4.2 Pre and Post Launch Medical Meetings: | 300 | days | Wed Jun. 1, 2011 | Tue Jul. 24, 2012 | | |
| 44 | 4.2.1 Professional Association | 300 | days | Wed Jun. 1, 2011 | Tue Jul. 24, 2012 | 51 | Communications Director/PR |
| 45 | 4.3 Medical Societies | 200 | days | Wed Jun. 1, 2011 | Tue Mar. 6, 2012 | | |
| 46 | 4.3.1 Identify Partners | 3 | wks | Wed Jun. 1, 2011 | Tue Jun. 21, 2011 | 51 | Communications Director/PR |
| 47 | 4.3.2 Determine opportunities | 200 | days | Wed Jun. 1, 2011 | Tue Mar. 6, 2012 | 46SS | Communications Director/PR |
| 48 | 4.3.3 Develop project plans | 200 | days | Wed Jun. 1, 2011 | Tue Mar. 6, 2012 | 47SS | Communications Director/PR |
| 49 | 4.3.4 Sponsorship Negotiation | 200 | days | Wed Jun. 1, 2011 | Tue Mar. 6, 2012 | 48SS | Communications Director/PR |
| 50 | 4.4 Advocacy Group Meetings | 320 | days | Wed Jun. 1, 2011 | Tue Aug. 21, 2012 | | |
| 51 | 4.4.1 Start of Project: NDA filing date | 0 | days | Wed Jun. 1, 2011 | Wed Jun. 1, 2011 | | |
| 52 | 4.4.2 Pre Approval Advocacy Group Meetings | 5 | mons | Wed Jun. 1, 2011 | Tue Oct. 18, 2011 | 51 | Communications Director/PR |
| 53 | 4.4.3 Encourage and prep third parties to distribute news al [symbol] | 60 | days | Wed Oct. 19, 2011 | Tue Jan. 10, 2012 | 52 | Communications Director/PR |
| 54 | 4.4.4 Post Approval Advocacy Group Meetings | 5 | mons | Wed Apr. 4, 2012 | Tue Aug. 21, 2012 | 51FS + 11 mons | Communications Director/PR |
| 55 | 4.5 eMarketing Tactics | 269 | days | Wed Jun. 1, 2011 | Mon Jun. 11, 2012 | | |
| 56 | 4.5.1 Product Back-Up Site Decision | 17 | days | Wed Jun. 1, 2011 | Thu Jun. 23, 2011 | | Brand Management |
| 57 | 4.5.2 Extranet | 203 | days | Fri Jun. 24, 2011 | Tue Apr. 3, 2012 | | |
| 58 | 4.5.2.1 Design | 66 | days | Fri Jun. 24, 2011 | Fri Sep. 23, 2011 | | |
| 59 | 4.5.2.1.1 Requirements Meeting | 4 | days | Fri Jun. 24, 2011 | Wed Jun. 29, 2011 | 56 | Web Services |
| 60 | 4.5.2.1.2 Plan Preparation | 20 | days | Thu Jun. 30, 2011 | Wed Jul. 27, 2011 | 59 | Web Services |
| 61 | 4.5.2.1.3 Plan Approval by LMR | 10 | days | Thu Jul. 28, 2011 | Wed Aug. 10, 2011 | 60 | Web Services |
| 62 | 4.5.2.1.4 Initial Design | 10 | days | Thu Aug. 11, 2011 | Wed Aug. 24, 2011 | 61 | Web Services |
| 63 | 4.5.2.1.5 Design Review Meeting | 2 | days | Thu Aug. 25, 2011 | Fri Aug. 26, 2011 | 62 | Web Services |
| 64 | 4.5.2.1.6 Design Revisions | 10 | days | Mon Aug. 29, 2011 | Fri Sep. 9, 2011 | 63 | Web Services |
| 65 | 4.5.2.1.7 Design Approval by LMR | 10 | days | Mon Sep. 12, 2011 | Fri Sep. 23, 2011 | 64 | Web Services |
| 66 | 4.5.2.2 Extranet Member Recruitment | 27 | days | Wed Nov. 2, 2011 | Thu Dec. 8, 2011 | | |
| 67 | 4.5.2.2.1 Follow-up with Phone to KOL's post recruitme [symbol] | 10 | days | Wed Nov. 2, 2011 | Tue Nov. 15, 2011 | 51FS + 5.5 mons | Web Services |
| 68 | 4.5.2.2.2 Collect content selection feedback | 15 | days | Wed Nov. 16, 2011 | Tue Dec. 6, 2011 | 67 | Web Services |
| 69 | 4.5.2.2.3 Incorporate content suggestions in plan | 2 | days | Wed Dec. 7, 2011 | Thu Dec. 8, 2011 | 68 | Web Services |
| 70 | 4.5.2.3 Build | 137 | days | Mon Sep. 26, 2011 | Tue Apr. 3, 2012 | | |
| 71 | 4.5.2.3.1 Development | 20 | days | Mon Sep. 26, 2011 | Fri Oct. 21, 2011 | 65 | Web Services |
| 72 | 4.5.2.3.2 Content collection | 20 | days | Wed Dec. 7, 2011 | Tue Jan. 3, 2012 | 65, 68, 71 | Web Services |
| 73 | 4.5.2.3.3 Content Load | 10 | days | Wed Jan. 4, 2012 | Tue Jan. 17, 2012 | 72 | Web Services |
| 74 | 4.5.2.3.4 QA Testing | 10 | days | Wed Jan. 18, 2012 | Tue Jan. 31, 2012 | 73 | Web Services |
| 75 | 4.5.2.3.5 Prepare Launch email | 45 | days | Wed Feb. 1, 2012 | Tue Apr. 3, 2012 | 74 | Web Services |
| 76 | 4.5.2.3.6 Send Launch Email | 1 | day | Tue Apr. 3, 2012 | Tue Apr. 3, 2012 | 75FF | Web Services |
| 77 | 4.5.2.3.7 Launch Extranet | 0 | days | Tue Apr. 3, 2012 | Tue Apr. 3, 2012 | 2FS − 2 days | Web Services |
| 78 | 4.5.3 Approval Site | 188 | days | Wed Sep. 21, 2011 | Fri Jun. 8, 2012 | | |
| 79 | 4.5.3.1 Resolution of New Product (Name) URL | 40 | days | Wed Sep. 21, 2011 | Tue Nov. 15, 2011 | 51FS + 16 wks | Web Services |
| 80 | 4.5.3.2 Functional Specification Document | 30 | days | Wed Nov. 16, 2011 | Tue Dec. 27, 2011 | 79 | Web Services |
| 81 | 4.5.3.3 Review, Approval, Signoff | 15 | days | Wed Dec. 28, 2011 | Tue Jan. 17, 2012 | 80 | Web Services |
| 82 | 4.5.3.4 Initial Design | 15 | days | Wed Jan. 18, 2012 | Tue Feb. 7, 2012 | 81 | Web Services |
| 83 | 4.5.3.5 Site design review meeting #1 | 2 | days | Wed Feb. 8, 2012 | Thu Feb. 9, 2012 | 82 | Web Services |
| 84 | 4.5.3.6 Design revisions | 15 | days | Fri Feb. 10, 2012 | Thu Mar. 1, 2012 | 83 | Web Services |
| 85 | 4.5.3.7 Site design review and approval meeting #2 | 2 | days | Fri Mar. 2, 2012 | Mon Mar. 5, 2012 | 84 | Web Services |
| 86 | 4.5.3.8 Site build out | 20 | days | Tue Mar. 20, 2012 | Mon Apr. 16, 2012 | 85FS + 10 days | Web Services |
| 87 | 4.5.3.9 Internal review and approval of Internet Approval | 10 | days | Tue Apr. 17, 2012 | Mon Apr. 30, 2012 | 86 | Web Services |
| 88 | 4.5.3.10 Receive approved PI in PDF Format | 5 | days | Tue May 1, 2012 | Mon May 7, 2012 | 87 | Web Services |
| 89 | 4.5.3.11 Basic Site Launch | 5 | days | Tue May 8, 2012 | Mon May 14, 2012 | 88 | Web Services |
| 90 | 4.5.3.12 CD creation for FDA | 2 | days | Tue May 15, 2012 | Wed May 16, 2012 | 89 | Web Services |
| 91 | 4.5.3.13 Review and approval LMR | 15 | days | Thu May 17, 2012 | Wed Jun. 6, 2012 | 90 | |
| 92 | 4.5.3.14 Submission of Web Site to FDA | 2 | days | Thu Jun. 7, 2012 | Fri Jun. 8, 2012 | 91 | Web Services |
| 93 | 4.5.4 Launch Site | 119 | days | Wed Dec. 28, 2011 | Mon Jun. 11, 2012 | | |
| 94 | 4.5.4.1 Functional Specification Document | 20 | days | Wed Dec. 28, 2011 | Tue Jan. 24, 2012 | 80 | Web Services |
| 95 | 4.5.4.2 LMR Review and Approval | 10 | days | Wed Jan. 25, 2012 | Tue Feb. 7, 2012 | 94 | Web Services |
| 96 | 4.5.4.3 Initial Design | 15 | days | Wed Feb. 8, 2012 | Tue Feb. 28, 2012 | 95 | Web Services |
| 97 | 4.5.4.4 Site design review meeting #1 | 2 | days | Wed Feb. 29, 2012 | Thu Mar. 1, 2012 | 96 | Web Services |
| 98 | 4.5.4.5 Design revisions | 15 | days | Fri Mar. 2, 2012 | Thu Mar. 22, 2012 | 97 | Web Services |
| 99 | 4.5.4.6 Site design review meeting #2 | 2 | days | Fri Mar. 23, 2012 | Mon Mar. 26, 2012 | 98 | Web Services |
| 100 | 4.5.4.7 Site build out | 30 | days | Tue Mar. 27, 2012 | Mon May 7, 2012 | 99 | Web Services |
| 101 | 4.5.4.8 Internal approval of launch site | 10 | days | Tue May 8, 2012 | Mon May 21, 2012 | 100 | Web Services |
| 102 | 4.5.4.9 Basic Site Launch | 2 | days | Tue May 22, 2012 | Wed May 23, 2012 | 101 | Web Services |
| 103 | 4.5.4.10 CD creation for FDA | 1 | day | Thu May 24, 2012 | Thu May 24, 2012 | 102 | Web Services |
| 104 | 4.5.4.11 LMR Review and Approval | 10 | days | Fri May 25, 2012 | Thu Jun. 7, 2012 | 103 | |
| 105 | 4.5.4.12 Submission of Web Site to FDA (DDMAC) | 2 | days | Fri Jun. 8, 2012 | Mon Jun. 11, 2012 | 100, 104 | Web Services |
| 106 | 4.6 Drug approval media blitz | 157 | days | Wed Feb. 15, 2012 | Thu Sep. 20, 2012 | 19 | |
| 107 | 4.6.1 Message Development for the President/CEO | 5 | days | Wed Feb. 22, 2012 | Tue Feb. 28, 2012 | 51FS + 9.5 mons | Communications Director/PR |
| 108 | 4.6.2 Internal media training | 25 | days | Wed Feb. 15, 2012 | Tue Mar. 20, 2012 | 107FS − 10 days | Communications Director/PR |
| 109 | 4.6.3 Grass roots public relations/special events | 132 | days | Wed Mar. 21, 2012 | Thu Sep. 20, 2012 | 108 | Communications Director/PR |
| 110 | 4.6.4 Launch Internet campaign | 44 | days | Wed Mar. 21, 2012 | Mon May 21, 2012 | 108 | Communications Director/PR |
| 111 | 4.6.5 Field awareness campaign/internal campaign | 132 | days | Wed Mar. 21, 2012 | Thu Sep. 20, 2012 | 108 | Communications Director/PR |
| 112 | 5 Post Launch Activities Plan | 100 | days | Wed Apr. 4, 2012 | Tue Aug. 21, 2012 | | |
| 113 | 5.1 Local market seminars (2) | 20 | wks | Wed Apr. 4, 2012 | Tue Aug. 21, 2012 | 51FS + 11 mons | Communications Director/PR |
| 114 | 5.2 National media campaign | 20 | wks | Wed Apr. 4, 2012 | Tue Aug. 21, 2012 | 51FS + 11 mons | Communications Director/PR |
| 115 | 6 Internal Public Relations | 101 | days | Wed Nov. 16, 2011 | Wed Apr. 4, 2012 | | |
| 116 | 6.1 Develop communication tree (call routing) | 86 | days | Wed Nov. 16, 2011 | Wed Mar. 14, 2012 | | |
| 117 | 6.1.1 Reserve toll free “800” number(s) | 10 | days | Wed Jan. 11, 2012 | Tue Jan. 24, 2012 | 51FS + 8 mons | Communications Director/PR |
| 118 | 6.1.2 Script for Sales Force Communications to Clinicians pr [symbol] | 40 | days | Wed Nov. 16, 2011 | Tue Jan. 10, 2012 | 51FS + 6 mons | Communications Director/PR |
| 119 | 6.1.3 Communications to Clinical community via 800 Numbe [symbol] | 40 | days | Wed Nov. 16, 2011 | Tue Jan. 10, 2012 | 118FF | Communications Director/PR |
| 120 | 6.1.4 Script for Medical | 40 | days | Wed Jan. 11, 2012 | Tue Mar. 6, 2012 | 118 | Communications Director/PR |
| 121 | 6.1.5 Script for Drug Information | 40 | days | Wed Jan. 11, 2012 | Tue Mar. 6, 2012 | 120SS | Communications Director/PR |
| 122 | 6.1.6 Script for Consumers | 40 | days | Wed Jan. 11, 2012 | Tue Mar. 6, 2012 | 120SS | Communications Director/PR |
| 123 | 6.1.7 Review and approval of the New Product communicati [symbol] | 4 | days | Wed Mar. 7, 2012 | Mon Mar. 12, 2012 | 122 | Communications Director/PR |
| 124 | 6.1.8 Receive communication training scripts from Marketin [symbol] | 0 | days | Mon Mar. 12, 2012 | Mon Mar. 12, 2012 | 123 | Communications Director/PR |
| 125 | 6.1.9 Training for Sales Force for outreach to the Clinician co [symbol] | 2 | days | Tue Mar. 13, 2012 | Wed Mar. 14, 2012 | 2FS − 3.4 wks | Brand Management, Medical Director, |
| 126 | 6.2 Response to questions regarding the product from the pu [symbol] | 60 | days | Wed Jan. 11, 2012 | Tue Apr. 3, 2012 | | |
| 127 | 6.2.1 Script for Customer Service & Switchboard-Draft | 50 | days | Wed Jan. 11, 2012 | Tue Mar. 20, 2012 | 51FS + 8 mons | Communications Director/PR |
| 128 | 6.2.2 Script for Customer Service & Switchboard-Approval b [symbol] | 10 | days | Wed Mar. 21, 2012 | Tue Apr. 3, 2012 | 127 | Communications Director/PR |
| 129 | 6.2.3 Script for Customer Service & Switchboard-Distribute | 0 | days | Tue Apr. 3, 2012 | Tue Apr. 3, 2012 | 128, 2FS − 2 days | Communications Director/PR |
| 130 | 6.3 Companywide announcement and coordinate Company In | 24 | days | Fri Mar. 2, 2012 | Wed Apr. 4, 2012 | | |
| 131 | 6.3.1 Draft “Approval” Company-Wide Announcement | 5 | days | Wed Mar. 7, 2012 | Tue Mar. 13, 2012 | 51FS + 10 mons | Communications Director/PR |
| 132 | 6.3.2 Submit to Legal and Medical for approval | 10 | days | Wed Mar. 14, 2012 | Tue Mar. 27, 2012 | 131 | Communications Director/PR |
| 133 | 6.3.3 Company wide announcement is approved | 1 | day | Wed Mar. 28, 2012 | Wed Mar. 28, 2012 | 132 | Communications Director/PR |
| 134 | 6.3.4 Post Company-Wide Announcement to Intranet | 1 | day | Thu Mar. 29, 2012 | Thu Mar. 29, 2012 | 133 | Communications Director/PR |
| 135 | 6.3.5 Post the Approval Press Release to Corporate Internet | 1 | day | Thu Mar. 29, 2012 | Thu Mar. 29, 2012 | 134SS | Communications Director/PR |
| 136 | 6.3.6 Send “Approval” Company-Wide Announcement | 1 | day | Thu Mar. 29, 2012 | Thu Mar. 29, 2012 | 134SS | Communications Director/PR |
| 137 | 6.3.7 Post “Approval” Company-Wide Announcement and P [symbol] | 1 | day | Fri Mar. 2, 2012 | Fri Mar. 2, 2012 | 98SS | Communications Director/PR |
| 138 | 6.3.8 Draft “Launch” Company-Wide Announcement | 5 | days | Mon Mar. 5, 2012 | Fri Mar. 9, 2012 | 137 | Communications Director/PR |
| 139 | 6.3.9 Submit to LMR | 10 | days | Mon Mar. 12, 2012 | Fri Mar. 23, 2012 | 138 | Communications Director/PR |
| 140 | 6.3.10 Send “Launch” Company-Wide Announcement | 0 | days | Wed Apr. 4, 2012 | Wed Apr. 4, 2012 | 2 | Communications Director/PR |
| 141 | 6.3.11 Post “Launch” Company-Wide Announcement and Pr [symbol] | 0 | days | Wed Apr. 4, 2012 | Wed Apr. 4, 2012 | 2 | Communications Director/PR, Web Se [symbol] |
| 142 | 6.3.12 Prepare “Internal Newsletter” article on Product Laun | 15 | days | Wed Mar. 14, 2012 | Tue Apr. 3, 2012 | 132FS − 10 days | Communications Director/PR |
| 143 | 6.3.13 Home Office Celebration Events | 1 | day | Wed Apr. 4, 2012 | Wed Apr. 4, 2012 | 51FS + 11 mons | |

[symbol]

indicates data missing or illegible when filed

TABLE 3
MANAGED MARKETS PERSPECTIVE

| ID | Task Name | Duration | | Start |
|---|---|---|---|---|
| 1 | 1 National Advisory Boards (Managed Markets) | 227 | days | Wed Jun. 1, 2011 |
| 2 | 1.1 Ad Board Initial Planning (Managed Markets) | 7.5 | days | Wed Jun. 1, 2011 |
| 3 | 1.1.1 Objectives and Agenda | 1 | day | Wed Jun. 1, 2011 |
| 4 | 1.1.2 Available funding and budget availability reviewed for [symbol] | 1.5 | days | Thu Jun. 2, 2011 |
| 5 | 1.1.3 Commitment to conducting the meeting | 0 | days | Fri Jun. 3, 2011 |
| 6 | 1.1.4 Complete/Submit Meeting Request Form to Meeting P [symbol] | 0.5 | days | Fri Jun. 3, 2011 |
| 7 | 1.1.5 Meeting specifics and budget reviewed and approved [symbol] | 0.5 | days | Wed Jun. 8, 2011 |
| 8 | 1.1.6 Develop Meeting Objectives and Agenda | 1 | day | Wed Jun. 8, 2011 |
| 9 | 1.1.7 Identify KOL's | 1 | day | Thu Jun. 9, 2011 |
| 10 | 1.2 Ad Board Activity Content Development (Managed Mark [symbol] | 37 | days | Wed Jun. 1, 2011 |
| 11 | 1.2.1 Objectives and Agenda | 12 | days | Wed Jun. 1, 2011 |
| 12 | 1.2.2 Schedule clinical presentations | 1 | day | Wed Jun. 1, 2011 |
| 13 | 1.2.3 Identify speakers | 3 | days | Thu Jun. 2, 2011 |
| 14 | 1.2.4 Determine which materials to provide (literature, IB, e [symbol] | 10 | days | Wed Jun. 1, 2011 |
| 15 | 1.2.5 Ad Board Questions-prepare draft | 3 | wks | Wed Jun. 1, 2011 |
| 16 | 1.2.6 Ad Board Questions-Revise Draft | 2 | wks | Wed Jun. 22, 2011 |
| 17 | 1.2.7 Ad Board Deck-Regulatory and Legal Review of Revise [symbol] | 2 | wks | Wed Jul. 6, 2011 |
| 18 | 1.2.8 Ad Board Materials-Finalize | 2 | days | Wed Jul. 20, 2011 |
| 19 | 1.3 Ad Board Meeting Planning (Managed Markets) | 56.33 | days | Thu Jun. 2, 2011 |
| 20 | 1.3.1 Ad Board Meeting Planning (Managed Markets) | 0 | days | Thu Jul. 21, 2011 |
| 21 | 1.3.2 Ad Board Meeting Planning (Managed Markets) | 0 | days | Thu Jul. 21, 2011 |
| 22 | 1.3.3 Create and source RFP for the meeting | 20.33 | days | Fri Jul. 22, 2011 |
| 23 | 1.3.3.1 RFP is drafted | 2 | days | Fri Jul. 22, 2011 |
| 24 | 1.3.3.2 Distribute RFP to vendors | 2 | days | Tue Jul. 26, 2011 |
| 25 | 1.3.3.3 Compile list of responses to the RFP and distribute [symbol] | 3 | days | Thu Jul. 28, 2011 |
| 26 | 1.3.3.4 Present to Medical Director and Marketing (based | 2 | days | Tue Aug. 2, 2011 |
| 27 | 1.3.3.5 Negotiations are conducted with the venue to co [symbol] | 5 | days | Thu Aug. 4, 2011 |
| 28 | 1.3.3.6 Contract is then routed to procurement and legal [symbol] | 5 | days | Thu Aug. 11, 2011 |
| 29 | 1.3.3.7 Circulated for final signature and approval | 0.67 | days | Thu Aug. 18, 2011 |
| 30 | 1.3.3.8 Agreement is routed to venue for signature and ac [symbol] | 0.67 | days | Thu Aug. 18, 2011 |
| 31 | 1.3.4 Invitations/Letters | 38 | days | Thu Jun. 2, 2011 |
| 32 | 1.3.4.1 Invitations/Letters-Prepare Drafts | 3 | days | Thu Jun. 2, 2011 |
| 33 | 1.3.4.2 Invitations/Letters-Legal Review of Drafts | 3 | days | Tue Jun. 7, 2011 |
| 34 | 1.3.4.3 Invitations/Letters-Finalize | 2 | days | Fri Jun. 10, 2011 |
| 35 | 1.3.4.4 Consultancy Agreements for Attendees | 2 | days | Tue Jun. 14, 2011 |
| 36 | 1.3.4.5 Send Out Invitation to Group 1 | 3 | days | Thu Jun. 16, 2011 |
| 37 | 1.3.4.6 Invitation turnaround | 2 | ewks | Mon Jun. 20, 2011 |
| 38 | 1.3.4.7 Evaluate Group 1 Responses to Invitation | 0.5 | days | Tue Jul. 5, 2011 |
| 39 | 1.3.4.8 Send Out Invitation to Wave 2 (if applicable) | 2 | ewks | Tue Jul. 5, 2011 |
| 40 | 1.3.4.9 Evaluate Group 2 Responses to Invitation | 0.5 | days | Tue Jul. 19, 2011 |
| 41 | 1.3.4.10 Follow-Up to Medical director and Marketing wit [symbol] | 1 | day | Wed Jul. 20, 2011 |
| 42 | 1.3.4.11 Confirmation Letters to Attendees Group 1 and 2 [symbol] | 1 | day | Thu Jul. 21, 2011 |
| 43 | 1.3.4.12 Ticket Mailing Letters to Attendees | 1 | day | Fri Jul. 22, 2011 |
| 44 | 1.3.4.13 Consultancy Agreement for External Moderator [symbol] | 1 | day | Mon Jul. 25, 2011 |
| 45 | 1.4 Conduct Advisory Board (Managed Markets) | 188 | days | Tue Jul. 26, 2011 |
| 46 | 1.4.1 Advisory Board 1 (Managed Markets) | 1 | day | Tue Jul. 26, 2011 |
| 47 | 1.4.2 Advisory Board 2 (Managed Markets) | 1 | day | Wed Aug. 17, 2011 |
| 48 | 1.4.3 Advisory Board 3 (Managed Markets) | 1 | day | Thu Sep. 15, 2011 |
| 49 | 1.4.4 Advisory Board and Consultant input | 4 | wks | Fri Sep. 16, 2011 |
| 50 | 1.4.5 Advisory Boards Report/Feedback Loop | 2 | wks | Fri Oct. 14, 2011 |
| 51 | 1.4.6 Update the KOL Infulence Map | 6 | mons | Fri Oct. 28, 2011 |
| 52 | 2 Pricing study | 265 | days | Wed Jun. 1, 2011 |
| 53 | 2.1 Pricing Model Development | 8.5 | mons | Wed Jun. 1, 2011 |
| 54 | 2.2 Review pharmacoeconomic data to support positioning an [symbol] | 2 | wks | Wed Jan. 25, 2012 |
| 55 | 2.3 Forecasting Study updated annually | 13 | wks | Wed Jun. 1, 2011 |
| 56 | 2.4 Pricing Study-Update | 3 | mons | Wed Aug. 31, 2011 |
| 57 | 2.5 Pricing Study (Qualitative) | 2 | mons | Wed Nov. 23, 2011 |
| 58 | 2.6 Pricing Study (Quantitive) | 2 | mons | Wed Jan. 18, 2012 |
| 59 | 2.7 Price-Volume discrete study choice | 2.75 | mons | Wed Nov. 2, 2011 |
| 60 | 2.8 Pricing Recommendation | 0 | wks | Tue Feb. 14, 2012 |
| 61 | 2.9 Determine clinical value | 1 | wk | Wed Feb. 15, 2012 |
| 62 | 2.10 Determine Customers' perceived value (Value Proposition [symbol] | 1 | wk | Wed Feb. 22, 2012 |
| 63 | 2.11 Additional Pricing Research (Final Price) | 70 | days | Wed Feb. 29, 2012 |
| 64 | 3 Cost Model Presentation | 250 | days | Wed Mar. 28, 2012 |
| 65 | 3.1 Select Health Economics Vendor for model construction | 4 | wks | Wed Mar. 28, 2012 |
| 66 | 3.2 Develop health economics model | 4 | mons | Wed Apr. 25, 2012 |
| 67 | 3.3 Select vendor for publication of the health economics mod [symbol] | 2 | wks | Wed Aug. 15, 2012 |
| 68 | 3.4 Develop Health Economics paper for model data | 6 | mons | Wed Aug. 29, 2012 |
| 69 | 3.5 AMCP Poster | 10 | days | Wed Feb. 13, 2013 |
| 70 | 3.6 Submit for LMR and Execuetive Approvals | 10 | days | Wed Feb. 27, 2013 |
| 71 | 3.7 AMCP Poster Presentation | 0 | days | Tue Mar. 12, 2013 |
| 72 | 4 AMCP Dossier | 322 | days | Wed Feb. 29, 2012 |
| 73 | 4.1 AMCP Formulary Dossier | 2.5 | mons | Fri Mar. 15, 2013 |
| 74 | 4.2 Clinical Input | 2 | mons | Fri Mar. 15, 2013 |
| 75 | 4.3 Economic Input | 1 | mon | Wed Feb. 29, 2012 |
| 76 | 5 Presentation Decks for Field Account Managers | 50 | days | Wed Mar. 28, 2012 |
| 77 | 5.1 Brand messaging | 10 | wks | Wed Mar. 28, 2012 |
| 78 | 5.2 Pharmecomonic Messaging | 10 | wks | Wed Mar. 28, 2012 |
| 79 | 5.3 Value Proposition | 7 | wks | Wed Mar. 28, 2012 |
| 80 | 5.4 Contracting Strategy | 9 | wks | Wed Mar. 28, 2012 |
| 81 | 6 Distribution Channel Sell Sheets | 83 | days | Fri Feb. 24, 2012 |
| 82 | 6.1 Product Fact Sheet | 2.5 | mons | Fri Feb. 24, 2012 |
| 83 | 6.2 Wholesaler Sell Sheet | 1 | mon | Fri May 4, 2012 |
| 84 | 6.3 MCO Sell Sheet | 1 | mon | Fri May 4, 2012 |
| 85 | 6.4 Pharmacy Sell Sheet | 1 | mon | Fri May 4, 2012 |
| 86 | 6.5 Wholesaler, MCO/Pharmacy Announcement Letter and She [symbol] | 1 | day | Fri Jun. 1, 2012 |
| 87 | 6.6 Develop Wholesaler Communication and Training | 2 | wks | Mon Jun. 4, 2012 |
| 88 | 6.7 Wholesaler Communication and Training | 2 | days | Mon Jun. 18, 2012 |

| ID | Finish | Predecessors | Resource Names |
|---|---|---|---|
| 1 | Thu Apr. 12, 2012 | | |
| 2 | Fri Jun. 10, 2011 | | |
| 3 | Wed Jun. 1, 2011 | | Medical Director, Brand [symbol] |
| 4 | Fri Jun. 3, 2011 | 3 | Brand Management, Med [symbol] |
| 5 | Fri Jun. 3, 2011 | 4 | Brand Management, Med [symbol] |
| 6 | Fri Jun. 3, 2011 | 5 | Brand Management, Med [symbol] |
| 7 | Wed Jun. 8, 2011 | 6FS + 2 days | Brand Management, Med [symbol] |
| 8 | Thu Jun. 9, 2011 | 7 | |
| 9 | Fri Jun. 10, 2011 | 8 | |
| 10 | Thu Jul. 21, 2011 | | |
| 11 | Thu Jun. 16, 2011 | 3SS | Medical Director, Brand [symbol] |
| 12 | Wed Jun. 1, 2011 | 3SS | Medical Director, Brand [symbol] |
| 13 | Mon Jun. 6, 2011 | 12 | Medical Director, Brand [symbol] |
| 14 | Tue Jun. 14, 2011 | 3SS | Medical Director, Brand [symbol] |
| 15 | Tue Jun. 21, 2011 | 3SS | Medical Director, Brand [symbol] |
| 16 | Tue Jul. 5, 2011 | 15 | Medical Director, Brand [symbol] |
| 17 | Tue Jul. 19, 2011 | 16 | Medical Director, Brand [symbol] |
| 18 | Thu Jul. 21, 2011 | 17 | Medical Director, Brand [symbol] |
| 19 | Fri Aug. 19, 2011 | | |
| 20 | Thu Jul. 21, 2011 | 18 | |
| 21 | Thu Jul. 21, 2011 | 20 | |
| 22 | Fri Aug. 19, 2011 | | |
| 23 | Mon Jul. 25, 2011 | 21 | Meeting Planning |
| 24 | Wed Jul. 27, 2011 | 23 | Meeting Planning |
| 25 | Mon Aug. 1, 2011 | 24 | Meeting Planning |
| 26 | Wed Aug. 3, 2011 | 25 | Meeting Planning |
| 27 | Wed Aug. 10, 2011 | 26 | Meeting Planning |
| 28 | Wed Aug. 17, 2011 | 27 | Legal, Meeting Planning |
| 29 | Thu Aug. 18, 2011 | 28 | Legal, Procurement, Meet [symbol] |
| 30 | Fri Aug. 19, 2011 | 29 | Legal, Meeting Planning, P [symbol] |
| 31 | Mon Jul. 25, 2011 | | |
| 32 | Mon Jun. 6, 2011 | 3 | Meeting Planning |
| 33 | Thu Jun. 9, 2011 | 32 | Meeting Planning |
| 34 | Mon Jun. 13, 2011 | 33 | Meeting Planning |
| 35 | Wed Jun. 15, 2011 | 34 | Meeting Planning |
| 36 | Mon Jun. 20, 2011 | 35 | Meeting Planning |
| 37 | Mon Jul. 4, 2011 | 36 | |
| 38 | Tue Jul. 5, 2011 | 37 | Brand Management, Med [symbol] |
| 39 | Tue Jul. 19, 2011 | 38 | Meeting Planning |
| 40 | Tue Jul. 19, 2011 | 39 | Brand Management, Med [symbol] |
| 41 | Wed Jul. 20, 2011 | 40 | Meeting Planning |
| 42 | Thu Jul. 21, 2011 | 41 | Meeting Planning |
| 43 | Fri Jul. 22, 2011 | 42 | Meeting Planning |
| 44 | Mon Jul. 25, 2011 | 43 | Meeting Planning |
| 45 | Thu Apr. 12, 2012 | 18 | |
| 46 | Tue Jul. 26, 2011 | 44 | Medical Director, Brand [symbol] |
| 47 | Wed Aug. 17, 2011 | 46FS + 3 wks | Medical Director, Brand [symbol] |
| 48 | Thu Sep. 15, 2011 | 47FS + 4 wks | Medical Director, Brand [symbol] |
| 49 | Thu Oct. 13, 2011 | 48 | Brand Management, Med [symbol] |
| 50 | Thu Oct. 27, 2011 | 49 | Medical Director, Brand [symbol] |
| 51 | Thu Apr. 12, 2012 | 50 | Brand Management, Med [symbol] |
| 52 | Tue Jun. 5, 2012 | | |
| 53 | Tue Jan. 24, 2012 | 3SS | Brand Management |
| 54 | Tue Feb. 7, 2012 | 53 | Finance |
| 55 | Tue Aug. 30, 2011 | 3SS | Market Research |
| 56 | Tue Nov. 22, 2011 | 55 | Market Research |
| 57 | Tue Jan. 17, 2012 | 56 | Market Research |
| 58 | Tue Mar. 13, 2012 | 57 | Brand Management, Med [symbol] |
| 59 | Tue Jan. 17, 2012 | 53FS − 3 mons | Brand Management, Med [symbol] |
| 60 | Tue Feb. 14, 2012 | 59FS + 1 mon | Finance |
| 61 | Tue Feb. 21, 2012 | 60 | Finance |
| 62 | Tue Feb. 28, 2012 | 61 | Finance |
| 63 | Tue Jun. 5, 2012 | 62 | Finance |
| 64 | Tue Mar. 12, 2013 | | |
| 65 | Tue Apr. 24, 2012 | 75 | Market Access |
| 66 | Tue Aug. 14, 2012 | 65 | Market Access |
| 67 | Tue Aug. 28, 2012 | 66 | Market Access |
| 68 | Tue Feb. 12, 2013 | 67 | Market Access |
| 69 | Tue Feb. 26, 2013 | 68 | Market Access |
| 70 | Tue Mar. 12, 2013 | 69 | |
| 71 | Tue Mar. 12, 2013 | 70 | Market Access |
| 72 | Thu May 23, 2013 | | |
| 73 | Thu May 23, 2013 | 71FS + 2 days | Market Access |
| 74 | Thu May 9, 2013 | 73SS | Medical Director |
| 75 | Tue Mar. 27, 2012 | 62 | Market Access |
| 76 | Tue Jun. 5, 2012 | | |
| 77 | Tue Jun. 5, 2012 | 75 | |
| 78 | Tue Jun. 5, 2012 | 75 | |
| 79 | Tue May 15, 2012 | 75 | |
| 80 | Tue May 29, 2012 | 75 | |
| 81 | Tue Jun. 19, 2012 | | |
| 82 | Thu May 3, 2012 | 62FS − 3 days | Distribution |
| 83 | Thu May 31, 2012 | 82 | Distribution |
| 84 | Thu May 31, 2012 | 82 | |
| 85 | Thu May 31, 2012 | 82 | |
| 86 | Fri Jun. 1, 2012 | 83 | Distribution |
| 87 | Fri Jun. 15, 2012 | 86 | Distribution |
| 88 | Tue Jun. 19, 2012 | 87 | Distribution |

[symbol]

indicates data missing or illegible when filed

TABLE 4
MEDICAL AFFAIRS PERSPECTIVE

| ID | Task Name | Duration | | Start | Finish | Predecessors | Resource Names |
|---|---|---|---|---|---|---|---|
| 1 | Submission of NDA | 0 | d | Wed Jun. 1, 2011 | Wed Jun. 1, 2011 | | |
| 2 | PDUFA Date | 0 | d | Wed Apr. 4, 2012 | Wed Apr. 4, 2012 | 1FS + 11 mons | |
| 3 | Drug Information Plan | 195 | d | Wed Mar. 9, 2011 | Tue Dec. 6, 2011 | | |
| 4 | Develop bibliography for pre-approval requests f [symbol] | 15 | d | Wed Mar. 9, 2011 | Tue Mar. 29, 2011 | | Drug Information |
| 5 | Perform literature search using key words | 2 | d | Wed Mar. 9, 2011 | Tue Mar. 10, 2011 | 1FS − 60 d | Drug Information |
| 6 | Select most appropriate citations and create bit | 5 | d | Fri Mar. 11, 2011 | Tue Mar. 17, 2011 | 5 | Drug Information |
| 7 | Review by Medical Advisor | 2 | d | Fri Mar. 18, 2011 | Mon Mar. 21, 2011 | 6 | Drug Information |
| 8 | Finalize Bibliography | 6 | d | Tue Mar. 22, 2011 | Tue Mar. 29, 2011 | 7 | Drug Information |
| 9 | Update as necessary | 1 | w | Wed Mar. 30, 2011 | Tue Apr. 5, 2011 | 5SS, 8 | Drug Information[300%] |
| 10 | Identify major topics, concerns, and/or frequent [symbol] | 40 | d | Wed Mar. 30, 2011 | Tue May 24, 2011 | | Drug Information |
| 11 | Examine available literature for possible topics | 40 | d | Wed Mar. 30, 2011 | Tue May 24, 2011 | | Drug Information |
| 12 | Using bibliography, obtain full copies of most | 10 | d | Wed Mar. 30, 2011 | Tue Apr. 12, 2011 | 8 | Drug Information |
| 13 | Evaluate the literature. | 4 | w | Wed Apr. 13, 2011 | Tue May 10, 2011 | 12 | Drug Information |
| 14 | Identify possible topics | 2 | w | Wed May 11, 2011 | Tue May 24, 2011 | 13 | Drug Information |
| 15 | Discuss with Medical Advisors the possible additi [symbol] | 30 | d | Wed May 25, 2011 | Tue Jul. 5, 2011 | | Drug Information |
| 16 | Meet and discuss with Medical Director | 10 | d | Wed May 25, 2011 | Tue Jun. 7, 2011 | 14 | Drug Information |
| 17 | Meet and discuss with clinical data expert | 10 | d | Wed Jun. 8, 2011 | Tue Jun. 21, 2011 | 16 | Drug Information |
| 18 | Identify possible topics | 10 | d | Wed Jun. 22, 2011 | Tue Jul. 5, 2011 | 17 | Drug Information |
| 19 | Finalize the list of topics on which Standard Lette [symbol] | 15 | d | Wed Jul. 6, 2011 | Tue Jul. 26, 2011 | | Drug Information |
| 20 | Draft list of Standard Letters | 5 | d | Wed Jul. 6, 2011 | Tue Jul. 12, 2011 | 18 | Drug Information |
| 21 | Review by Medical Advisor | 5 | d | Wed Jul. 13, 2011 | Tue Jul. 19, 2011 | 20 | Drug Information |
| 22 | Finalize list of Standard Letters | 5 | d | Wed Jul. 20, 2011 | Tue Jul. 26, 2011 | 21 | Drug Information |
| 23 | Draft Standard Letters | 35 | d | Wed Jul. 27, 2011 | Tue Sep. 13, 2011 | | Drug Information |
| 24 | Gather data from applicable clinical trials and/o [symbol] | 20 | d | Wed Jul. 27, 2011 | Tue Aug. 23, 2011 | 22 | Drug Information |
| 25 | Search and gather published literature on topic | 20 | d | Wed Jul. 27, 2011 | Tue Aug. 23, 2011 | 24SS | Drug Information |
| 26 | Get input from Medical Advisors | 10 | d | Wed Aug. 17, 2011 | Tue Aug. 30, 2011 | 25FS − 5 d | Drug Information |
| 27 | Prepare initial draft | 10 | d | Wed Aug. 31, 2011 | Tue Sep. 13, 2011 | 26 | Drug Information |
| 28 | Finalize Standard Letters | 60 | d | Wed Sep. 14, 2011 | Tue Dec. 6, 2011 | | Drug Information |
| 29 | Circulate each draft document for review | 10 | d | Wed Sep. 14, 2011 | Tue Sep. 27, 2011 | | Drug Information |
| 30 | Regulatory- or designee | 10 | d | Wed Sep. 14, 2011 | Tue Sep. 27, 2011 | 27 | Drug Information |
| 31 | Medical | 10 | d | Wed Sep. 14, 2011 | Tue Sep. 27, 2011 | 30SS | Drug Information |
| 32 | Legal | 10 | d | Wed Sep. 14, 2011 | Tue Sep. 27, 2011 | 31SS | Drug Information |
| 33 | Discuss and/or incorporate comments | 10 | d | Wed Sep. 28, 2011 | Tue Oct. 11, 2011 | 32 | Drug Information |
| 34 | Repeat process as necessary depending on quar [symbol] | 20 | d | Wed Oct. 12, 2011 | Tue Nov. 8, 2011 | 33 | Drug Information |
| 35 | Schedule meeting to discuss comments if neces [symbol] | 5 | d | Wed Nov. 9, 2011 | Tue Nov. 15, 2011 | 34 | Drug Information |
| 36 | Incorporate final comments | 5 | d | Wed Nov. 16, 2011 | Tue Nov. 22, 2011 | 35 | Drug Information |
| 37 | Obtain final sign-off | 10 | d | Wed Nov. 23, 2011 | Tue Dec. 6, 2011 | 36 | Drug Information |
| 38 | Publications | 869.26 | d | Wed Feb. 17, 2010 | Tue Jun. 18, 2013 | | |
| 39 | Publication Planning (US) | 780 | d | Wed Feb. 17, 2010 | Tue Feb. 12, 2013 | | |
| 40 | Develop annotated publication roster | 39 | mons | Wed Feb. 17, 2010 | Tue Feb. 12, 2013 | 42FS-13 mons | Health Economics, Medical Director |
| 41 | Develop US publication objectives (Pre-Through | 13 | w | Wed Nov. 17, 2010 | Tue Feb. 15, 2011 | 1FS-7 mons | Health Economics, Medical Director |
| 42 | Identify authors and topics to be covered | 13 | w | Wed Nov. 17, 2010 | Tue Feb. 15, 2011 | 1FS-7 mons | Health Economics, Medical Director |
| 43 | Primary Manuscripts Publication Schedule | 556 | d | Tue Feb. 15, 2011 | Wed Apr. 3, 2013 | | |
| 44 | Phase 1 | 0 | mons | Tue Feb. 15, 2011 | Tue Feb. 15, 2011 | 42 | Clinical Development |
| 45 | Phase 2 | 0 | mons | Tue Feb. 15, 2011 | Tue Feb. 15, 2011 | 42 | Clinical Development |
| 46 | Phase 3A Studies | 0 | mons | Tue Mar. 1, 2011 | Tue Mar. 1, 2011 | 42FS + 2 w | Clinical Development |
| 47 | Phase 3B and Phase 4 studies | 0 | mons | Wed Jul. 25, 2012 | Wed Jul. 25, 2012 | 2FS + 4 mons | Clinical Development |
| 48 | Secondary Manuscripts | 13 | mons | Thu Apr. 5, 2012 | Wed Apr. 3, 2013 | 2SS | Clinical Development |
| 49 | Publication 1: Phase 1 | 233.26 | d | Wed Feb. 16, 2011 | Mon Jan. 9, 2012 | | |
| 50 | Invite Authors | 1 | w | Wed Feb. 16, 2011 | Tue Feb. 22, 2011 | 44SS | Health Economics, Medical Director |
| 51 | Determine if writing assistance necessary and if | 1 | w | Wed Feb. 23, 2011 | Tue Mar. 1, 2011 | 50 | Health Economics, Medical Director |
| 52 | A conference call is held to discuss the manuscri [symbol] | 1 | d | Wed Mar. 9, 2011 | Wed Mar. 9, 2011 | 51FS + 5 d | Health Economics, Medical Director |
| 53 | Prepare an outline/backgrounder | 2 | d | Thu Mar. 10, 2011 | Fri Mar. 11, 2011 | 52 | Health Economics, Medical Director |
| 54 | Author prepares and submits draft manuscript | 4.25 | w | Mon Mar. 14, 2011 | Tue Apr. 12, 2011 | 53 | Health Economics, Medical Director |
| 55 | Manuscript is reviewed by the team | 2 | w | Tue Apr. 12, 2011 | Tue Apr. 26, 2011 | 54 | Health Economics, Medical Director |
| 56 | Reviewed manuscript is returned to authors | 0 | w | Tue Apr. 26, 2011 | Tue Apr. 26, 2011 | 55FS + 3 mins | Health Economics, Medical Director |
| 57 | Author prepare final draft | 3 | w | Tue Apr. 26, 2011 | Tue May 17, 2011 | 56 | Health Economics, Medical Director |
| 58 | Obtain internal and external authorization shee [symbol] | 2 | d | Tue May 17, 2011 | Thu May 19, 2011 | 57 | Health Economics, Medical Director |
| 59 | Submit article to journal | 2 | d | Thu May 19, 2011 | Mon May 23, 2011 | 58 | Health Economics, Medical Director |
| 60 | Journal notifies of decision on publication of ma [symbol] | 2 | mons | Mon May 23, 2011 | Mon Jul. 18, 2011 | 59 | Health Economics, Medical Director |
| 61 | Manuscript revisions requested by the publicati [symbol] | 3 | w | Mon Jul. 18, 2011 | Mon Aug. 8, 2011 | 60 | Health Economics, Medical Director |
| 62 | Manuscript is scheduled for publication | 1.5 | mons | Mon Aug. 8, 2011 | Mon Sep. 19, 2011 | 61 | Health Economics, Medical Director |
| 63 | Phase 1 Study is published | 0 | d | Mon Jan. 9, 2012 | Mon Jan. 9, 2012 | 62FS + 4 mons | |
| 64 | Publication 2: Phase 2 | 233.26 | d | Wed Feb. 16, 2011 | Mon Jan. 9, 2012 | | |
| 65 | Invite authors | 1 | w | Wed Feb. 16, 2011 | Tue Feb. 22, 2011 | 45SS | Health Economics, Medical Director |
| 66 | Determine if writing assistance necessary and if | 1 | w | Wed Feb. 23, 2011 | Tue Mar. 1, 2011 | 65 | Health Economics, Medical Director |
| 67 | A conference call is held to discuss the manuscri [symbol] | 1 | d | Wed Mar. 9, 2011 | Wed Mar. 9, 2011 | 66FS + 5 d | Health Economics, Medical Director |
| 68 | Prepare an outline/backgrounder | 2 | d | Thu Mar. 10, 2011 | Fri Mar. 11, 2011 | 67 | Health Economics, Medical Director |
| 69 | Author prepares and submits draft manuscript | 4.25 | w | Mon Mar. 14, 2011 | Tue Apr. 12, 2011 | 68 | Health Economics, Medical Director |
| 70 | Manuscript is reviewed by the team | 2 | w | Tue Apr. 12, 2011 | Tue Apr. 26, 2011 | 69 | Health Economics, Medical Director |
| 71 | Reviewed manuscript is returned to authors | 0 | w | Tue Apr. 26, 2011 | Tue Apr. 26, 2011 | 70FS + 3 mins | Health Economics, Medical Director |
| 72 | Author prepare final draft | 3 | w | Tue Apr. 26, 2011 | Tue May 17, 2011 | 71 | Health Economics, Medical Director |
| 73 | Obtain internal and external authorization shee [symbol] | 2 | d | Tue May 17, 2011 | Thu May 19, 2011 | 72 | Health Economics, Medical Director |
| 74 | Submit article to journal | 2 | d | Thu May 19, 2011 | Mon May 23, 2011 | 73 | Health Economics, Medical Director |
| 75 | Journal notifies of decision on publication of ma [symbol] | 2 | mons | Mon May 23, 2011 | Mon Jul. 18, 2011 | 74 | Health Economics, Medical Director |
| 76 | Manuscript revisions requested by the publicati [symbol] | 3 | w | Mon Jul. 18, 2011 | Mon Aug. 8, 2011 | 75 | Health Economics, Medical Director |
| 77 | Manuscript is scheduled for publication | 1.5 | mons | Mon Aug. 8, 2011 | Mon Sep. 19, 2011 | 76 | Health Economics, Medical Director |
| 78 | Phase 2 Study is published | 0 | d | Mon Jan. 9, 2012 | Mon Jan. 9, 2012 | 77FS + 4 mons | |
| 79 | Publication 3: Phase 3A | 228.26 | d | Wed Mar. 2, 2011 | Mon Jan. 16, 2012 | | |
| 80 | Invite authors | 1 | w | Wed Mar. 2, 2011 | Tue Mar. 8, 2011 | 46 | Health Economics, Medical Director |
| 81 | Determine if writing assistance necessary and if | 1 | w | Wed Mar. 2, 2011 | Tue Mar. 8, 2011 | 80SS | Health Economics, Medical Director |
| 82 | A conference call is held to discuss the manuscri [symbol] | 1 | d | Wed Mar. 16, 2011 | Wed Mar. 16, 2011 | 81FS + 5 d | Health Economics, Medical Director |
| 83 | Prepare an outline/backgrounder | 2 | d | Thu Mar. 17, 2011 | Fri Mar. 18, 2011 | 82 | Health Economics, Medical Director |
| 84 | Author prepares and submits draft manuscript | 4.25 | w | Mon Mar. 21, 2011 | Tue Apr. 19, 2011 | 83 | Health Economics, Medical Director |
| 85 | Manuscript is reviewed by the team | 2 | w | Tue Apr. 19, 2011 | Tue May 3, 2011 | 84 | Health Economics, Medical Director |
| 86 | Reviewed manuscript is returned to authors | 0 | w | Tue May 3, 2011 | Tue May 3, 2011 | 85FS + 3 mins | Health Economics, Medical Director |
| 87 | Author prepare final draft | 3 | w | Tue May 3, 2011 | Tue May 24, 2011 | 86 | Health Economics, Medical Director |
| 88 | Obtain internal and external authorization shee [symbol] | 2 | d | Tue May 24, 2011 | Thu May 26, 2011 | 87 | Health Economics, Medical Director |
| 89 | Submit article to journal | 2 | d | Thu May 26, 2011 | Mon May 30, 2011 | 88 | Health Economics, Medical Director |
| 90 | Journal notifies of decision on publication of ma [symbol] | 2 | mons | Mon May 30, 2011 | Mon Jul. 25, 2011 | 89 | Health Economics, Medical Director |
| 91 | Manuscript revisions requested by the publicati [symbol] | 3 | w | Mon Jul. 25, 2011 | Mon Aug. 15, 2011 | 90 | Health Economics, Medical Director |
| 92 | Manuscript is scheduled for publication | 1.5 | mons | Mon Aug. 15, 2011 | Mon Sep. 26, 2011 | 91 | Health Economics, Medical Director |
| 93 | Phase 3 Study is published | 0 | d | Mon Jan. 16, 2012 | Mon Jan. 16, 2012 | 92FS + 4 mons | |
| 94 | Publication 4: Phase 3B and/or Phase 4 (Seconda [symbol] | 233.26 | d | Thu Jul. 26, 2012 | Tue Jun. 18, 2013 | | |
| 95 | Invite authors | 1 | w | Thu Jul. 26, 2012 | Wed Aug. 1, 2012 | 47 | Health Economics, Medical Director |
| 96 | Determine if writing assistance necessary and if | 1 | w | Thu Aug. 2, 2012 | Wed Aug. 8, 2012 | 95 | Health Economics, Medical Director |
| 97 | A conference call is held to discuss the manuscri [symbol] | 1 | d | Thu Aug. 16, 2012 | Thu Aug. 16, 2012 | 96FS + 5 d | Health Economics, Medical Director |
| 98 | Prepare an outline/backgrounder | 2 | d | Fri Aug. 17, 2012 | Mon Aug. 20, 2012 | 97 | Health Economics, Medical Director |
| 99 | Author prepares and submits draft manuscript | 4.25 | w | Tue Aug. 21, 2012 | Wed Sep. 19, 2012 | 98 | Health Economics, Medical Director |
| 100 | Manuscript is reviewed by the team | 2 | w | Wed Sep. 19, 2012 | Wed Oct. 3, 2012 | 99 | Health Economics, Medical Director |
| 101 | Reviewed manuscript is returned to authors | 0 | w | Wed Oct. 3, 2012 | Wed Oct. 3, 2012 | 100FS + 3 mins | Health Economics, Medical Director |
| 102 | Author prepare final draft | 3 | w | Wed Oct. 3, 2012 | Wed Oct. 24, 2012 | 101 | Health Economics, Medical Director |
| 103 | Obtain internal and external authorization shee [symbol] | 2 | d | Wed Oct. 24, 2012 | Fri Oct. 26, 2012 | 102 | Health Economics, Medical Director |
| 104 | Submit article to journal | 2 | d | Fri Oct. 26, 2012 | Tue Oct. 30, 2012 | 103 | Health Economics, Medical Director |
| 105 | Journal notifies of decision on publication of ma [symbol] | 2 | mons | Tue Oct. 30, 2012 | Tue Dec. 25, 2012 | 104 | Health Economics, Medical Director |
| 106 | Manuscript revisions requested by the publicati [symbol] | 3 | w | Tue Dec. 25, 2012 | Tue Jan. 15, 2013 | 105 | Health Economics, Medical Director |
| 107 | Manuscript is scheduled for publication | 1.5 | mons | Tue Jan. 15, 2013 | Tue Feb. 26, 2013 | 106 | Health Economics, Medical Director |
| 108 | Phase 3B Study is published | 0 | d | Tue Jun. 18, 2013 | Tue Jun. 18, 2013 | 107FS + 4 mons | |
| 109 | Publication-Health Economics (Global/US) | 167.01 | d | Thu Jul. 26, 2012 | Mon Mar. 18, 2013 | | |
| 110 | Invite authors | 1 | w | Thu Jul. 26, 2012 | Wed Aug. 1, 2012 | 2FS + 4 mons | Health Economics, Medical Director |
| 111 | Determine if writing assistance necessary and if | 1 | w | Thu Aug. 2, 2012 | Wed Aug. 8, 2012 | 110 | Health Economics, Medical Director |
| 112 | A conference call is held to discuss the manuscri [symbol] | 1 | d | Thu Aug. 16, 2012 | Thu Aug. 16, 2012 | 111FS + 5 d | Health Economics, Medical Director |
| 113 | Prepare an outline/backgrounder | 2 | d | Fri Aug. 17, 2012 | Mon Aug. 20, 2012 | 112 | Health Economics, Medical Director |
| 114 | Author prepares and submits draft manuscript | 5 | w | Tue Aug. 21, 2012 | Mon Sep. 24, 2012 | 113 | Health Economics, Medical Director |
| 115 | Manuscript is reviewed by the team | 2 | w | Tue Sep. 25, 2012 | Mon Oct. 8, 2012 | 114 | Health Economics, Medical Director |
| 116 | Reviewed manuscript is returned to authors | 0 | w | Tue Oct. 9, 2012 | Tue Oct. 9, 2012 | 115FS + 3 mins | Health Economics, Medical Director |
| 117 | Author prepare final draft | 3 | w | Tue Oct. 9, 2012 | Tue Oct. 30, 2012 | 116 | Health Economics, Medical Director |
| 118 | Obtain internal and external authorization shee [symbol] | 2 | d | Tue Oct. 30, 2012 | Thu Nov. 1, 2012 | 117 | Health Economics, Medical Director |
| 119 | Submit article to journal | 2 | d | Thu Nov. 1, 2012 | Mon Nov. 5, 2012 | 118 | Health Economics, Medical Director |
| 120 | Journal notifies of decision on publication of ma [symbol] | 2 | mons | Mon Nov. 5, 2012 | Mon Dec. 31, 2012 | 119 | Health Economics, Medical Director |
| 121 | Manuscript revisions requested by the publicati [symbol] | 3 | w | Mon Dec. 31, 2012 | Mon Jan. 21, 2013 | 120 | Health Economics, Medical Director |
| 122 | Manuscript is scheduled for publication | 2 | mons | Mon Jan. 21, 2013 | Mon Mar. 18, 2013 | 121 | Health Economics, Medical Director |
| 123 | Health Economics Study is published | 0 | d | Mon Mar. 18, 2013 | Mon Mar. 18, 2013 | 122 | |
| 124 | Development of message presentations for NDA su [symbol] | 2 | d | Mon Jun. 6, 2011 | Tue Jun. 7, 2011 | | |
| 125 | Full message | 0.5 | d | Mon Jun. 6, 2011 | Mon Jun. 6, 2011 | 1FS + 3 d | Brand Management, Medical Director |
| 126 | 30 second message detail | 0.5 | d | Mon Jun. 6, 2011 | Mon Jun. 6, 2011 | 125 | Brand Management, Medical Director |
| 127 | 60 second message detail | 0.5 | d | Tue Jun. 7, 2011 | Tue Jun. 7, 2011 | 126 | Brand Management, Medical Director |
| 128 | Development of objection handling guide | 0.5 | d | Tue Jun. 7, 2011 | Tue Jun. 7, 2011 | 127 | Brand Management, Medical Director |
| 129 | Recruit and Certify MSL's | 193 | d | Wed Mar. 9, 2011 | Fri Dec. 2, 2011 | | |
| 130 | Search for MSL candidates | 75 | d | Wed Mar. 9, 2011 | Tue Jun. 21, 2011 | 1SS-3 mons | Medical Director |
| 131 | Interview/Selection of MSL candidates | 40 | d | Wed Jun. 22, 2011 | Tue Aug. 16, 2011 | 130 | Medical Director |
| 132 | Hire MSL | 8 | w | Wed Aug. 17, 2011 | Tue Oct. 11, 2011 | 131 | Medical Director |
| 133 | Confidentiality Agreements for MSL's | 8 | w | Wed Aug. 17, 2011 | Tue Oct. 11, 2011 | 132SS | Medical Director |
| 134 | Home Study for newly hired MSL's | 30 | d | Wed Oct. 12, 2011 | Tue Nov. 22, 2011 | 133 | Medical Director |
| 135 | Level I training for newly hired MSL's | 8 | d | Wed Nov. 23, 2011 | Fri Dec. 2, 2011 | 134 | Medical Director |
| 136 | Complete train, test and certify MSL | 0 | d | Fri Dec. 2, 2011 | Fri Dec. 2, 2011 | 135 | Medical Director |
| 137 | Key Opinion Leader Selection | 479 | d | Wed Mar. 2, 2011 | Mon Dec. 31, 2012 | | |
| 138 | Thought leader development | 479 | d | Wed Mar. 2, 2011 | Mon Dec. 31, 2012 | | |
| 139 | Identify KOL candidates | 9 | w | Wed Mar. 2, 2011 | Tue May 3, 2011 | 46 | Brand Management, Medical Director |
| 140 | Validate KOL | 5 | mons | Wed Mar. 23, 2011 | Tue Aug. 9, 2011 | 139SS + 3 w | Brand Management, Medical Director |
| 141 | Complete KOL database | 3 | mons | Wed Aug. 10, 2011 | Tue Nov. 1, 2011 | 140 | Brand Management, Medical Director |
| 142 | Identify KOL Influencers | 5 | mons | Tue Mar. 27, 2012 | Mon Aug. 13, 2012 | 141FS + 5.2 mons | |
| 143 | On-going Maintenance of KOL database | 10 | mons | Tue Mar. 27, 2012 | Mon Dec. 31, 2012 | 142SS | Brand Management, Medical Director |
| 144 | KOL strategy and Tactical Plan | 18.5 | d | Mon Mar. 19, 2012 | Thu Apr. 12, 2012 | | |
| 145 | Develop medical strategy | 10 | d | Mon Mar. 19, 2012 | Fri Mar. 30, 2012 | 1FS + 10 mons | Brand Management, Medical Director |
| 146 | Develop MSL strategy for KOL's | 5 | d | Mon Apr. 2, 2012 | Fri Apr. 6, 2012 | 14S | Brand Management, Medical Director |
| 147 | Develop Tactical Plan for KOL's | 3.5 | d | Mon Apr. 9, 2012 | Thu Apr. 12, 2012 | 146 | Brand Management, Medical Director |
| 148 | National Speaker Training | 106.83 | d | Wed Feb. 8, 2012 | Thu Jul. 5, 2012 | | |
| 149 | Internal Speaker Planning Meeting (MM, Medical | 32 | d | Wed Feb. 8, 2012 | Thu Mar. 22, 2012 | | |
| 150 | Objectives and Agenda | 12 | d | Wed Feb. 8, 2012 | Thu Feb. 23, 2012 | 1FS + 9 mons | Medical Director, Brand Management, Ad Agency |
| 151 | Complete/Submit Meeting Request Form to Me [symbol] | 4 | d | Fri Feb. 24, 2012 | Wed Feb. 29, 2012 | 150 | Medical Director, Brand Management, Ad Agency |
| 152 | Meeting specifics and budget reviewed and app [symbol] | 4 | d | Mon Mar. 5, 2012 | Thu Mar. 8, 2012 | 151FS + 2 d | Medical Director, Brand Management, Ad Agency |
| 153 | Commitment to conducting the meeting | 2 | w | Fri Mar. 9, 2012 | Thu Mar. 22, 2012 | 152 | Medical Director, Brand Management, Ad Agency |
| 154 | Create and source RFP for the meeting | 74.83 | d | Fri Mar. 23, 2012 | Thu Jul. 5, 2012 | 153 | |
| 155 | RFP is drafted | 2 | d | Fri Mar. 23, 2012 | Mon Mar. 26, 2012 | 153 | Meeting Planning |
| 156 | Distribute RFP to vendors | 2 | d | Tue Mar. 27, 2012 | Wed Mar. 28, 2012 | 155 | Meeting Planning |
| 157 | Compile list of responses to the RFP and distrib [symbol] | 3 | d | Thu Mar. 29, 2012 | Mon Apr. 2, 2012 | 156 | Meeting Planning |
| 158 | Present to Medical Director and Marketing (bas [symbol] | 2 | d | Tue Apr. 3, 2012 | Wed Apr. 4, 2012 | 157 | Meeting Planning |
| 159 | Negotiations are conducted with the venue to c [symbol] | 5 | d | Thu Apr. 5, 2012 | Wed Apr. 11, 2012 | 158 | Meeting Planning |
| 160 | Contract is then routed to procurement and leg [symbol] | 5 | d | Thu Apr. 12, 2012 | Wed Apr. 18, 2012 | 159 | Legal, Meeting Planning |
| 161 | Circulated for final signature and approval | 0.67 | d | Thu Apr. 19, 2012 | Thu Apr. 19, 2012 | 160 | Legal, Procurement, Meeting Planning |
| 162 | Agreement is routed to venue for signature and | 0.67 | d | Thu Apr. 19, 2012 | Fri Apr. 20, 2012 | 161 | Legal, Meeting Planning, Procurement |
| 163 | Invitations/Letters | 54.5 | d | Fri Apr. 20, 2012 | Thu Jul. 5, 2012 | 162 | |
| 164 | Invitations/Letters-Prepare Drafts | 2.5 | d | Fri Apr. 20, 2012 | Tue Apr. 24, 2012 | 157 | Meeting Planning, Ad Agency |
| 165 | Invitations/Letters-Legal Review of Drafts | 2 | d | Tue Apr. 24, 2012 | Thu Apr. 26, 2012 | 164 | Meeting Planning, Ad Agency |
| 166 | Invitations/Letters-Finalize | 0 | d | Thu Apr. 26, 2012 | Thu Apr. 26, 2012 | 165 | Meeting Planning, Ad Agency |
| 167 | Consultancy Agreements for Attendees | 3 | d | Thu Apr. 26, 2012 | Tue May 1, 2012 | 166 | Meeting Planning, Ad Agency |
| 168 | Send Out Invitation to Group 1 | 2 | d | Tue May 1, 2012 | Thu May 3, 2012 | 167 | Meeting Planning, Ad Agency |
| 169 | Invitation turnaround | 2 | ew | Thu May 3, 2012 | Thu May 17, 2012 | 168 | Ad Agency, Meeting Planning |
| 170 | Evaluate Group 1 Responses to Invitation | 2 | d | Thu May 31, 2012 | Mon Jun. 4, 2012 | 169FS + 10 d | Ad Agency, Meeting Planning |
| 171 | Follow-Up to Medical director and Brand Ma [symbol] | 2 | d | Mon Jun. 4, 2012 | Wed Jun. 6, 2012 | 170 | Meeting Planning, Brand Management, Medical Directo [symbol] |
| 172 | Send Out Invitation & Agenda to Wave 2 (if a [symbol] | 2 | d | Wed Jun. 6, 2012 | Fri Jun. 8, 2012 | 171 | Meeting Planning, Ad Agency |
| 173 | Invitation turnaround | 2 | ew | Fri Jun. 8, 2012 | Fri Jun. 22, 2012 | 172 | Meeting Planning[50%], Ad Agency [50%] |
| 174 | Evaluate Group 2 Responses to Invitation | 2 | d | Fri Jun. 22, 2012 | Tue Jun. 26, 2012 | 173 | Meeting Planning, Ad Agency |
| 175 | Confirmation Letters to Attendees Group 1 a [symbol] | 3 | d | Tue Jun. 26, 2012 | Fri Jun. 29, 2012 | 174 | Meeting Planning, Ad Agency |
| 176 | Distribute Itineraries to Attendees | 1 | d | Fri Jun. 29, 2012 | Mon Jul. 2, 2012 | 175 | Meeting Planning, Ad Agency |
| 177 | Consultancy Agreement for External Modera [symbol] | 2 | d | Mon Jul. 2, 2012 | Wed Jul. 4, 2012 | 176 | Meeting Planning, Ad Agency |
| 178 | Speaker Training | 1 | d | Wed Jul. 4, 2012 | Thu Jul. 5, 2012 | 177 | |
| 179 | Speaker Training Steering Committee | 129.3 | d | Mon Jan. 23, 2012 | Fri Jul. 20, 2012 | | |
| 180 | Content Development | 52.5 | d | Mon Jan. 23, 2012 | Wed Apr. 4, 2012 | | |
| 181 | Develop objectives and Agenda | 3 | d | Mon Jan. 23, 2012 | Wed Jan. 25, 2012 | 1FS + 8.4 mons | |
| 182 | Identify KOL's to participate on the Steering Co [symbol] | 10 | d | Thu Jan. 26, 2012 | Wed Feb. 8, 2012 | 181 | |
| 183 | Development of message for KOL | 1 | d | Thu Feb. 9, 2012 | Thu Feb. 9, 2012 | 182 | Brand Management, Medical Director |
| 184 | Review, revision and approval of message | 1 | d | Fri Feb. 10, 2012 | Fri Feb. 10, 2012 | 183 | Brand Management, Medical Director |
| 185 | Determine which materials to provide (literatu [symbol] | 11 | d | Mon Feb. 13, 2012 | Mon Feb. 27, 2012 | 184 | Medical Director, Brand Management |
| 186 | Speaker slide Deck-prepare draft | 1.5 | d | Tue Feb. 28, 2012 | Wed Feb. 29, 2012 | 185 | Medical Director, Brand Management |
| 187 | Circulate draft deck for review | 5 | d | Wed Feb. 29, 2012 | Wed Mar. 7, 2012 | 186 | |
| 188 | Speaker Deck-Revise Draft | 2 | d | Wed Mar. 7, 2012 | Fri Mar. 9, 2012 | 187 | Medical Director, Brand Management |
| 189 | Speaker Training Deck-Regulatory and Legal Rev [symbol] | 10 | d | Fri Mar. 9, 2012 | Fri Mar. 23, 2012 | 188 | Medical Director, Brand Management |
| 190 | Speaker Training Deck approved | 5 | d | Fri Mar. 23, 2012 | Fri Mar. 30, 2012 | 189 | Medical Director, Brand Management |
| 191 | Pre-brief reporters | 1 | d | Fri Mar. 30, 2012 | Mon Apr. 2, 2012 | 190 | Communication |
| 192 | Media train presenters | 1 | d | Mon Apr. 2, 2012 | Tue Apr. 3, 2012 | 191 | Communication |
| 193 | Schedule clinical presentations | 1 | d | Tue Apr. 3, 2012 | Wed Apr. 4, 2012 | 192 | Medical Director, Brand Management |
| 194 | Identify speakers | 0 | d | Wed Apr. 4, 2012 | Wed Apr. 4, 2012 | 193 | Medical Director, Brand Management |
| 195 | Meeting Planning | 58.8 | d | Wed Apr. 4, 2012 | Tue Jun. 26, 2012 | 194 | |
| 196 | Speaker Training Meeting Planning (Medical, [symbol] | 3 | d | Wed Apr. 4, 2012 | Mon Apr. 9, 2012 | | Brand Management, Medical Director |
| 197 | Commitment to conducting the meeting | 0 | d | Wed Apr. 4, 2012 | Wed Apr. 4, 2012 | 1SS + 11 mons | Brand Management, Medical Director |
| 198 | Complete/Submit Meeting Request Form to [symbol] | 0.5 | d | Wed Apr. 4, 2012 | Wed Apr. 4, 2012 | 197 | Brand Management, Medical Director |
| 199 | Meeting specifics and budget reviewed and a [symbol] | 0.5 | d | Mon Apr. 9, 2012 | Mon Apr. 9, 2012 | 198FS + 2 d | Brand Management, Medical Director |
| 200 | Engage Speaker Training Agency | 55 | d | Mon Apr. 9, 2012 | Mon Jun. 25, 2012 | | |
| 201 | Prepare Soliciatation for Speaker Training Ag [symbol] | 1 | w | Mon Apr. 9, 2012 | Mon Apr. 16, 2012 | 199 | |
| 202 | Distribute RFP to vendors | 1 | w | Mon Apr. 16, 2012 | Mon Apr. 23, 2012 | 201 | |
| 203 | Evaluate Responses | 3 | w | Mon Apr. 23, 2012 | Mon May 14, 2012 | 202 | |
| 204 | Select Agancy | 1 | w | Mon May 14, 2012 | Mon May 21, 2012 | 203 | |
| 205 | Submit selection for review | 1 | w | Mon May 21, 2012 | Mon May 28, 2012 | 204 | |
| 206 | Develop Speaker Training Website | 4 | w | Mon May 28, 2012 | Mon Jun. 25, 2012 | 205 | |
| 207 | Create and source RFP for the meeting | 58.8 | d | Wed Apr. 4, 2012 | Tue Jun. 26, 2012 | | Meeting Planning |
| 208 | RFP is drafted | 2 | d | Wed Apr. 4, 2012 | Fri Apr. 6, 2012 | 155 | Meeting Planning |
| 209 | RFP is reviewed and approved | 1 | d | Fri Apr. 6, 2012 | Mon Apr. 9, 2012 | 208 | Meeting Planning |
| 210 | Distribute RFP to vendors | 2 | d | Mon Apr. 9, 2012 | Wed Apr. 11, 2012 | 209 | Meeting Planning |
| 211 | Compile list of responses to the RFP and distr [symbol] | 1 | d | Wed Apr. 11, 2012 | Thu Apr. 12, 2012 | 210 | Meeting Planning |
| 212 | Present to Medical Director and Marketing (b [symbol] | 2 | d | Thu Apr. 12, 2012 | Mon Apr. 16, 2012 | 211 | Meeting Planning |
| 213 | Venues proposed and negotiations are condu [symbol] | 6 | d | Mon Apr. 16, 2012 | Tue Apr. 24, 2012 | 212 | Meeting Planning |
| 214 | Contracts are routed to procurement and leg [symbol] | 2.67 | d | Tue Apr. 24, 2012 | Fri Apr. 27, 2012 | 213 | Legal, Meeting Planning, Procurement |
| 215 | Circulated for final signature and approval | 1.33 | d | Fri Apr. 27, 2012 | Mon Apr. 30, 2012 | 214 | Legal, Meeting Planning, Procurement |
| 216 | Agreement is routed to venue for signature a [symbol] | 1 | d | Mon Apr. 30, 2012 | Tue May 1, 2012 | 215 | Legal, Meeting Planning, Procurement |
| 217 | Invitations/Letters | 40.8 | d | Mon Apr. 30, 2012 | Tue Jun. 26, 2012 | | |
| 218 | Invitations/Letters-Prepare Drafts | 3 | d | Mon Apr. 30, 2012 | Thu May 3, 2012 | 215 | Meeting Planning |
| 219 | Invitations/Letters-Legal Review of Drafts | 3 | d | Thu May 3, 2012 | Tue May 8, 2012 | 218 | Meeting Planning |
| 220 | Invitations/Letters-Finalize | 2 | d | Tue May 8, 2012 | Thu May 10, 2012 | 219 | Meeting Planning |
| 221 | Consultancy Agreements for Attendees | 2 | d | Thu May 10, 2012 | Mon May 14, 2012 | 220 | Meeting Planning |
| 222 | Send Out Invitation to Group 1 | 3 | d | Mon May 14, 2012 | Thu May 17, 2012 | 221 | Meeting Planning |
| 223 | Invitation turnaround | 2 | ew | Thu May 17, 2012 | Thu May 31, 2012 | 222 | |
| 224 | Evaluate Group 1 Responses to Invitation | 0.5 | d | Thu May 31, 2012 | Thu May 31, 2012 | 223 | Brand Management, Medical Director |
| 225 | Send Out Invitation to Wave 2 (if applicabl [symbol] | 2 | ew | Thu May 31, 2012 | Thu Jun. 14, 2012 | 224 | Meeting Planning |
| 226 | Evaluate Group 2 Responses to Invitation | 0.5 | d | Fri Jun. 15, 2012 | Fri Jun. 15, 2012 | 225 | Brand Management, Medical Director |
| 227 | Follow-Up to Medical director and Market | 2.8 | d | Fri Jun. 15, 2012 | Wed Jun. 20, 2012 | 226 | Meeting Planning |
| 228 | Confirmation Letters to Attendees Group 1 | 1.5 | d | Wed Jun. 20, 2012 | Thu Jun. 21, 2012 | 227 | Meeting Planning |
| 229 | Ticket Mailing Letters to Attendees | 1 | d | Thu Jun. 21, 2012 | Fri Jun. 22, 2012 | 228 | Meeting Planning |
| 230 | Consultancy Agreement for External Mode | 1.5 | d | Fri Jun. 22, 2012 | Tue Jun. 26, 2012 | 229 | Meeting Planning |
| 231 | Conduct Steering Committee Speaker Training P [symbol] | 18 | d | Tue Jun. 26, 2012 | Fri Jul. 20, 2012 | 230 | Medical Director, Brand Management |
| 232 | Conduct Speaker Training Meetings | 2 | d | Tue Jun. 26, 2012 | Thu Jun. 28, 2012 | 230 | |
| 233 | Collect Evaluation Data from Speaker Training | 6 | d | Thu Jun. 28, 2012 | Fri Jul. 6, 2012 | 232 | Medical Director, Brand Management |
| 234 | Communicate Speaker Training Feedback to St [symbol] | 10 | d | Fri Jul. 6, 2012 | Fri Jul. 20, 2012 | 233 | Medical Director, Brand Management |
| 235 | Speaker Training Remaining Speaker Bureau | 715 | d | Wed Jun. 1, 2011 | Tue Feb. 25, 2014 | | |
| 236 | Content and Speaker Bureau List | 665 | d | Wed Aug. 10, 2011 | Tue Feb. 25, 2014 | | |
| 237 | Speaker Training Deck approved | 5 | d | Fri Mar. 30, 2012 | Fri Apr. 6, 2012 | 190 | Medical Director, Brand Management |
| 238 | Identify the KOL's to become speakers | 5 | mons | Wed Aug. 10, 2011 | Tue Dec. 27, 2011 | 140 | Brand Management, Medical Director |
| 239 | On-going Maintenance of Speaker Bureau | 277 | d | Mon Feb. 4, 2013 | Tue Feb. 25, 2014 | 145FS + 11 mons | Brand Management, Medical Director |
| 240 | Meeting Planning (Remaining Speaker Bureau) | 291 | d | Wed Jun. 1, 2011 | Wed Jul. 11, 2012 | | Brand Management, Medical Director |
| 241 | Commitment to conducting the meeting | 0 | d | Wed Jun. 1, 2011 | Wed Jun. 1, 2011 | | Brand Management, Medical Director |
| 242 | Complete/Submit Meeting Request Form to Me [symbol] | 0.5 | d | Wed Jun. 1, 2011 | Wed Jun. 1, 2011 | 241 | Brand Management, Medical Director |
| 243 | Meeting specifics and budget reviewed and app [symbol] | 0.5 | d | Fri Jun. 3, 2011 | Fri Jun. 3, 2011 | 242FS + 2 d | Brand Management, Medical Director |
| 244 | Create and source RFP for the meeting | 77 | d | Tue Mar. 27, 2012 | Wed Jul. 11, 2012 | | Meeting Planning |
| 245 | RFP is drafted | 2 | d | Tue Mar. 27, 2012 | Wed Mar. 28, 2012 | 155 | Meeting Planning |
| 246 | RFP is reviewed and approved | 1 | d | Thu Mar. 29, 2012 | Thu Mar. 29, 2012 | 245 | Meeting Planning |
| 247 | Distribute RFP to vendors | 2 | d | Fri Mar. 30, 2012 | Mon Apr. 2, 2012 | 246 | Meeting Planning |
| 248 | Compile list of responses to the RFP and distr [symbol] | 1 | d | Tue Apr. 3, 2012 | Tue Apr. 3, 2012 | 247 | Meeting Planning |
| 249 | Present to Medical Director and Marketing (b [symbol] | 2 | d | Wed Apr. 4, 2012 | Thu Apr. 5, 2012 | 248 | Meeting Planning |
| 250 | Venues proposed and negotiations are condu [symbol] | 6 | d | Fri Apr. 6, 2012 | Fri Apr. 13, 2012 | 249 | Meeting Planning |
| 251 | Contracts are routed to procurement and leg [symbol] | 2.67 | d | Mon Apr. 16, 2012 | Wed Apr. 18, 2012 | 250 | Legal, Meeting Planning, Procurement |
| 252 | Circulated for final signature and approval | 1.33 | d | Wed Apr. 18, 2012 | Thu Apr. 19, 2012 | 251 | Legal, Meeting Planning, Procurement |
| 253 | Agreement is routed to venue for signature a [symbol] | 1 | d | Fri Apr. 20, 2012 | Fri Apr. 20, 2012 | 252 | Legal, Meeting Planning, Procurement |
| 254 | Invitations/Letters | 48 | d | Mon May 7, 2012 | Wed Jul. 11, 2012 | | |
| 255 | Invitations/Letters-Prepare Drafts | 3 | d | Mon May 7, 2012 | Wed May 9, 2012 | 253FS + 2 w | Meeting Planning |
| 256 | Invitations/Letters-Legal Review of Drafts | 3 | d | Thu May 10, 2012 | Mon May 14, 2012 | 255 | Meeting Planning |
| 257 | Invitations/Letters-Finalize | 2 | d | Tue May 15, 2012 | Wed May 16, 2012 | 256 | Meeting Planning |
| 258 | Consultancy Agreements for Attendees | 2 | d | Thu May 17, 2012 | Fri May 18, 2012 | 257 | Meeting Planning |
| 259 | Send Out Invitation to Group 1 | 3 | d | Mon May 21, 2012 | Wed May 23, 2012 | 258 | Meeting Planning |
| 260 | Invitation turnaround | 2 | ew | Wed May 23, 2012 | Wed Jun. 6, 2012 | 259 | |
| 261 | Evaluate Group 1 Responses to Invitation | 1 | d | Thu Jun. 7, 2012 | Thu Jun. 7, 2012 | 260 | Brand Management, Medical Director |
| 262 | Send Out Invitation to Wave 2 (if applicabl [symbol] | 2 | ew | Thu Jun. 7, 2012 | Thu Jun. 21, 2012 | 261 | Meeting Planning |
| 263 | Evaluate Group 2 Responses to Invitation | 1 | d | Fri Jun. 22, 2012 | Fri Jun. 22, 2012 | 262 | Brand Management, Medical Director |
| 264 | Follow-Up to Medical director and Market | 2 | d | Mon Jun. 25, 2012 | Tue Jun. 26, 2012 | 263 | Meeting Planning |
| 265 | Confirmation Letters to Attendees Group 1 | 3 | d | Wed Jun. 27, 2012 | Fri Jun. 29, 2012 | 264 | Meeting Planning |
| 266 | Ticket Mailing Letters to Attendees | 3 | d | Mon Jul. 2, 2012 | Wed Jul. 4, 2012 | 265 | Meeting Planning |
| 267 | Consultancy Agreement for External Mode | 1 | w | Thu Jul. 5, 2012 | Wed Jul. 11, 2012 | 266 | Meeting Planning |
| 268 | Conduct Remaining Speaker Bureau Training | 184 | d | Thu Jul. 12, 2012 | Tue Mar. 26, 2013 | | Brand Management, Medical Director |
| 269 | Speaker Training 1 | 1 | d | Thu Jul. 12, 2012 | Thu Jul. 12, 2012 | 267 | Brand Management, Medical Director |
| 270 | Collect Evaluation Data from Speaker Training | 1 | d | Fri Jul. 13, 2012 | Fri Jul. 13, 2012 | 269 | |
| 271 | Communicate Speaker Training Feedback to St [symbol] | 5 | d | Mon Jul. 16, 2012 | Fri Jul. 20, 2012 | 270 | |
| 272 | Speaker Training 2 | 1 | d | Fri Oct. 5, 2012 | Fri Oct. 5, 2012 | 269FS + 3 mons | Brand Management, Medical Director |
| 273 | Speaker Training 3 | 1 | d | Mon Dec. 31, 2012 | Mon Dec. 31, 2012 | 272FS + 3 mons | Brand Management, Medical Director |
| 274 | Speaker Training 4 | 1 | d | Tue Mar. 26, 2013 | Tue Mar. 26, 2013 | 273FS + 3 mons | |
| 275 | Medical Ad Boards | 305 | d | Wed Jun. 1, 2011 | Tue Jul. 31, 2012 | | |
| 276 | Medical Ad Board Initial Planning | 8 | d | Wed Jun. 1, 2011 | Fri Jun. 10, 2011 | | Brand Management, Medical Director |
| 277 | Available funding and budget availability review [symbol] | 2 | d | Wed Jun. 1, 2011 | Thu Jun. 2, 2011 | 1SS | Brand Management, Medical Director |
| 278 | Commitment to conducting the meeting | 0 | d | Thu Jun. 2, 2011 | Thu Jun. 2, 2011 | 277 | Brand Management, Medical Director |
| 279 | Complete/Submit Meeting Request Form to Me [symbol] | 1 | d | Fri Jun. 3, 2011 | Fri Jun. 3, 2011 | 278 | Brand Management, Medical Director |
| 280 | Meeting specifics and budget reviewed and app [symbol] | 1 | d | Wed Jun. 8, 2011 | Wed Jun. 8, 2011 | 279FS + 2 d | Brand Management, Medical Director |
| 281 | Develop Meeting Objectives and Agenda | 1 | d | Thu Jun. 9, 2011 | Thu Jun. 9, 2011 | 280 | |
| 282 | Identify KOL's | 1 | d | Fri Jun. 10, 2011 | Fri Jun. 10, 2011 | 281 | |
| 283 | Content Development-Medical | 257 | d | Mon Jun. 13, 2011 | Tue Jun. 5, 2012 | 282 | |
| 284 | Develop clinical presentation slide kit | 0.5 | d | Mon Jun. 13, 2011 | Mon Jun. 13, 2011 | 282 | Brand Management, Medical Director |
| 285 | Identify speakers | 0.5 | d | Mon Jun. 13, 2011 | Mon Jun. 13, 2011 | 284 | Brand Management, Medical Director |
| 286 | Schedule clinical presentations | 0.5 | d | Tue Jun. 14, 2011 | Tue Jun. 14, 2011 | 285 | Brand Management, Medical Director |
| 287 | Meeting Activities Advisory Boards-Medical | 6.5 | d | Mon May 28, 2012 | Tue Jun. 5, 2012 | | |
| 288 | Ad Board Materials Development | 6.5 | d | Mon May 28, 2012 | Tue Jun. 5, 2012 | | |
| 289 | Ad Board Questions-prepare draft | 1.5 | d | Mon May 28, 2012 | Tue May 29, 2012 | 212FS + 1.5 mons | Brand Management, Medical Director |
| 290 | Ad Board Questions-Revise Draft | 1.5 | d | Wed May 30, 2012 | Thu May 31, 2012 | 289 | Brand Management, Medical Director |
| 291 | Ad Board Questions-Legal Review Revised | 1.5 | d | Thu May 31, 2012 | Fri Jun. 1, 2012 | 290 | Brand Management, Medical Director |
| 292 | Ad Board Questions/Discussion Guide-Fin [symbol] | 2 | d | Mon Jun. 4, 2012 | Tue Jun. 5, 2012 | 291 | Brand Management, Medical Director |
| 293 | Ad Board Medical Planning Meeting (Medical, & [symbol] | 255.5 | d | Thu Jun. 30, 2011 | Thu Jun. 21, 2012 | | Brand Management, Medical Director |
| 294 | Create and source RFP for the meeting | 19 | d | Thu Jun. 30, 2011 | Tue Jul. 26, 2011 | | Meeting Planning |
| 295 | RFP is drafted | 2 | d | Thu Jun. 30, 2011 | Fri Jul. 1, 2011 | 280FS + 3 w | Meeting Planning |
| 296 | RFP is reviewed and approved | 1 | d | Mon Jul. 4, 2011 | Mon Jul. 4, 2011 | 295 | Meeting Planning |
| 297 | Distribute RFP to vendors | 2 | d | Tue Jul. 5, 2011 | Wed Jul. 6, 2011 | 296 | Meeting Planning |
| 298 | Compile list of responses to the RFP and distr [symbol] | 1 | d | Thu Jul. 7, 2011 | Thu Jul. 7, 2011 | 297 | Meeting Planning |
| 299 | Present to Medical Director and Marketing (b [symbol] | 2 | d | Fri Jul. 8, 2011 | Mon Jul. 11, 2011 | 298 | Meeting Planning |
| 300 | Venues proposed and negotiations are condu [symbol] | 6 | d | Tue Jul. 12, 2011 | Tue Jul. 19, 2011 | 299 | Meeting Planning |
| 301 | Contracts are routed to procurement and leg [symbol] | 2.67 | d | Wed Jul. 20, 2011 | Fri Jul. 22, 2011 | 300 | Legal, Meeting Planning, Procurement |
| 302 | Circulated for final signature and approval | 1.33 | d | Fri Jul. 22, 2011 | Mon Jul. 25, 2011 | 301 | Legal, Meeting Planning, Procurement |
| 303 | Agreement is routed to venue for signature a [symbol] | 1 | d | Tue Jul. 26, 2011 | Tue Jul. 26, 2011 | 302 | Legal, Meeting Planning, Procurement |
| 304 | Invitations/Letters | 37 | d | Tue May 1, 2012 | Thu Jun. 21, 2012 | | |
| 305 | Invitations/Letters-Prepare Drafts | 2 | d | Tue May 1, 2012 | Thu May 3, 2012 | 216 | Meeting Planning |
| 306 | Invitations/Letters-Legal Review of Drafts | 3 | d | Thu May 3, 2012 | Tue May 8, 2012 | 305 | Meeting Planning |
| 307 | Invitations/Letters-Finalize | 2 | d | Tue May 8, 2012 | Thu May 10, 2012 | 306 | Meeting Planning |
| 308 | Consultancy Agreements for Attendees | 2 | d | Thu May 10, 2012 | Mon May 14, 2012 | 307 | Meeting Planning |
| 309 | Send Out Invitation to Group 1 | 3 | d | Mon May 14, 2012 | Thu May 17, 2012 | 308 | Meeting Planning |
| 310 | Invitation turnaround | 2 | ew | Thu May 17, 2012 | Thu May 31, 2012 | 309 | |
| 311 | Evaluate Group 1 Responses to Invitation | 0.5 | d | Thu May 31, 2012 | Thu May 31, 2012 | 310 | Brand Management, Medical Director |
| 312 | Send Out Invitation to Wave 2 (if applicable) | 2 | ew | Thu May 31, 2012 | Thu Jun. 14, 2012 | 311 | Meeting Planning |
| 313 | Evaluate Group 2 Responses to Invitation | 0.5 | d | Fri Jun. 15, 2012 | Fri Jun. 15, 2012 | 312 | Brand Management, Medical Director |
| 314 | Follow-Up to Medical director and Marketin [symbol] | 1 | d | Fri Jun. 15, 2012 | Mon Jun. 18, 2012 | 313 | Meeting Planning |
| 315 | Confirmation Letters to Attendees Group 1 a [symbol] | 1 | d | Mon Jun. 18, 2012 | Tue Jun. 19, 2012 | 314 | Meeting Planning |
| 316 | Ticket Mailing Letters to Attendees | 1 | d | Tue Jun. 19, 2012 | Wed Jun. 20, 2012 | 315 | Meeting Planning |
| 317 | Consultancy Agreement for External Moderat [symbol] | 1 | d | Wed Jun. 20, 2012 | Thu Jun. 21, 2012 | 316 | Meeting Planning |
| 318 | Conduct Advisory Boards Medical | 28.5 | d | Thu Jun. 21, 2012 | Tue Jul. 31, 2012 | | |
| 319 | Advisory Boards 1 | 1 | d | Thu Jun. 21, 2012 | Fri Jun. 22, 2012 | 317 | Brand Management, Medical Director |
| 320 | Advisory Boards 2 | 1 | d | Fri Jun. 22, 2012 | Mon Jun. 25, 2012 | 319 | Brand Management, Medical Director |
| 321 | Advisory Boards 3 | 1 | d | Mon Jun. 25, 2012 | Tue Jun. 26, 2012 | 320 | Brand Management, Medical Director |
| 322 | Advisory Boards 4 | 1 | d | Tue Jun. 26, 2012 | Wed Jun. 27, 2012 | 321 | Brand Management, Medical Director |
| 323 | Collect Evaluation Data from Ad Board and Mod [symbol] | 27.5 | d | Fri Jun. 22, 2012 | Tue Jul. 31, 2012 | 319 | Brand Management, Medical Director |
| 324 | CME/Symposia (?) | 445 | d | Wed Jun. 1, 2011 | Tue Feb. 12, 2013 | | |
| 325 | Develop CME/Medical Education Plan | 85 | d | Wed Jun. 1, 2011 | Tue Sep. 27, 2011 | | Medical Director |
| 326 | Confidentiality Agreements for both Senior Facult [symbol] | 1 | d | Wed Sep. 28, 2011 | Wed Sep. 28, 2011 | 325 | Medical Director |
| 327 | Identify Meetings and Symposia at which to prese [symbol] | 131 | d | Thu Sep. 29, 2011 | Thu Mar. 29, 2012 | 326 | Medical Director |
| 328 | Preparation of abstracts/posters | 88 | d | Fri Mar. 30, 2012 | Tue Jul. 31, 2012 | 327 | Medical Director |
| 329 | Submission of materials to relevant congresses an [symbol] | 63 | d | Wed Aug. 1, 2012 | Fri Oct. 26, 2012 | 328 | Medical Director |
| 330 | CME Platform Plan | 77 | d | Mon Oct. 29, 2012 | Tue Feb. 12, 2013 | | |
| 331 | Identify relevant meeting and congresses | 21 | d | Mon Oct. 29, 2012 | Mon Nov. 26, 2012 | 329 | Medical Director |
| 332 | Secure budget for large/small medical educatio [symbol] | 20 | d | Tue Nov. 27, 2012 | Mon Dec. 24, 2012 | 331 | Medical Director |
| 333 | identify other targets for CE (e.g. pharmacists) | 21 | d | Tue Dec. 25, 2012 | Tue Jan. 22, 2013 | 332 | Medical Director |
| 334 | Develop CME/Medical educational plan | 3 | w | Wed Jan. 23, 2013 | Tue Feb. 12, 2013 | 333 | Medical Director |
| 335 | Conventions and Events | 400 | d | Wed Jun. 1, 2011 | Tue Dec. 11, 2012 | | |
| 336 | Medical Societies | 400 | d | Wed Jun. 1, 2011 | Tue Dec. 11, 2012 | | Communication |
| 337 | Identify Partners | 20 | mons | Wed Jun. 1, 2011 | Tue Dec. 11, 2012 | | Communication |
| 338 | Determine opportunities | 20 | mons | Wed Jun. 1, 2011 | Tue Dec. 11, 2012 | 337SS | Communication |
| 339 | Develop project plans | 20 | mons | Wed Jun. 1, 2011 | Tue Dec. 11, 2012 | 338SS | Communication |
| 340 | Sponsorship Negotiation | 20 | mons | Wed Jun. 1, 2011 | Tue Dec. 11, 2012 | 339SS | Communication |
| 341 | Pre and Post Launch Medical Meetings: | 285 | d | Tue Jun. 14, 2011 | Mon Jul. 16, 2012 | | |
| 342 | Professional Organization | 285 | d | Tue Jun. 14, 2011 | Mon Jul. 16, 2012 | 354 | Communication |
| 343 | Professional Organization | 285 | d | Tue Jun. 14, 2011 | Mon Jul. 16, 2012 | 342FF | Communication |
| 344 | Conventions and Events | 9 | d | Wed Jun. 1, 2011 | Mon Jun. 13, 2011 | | |
| 345 | Conventions | 9 | d | Wed Jun. 1, 2011 | Mon Jun. 13, 2011 | | |
| 346 | Develop convention schedule | 1 | d | Wed Jun. 1, 2011 | Wed Jun. 1, 2011 | | Convention Services |
| 347 | Develop Communication objectives | 1 | d | Thu Jun. 2, 2011 | Thu Jun. 2, 2011 | 346 | Communication |
| 348 | Create Convention tactics (Communications) | 1 | d | Fri Jun. 3, 2011 | Fri Jun. 3, 2011 | 347 | Communication |
| 349 | Develop plan details | 1 | d | Mon Jun. 6, 2011 | Mon Jun. 6, 2011 | 348 | Convention Services |
| 350 | Organize planning resources | 1 | d | Tue Jun. 7, 2011 | Tue Jun. 7, 2011 | 349 | Convention Services |
| 351 | Select graphics/artwork vendor | 1 | d | Wed Jun. 8, 2011 | Wed Jun. 8, 2011 | 350 | Convention Services |
| 352 | Develop prelaunch graphics/artwork | 1 | d | Thu Jun. 9, 2011 | Thu Jun. 9, 2011 | 351 | Convention Services |
| 353 | Produce prelaunch graphics | 1 | d | Fri Jun. 10, 2011 | Fri Jun. 10, 2011 | 352 | Convention Services |
| 354 | Select and recruit MSL Medical staffing for ex [symbol] | 1 | d | Mon Jun. 13, 2011 | Mon Jun. 13, 2011 | 353 | Convention Services |
| 355 | DVD's and Reprints | 22.5 | d | Wed Dec. 7, 2011 | Fri Jan. 6, 2012 | | |
| 356 | Develop DVD's | 1.5 | w | Wed Dec. 7, 2011 | Fri Dec. 16, 2011 | 37 | Brand Management, Medical Director |
| 357 | Develop Reports | 2.5 | w | Wed Dec. 7, 2011 | Fri Dec. 23, 2011 | 356SS | Brand Management, Medical Director |
| 358 | Distribute DVD's and Reports | 1 | w | Fri Dec. 30, 2011 | Fri Jan. 6, 2012 | 357FS + 5 d | Brand Management, Medical Director |
| 359 | Experience Program | 192.42 | d | Wed Jun. 1, 2011 | Fri Feb. 24, 2012 | | |
| 360 | Speaker Bureau Experience Program | 129 | d | Wed Jun. 1, 2011 | Mon Nov. 28, 2011 | | |
| 361 | Prepare speaker materials | 35 | d | Wed Jun. 1, 2011 | Tue Jul. 19, 2011 | 1SS | Medical Agency, Medical Director |
| 362 | Finalize speaker material and plan for speaker t [symbol] | 3.4 | mons | Wed Aug. 3, 2011 | Fri Nov. 4, 2011 | 361FS + 10 d | Ad Agency, Brand Management |
| 363 | Submission of all materials prepared to LMR Ap [symbol] | 2 | w | Mon Nov. 7, 2011 | Fri Nov. 18, 2011 | 362 | Ad Agency |
| 364 | LMR Approval review, comment and approval | 6 | d | Mon Nov. 21, 2011 | Mon Nov. 28, 2011 | 363 | Ad Agency, Legal, Brand Management, Regulatory, Sales |
| 365 | DDMAC File and Go | 0 | d | Mon Nov. 28, 2011 | Mon Nov. 28, 2011 | 364 | |
| 366 | Charter Member Speaker Training Experience Pro [symbol] | 63.42 | d | Tue Nov. 29, 2011 | Fri Feb. 24, 2012 | | |
| 367 | Kick-off Meeting planning | 7 | w | Tue Nov. 29, 2011 | Mon Jan. 16, 2012 | 365 | Brand Management, Medical Agency, Medical Director, [symbol] |
| 368 | Revise agenda & faculty list | 3 | d | Tue Jan. 24, 2012 | Thu Jan. 26, 2012 | 367FS + 1 w | Medical Agency, Brand Management, Medical Director |
| 369 | Live Status Meeting | 1 | d | Fri Jan. 27, 2012 | Fri Jan. 27, 2012 | 368 | Ad Agency, Brand Management, Medical Director |
| 370 | Confirm Chair and Faculty | 2 | d | Mon Jan. 30, 2012 | Tue Jan. 31, 2012 | 369 | Medical Director |
| 371 | Invite Faculty | 0.67 | d | Fri Jan. 27, 2012 | Fri Jan. 27, 2012 | 368 | Medical Director, Medical Agency, Meeting Planning |
| 372 | Training deck internal workshop | 7 | d | Fri Jan. 27, 2012 | Tue Feb. 7, 2012 | 371 | Medical Agency |
| 373 | Live Status meeting | 2 | d | Tue Feb. 7, 2012 | Thu Feb. 9, 2012 | 372 | Ad Agency, Brand Management, Medical |
| 374 | Attendee pre-trip confirmations letters sent | 1 | d | Thu Feb. 9, 2012 | Fri Feb. 10, 2012 | 373 | Medical Agency, Meeting Planning |
| 375 | Meeting “look” and program components inclu [symbol] | 1 | d | Tue Feb. 7, 2012 | Wed Feb. 8, 2012 | 372 | Medical Agency, Meeting Planning |
| 376 | Schedule conference call with chair and faculty | 0.5 | d | Wed Feb. 8, 2012 | Thu Feb. 9, 2012 | 375 | Medical Agency, Meeting Planning |
| 377 | Develop first draft of presentations (non-core sl [symbol] | 2 | d | Thu Feb. 9, 2012 | Mon Feb. 13, 2012 | 376 | Medical Agency, Meeting Planning |
| 378 | Send first draft to client for review | 1 | d | Mon Feb. 13, 2012 | Tue Feb. 14, 2012 | 377 | Medical Agency, Meeting Planning |
| 379 | Draft (non-core) slides due back to APO | 2 | d | Tue Feb. 14, 2012 | Thu Feb. 16, 2012 | 378 | Medical Agency, Meeting Planning |
| 380 | Conference call with Chair/Faculty | 0.5 | d | Thu Feb. 16, 2012 | Thu Feb. 16, 2012 | 379 | Medical Agency, Meeting Planning |
| 381 | Editorial/digital review of all program materials | 2.5 | d | Thu Feb. 16, 2012 | Tue Feb. 21, 2012 | 380 | Medical Agency, Meeting Planning |
| 382 | Printing of on-site materials | 1 | d | Tue Feb. 21, 2012 | Wed Feb. 22, 2012 | 381 | Medical Agency, Meeting Planning |
| 383 | Conference #2 call with Chair/Faculty | 0.25 | d | Wed Feb. 22, 2012 | Wed Feb. 22, 2012 | 382 | Medical Agency, Meeting Planning |
| 384 | Final Presentations to Client | 0.5 | d | Wed Feb. 22, 2012 | Wed Feb. 22, 2012 | 383 | Medical Agency, Meeting Planning |
| 385 | On-site prep meeting | 0.25 | d | Wed Feb. 22, 2012 | Thu Feb. 23, 2012 | 384 | Medical Agency, Meeting Planning |
| 386 | On-site moderator prep | 0.25 | d | Thu Feb. 23, 2012 | Thu Feb. 23, 2012 | 385 | Medical Agency, Meeting Planning |
| 387 | On-site slide review | 1 | d | Thu Feb. 23, 2012 | Fri Feb. 24, 2012 | 386 | Medical Agency, Meeting Planning |
| 388 | Registry (Optional) | 258.67 | d | Wed Jun. 1, 2011 | Mon May 28, 2012 | | |
| 389 | Registry Design development | 1.5 | mons | Wed Jun. 1, 2011 | Tue Jul. 12, 2011 | | Brand Management, Medical Director |
| 390 | Registry submitted for approval | 0.5 | d | Wed Jul. 13, 2011 | Wed Jul. 13, 2011 | 389 | Brand Management, Medical Director |
| 391 | Registry approval process | 0.5 | mons | Wed Jul. 13, 2011 | Wed Jul. 27, 2011 | 390 | Brand Management, Medical Director |
| 392 | Registry design approved | 0 | d | Wed Jul. 27, 2011 | Wed Jul. 27, 2011 | 391 | Brand Management, Medical Director |
| 393 | Select Investigators | 1 | mon | Wed Jul. 27, 2011 | Wed Aug. 24, 2011 | 392 | Brand Management, Medical Director |
| 394 | Select CRO | 1 | mon | Wed Jul. 27, 2011 | Wed Aug. 24, 2011 | 393SS | Brand Management, Medical Director |
| 395 | Begin registry | 0 | d | Wed Aug. 24, 2011 | Wed Aug. 24, 2011 | 394 | Brand Management, Medical Director |
| 396 | Registry is operational | 1 | d | Wed Aug. 24, 2011 | Thu Aug. 25, 2011 | 395 | Brand Management, Medical Director |
| 397 | Registry Publication 1 (Global/US) | 118.51 | d | Wed Aug. 24, 2011 | Tue Feb. 7, 2012 | | |
| 398 | Invite authors | 1.5 | w | Wed Aug. 24, 2011 | Fri Sep. 2, 2011 | 395 | Health Economics, Medical Director |
| 399 | Determine if writing assistance necessary and if | 1 | w | Mon Sep. 5, 2011 | Fri Sep. 9, 2011 | 398 | Health Economics, Medical Director |
| 400 | A conference call is held to discuss the manuscri [symbol] | 0.5 | d | Mon Sep. 19, 2011 | Mon Sep. 19, 2011 | 399FS + 5 d | Health Economics, Medical Director |
| 401 | Prepare an outline/backgrounder | 2.5 | d | Mon Sep. 19, 2011 | Wed Sep. 21, 2011 | 400 | Health Economics, Medical Director |
| 402 | Author prepares and submits draft manuscript | 2 | w | Thu Sep. 22, 2011 | Wed Oct. 5, 2011 | 401 | Health Economics, Medical Director |
| 403 | Manuscript is reviewed by the team | 1 | w | Thu Oct. 6, 2011 | Wed Oct. 12, 2011 | 402 | Health Economics, Medical Director |
| 404 | Reviewed manuscript is returned to authors | 0 | w | Thu Oct. 13, 2011 | Thu Oct. 13, 2011 | 403FS + 3 mins | Health Economics, Medical Director |
| 405 | Author prepare final draft | 10 | d | Thu Oct. 13, 2011 | Thu Oct. 27, 2011 | 404 | Health Economics, Medical Director |
| 406 | Obtain internal and external authorization shee [symbol] | 1.5 | d | Thu Oct. 27, 2011 | Fri Oct. 28, 2011 | 405 | Health Economics, Medical Director |
| 407 | Submit article to journal | 1.5 | d | Fri Oct. 28, 2011 | Tue Nov. 1, 2011 | 406 | Health Economics, Medical Director |
| 408 | Journal notifies of decision on publication of ma [symbol] | 1.5 | mons | Tue Nov. 1, 2011 | Tue Dec. 13, 2011 | 407 | Health Economics, Medical Director |
| 409 | Manuscript revisions requested by the publicati [symbol] | 2 | w | Tue Dec. 13, 2011 | Tue Dec. 27, 2011 | 408 | Health Economics, Medical Director |
| 410 | Manuscript is scheduled for publication | 1.5 | mons | Tue Dec. 27, 2011 | Tue Feb. 7, 2012 | 409 | Health Economics, Medical Director |
| 411 | Registry Publication 2 (Global/US) | 80.67 | d | Mon Feb. 6, 2012 | Mon May 28, 2012 | | |
| 412 | Invite authors | 1 | w | Mon Feb. 6, 2012 | Mon Feb. 13, 2012 | 410FS − 1 d | Publication, Health Economics, Medical Director |
| 413 | Determine if writing assistance necessary and if | 0.67 | w | Mon Feb. 13, 2012 | Thu Feb. 16, 2012 | 412 | Publication, Health Economics, Medical Director |
| 414 | A conference call is held to discuss the manuscri [symbol] | 0.33 | d | Thu Feb. 23, 2012 | Thu Feb. 23, 2012 | 413FS + 5 d | Publication, Health Economics, Medical Director |
| 415 | Prepare an outline/backgrounder | 1.67 | d | Thu Feb. 23, 2012 | Mon Feb. 27, 2012 | 414 | Publication, Health Economics, Medical Director |
| 416 | Author prepares and submits draft manuscript | 1.33 | w | Mon Feb. 27, 2012 | Wed Mar. 7, 2012 | 415 | Publication, Health Economics, Medical Director |
| 417 | Manuscript is reviewed by the team | 0.67 | w | Wed Mar. 7, 2012 | Mon Mar. 12, 2012 | 416 | Publication, Health Economics, Medical Director |
| 418 | Reviewed manuscript is returned to authors | 0 | w | Mon Mar. 12, 2012 | Mon Mar. 12, 2012 | 417 | Publication, Health Economics, Medical Director |
| 419 | Author prepare final draft | 6.67 | d | Mon Mar. 12, 2012 | Wed Mar. 21, 2012 | 418 | Publication, Health Economics, Medical Director |
| 420 | Obtain internal and external authorization shee [symbol] | 1 | d | Wed Mar. 21, 2012 | Thu Mar. 22, 2012 | 419 | Publication, Health Economics, Medical Director |
| 421 | Submit article to journal | 1 | d | Thu Mar. 22, 2012 | Fri Mar. 23, 2012 | 420 | Publication, Health Economics, Medical Director |
| 422 | Journal notifies of decision on publication of ma [symbol] | 1 | mon | Fri Mar. 23, 2012 | Fri Apr. 20, 2012 | 421 | Publication, Health Economics, Medical Director |
| 423 | Manuscript revisions requested by the publicati [symbol] | 1.33 | w | Fri Apr. 20, 2012 | Mon Apr. 30, 2012 | 422 | Publication, Health Economics, Medical Director |
| 424 | Manuscript is scheduled for publication | 1 | mon | Mon Apr. 30, 2012 | Mon May 28, 2012 | 423 | Publication, Health Economics, Medical Director |
| 425 | Grand Rounds campaign | 39.5 | d | Wed Jun. 1, 2011 | Tue Jul. 26, 2011 | | Brand Management, Medical Director |
| 426 | Physician Experience Program Program Optional | 22.5 | d | Wed Jun. 1, 2011 | Fri Jul. 1, 2011 | | |
| 427 | IAS strategy | 0.5 | d | Fri Jul. 1, 2011 | Fri Jul. 1, 2011 | 431 | Medical Director, Health Economics |
| 428 | Study Report-1st Draft | 12.5 | d | Wed Jun. 1, 2011 | Fri Jun. 17, 2011 | | Medical Director, Health Economics |
| 429 | Study Report-Review 1st Draft | 6 | d | Fri Jun. 17, 2011 | Mon Jun. 27, 2011 | 428 | Medical Director, Health Economics |
| 430 | Study Report-Final Draft | 2.5 | d | Mon Jun. 27, 2011 | Wed Jun. 29, 2011 | 429 | Medical Director, Health Economics |
| 431 | Study Report-Sign Off | 1 | d | Thu Jun. 30, 2011 | Thu Jun. 30, 2011 | 430 | Medical Director, Health Economics |

[symbol]

indicates data missing or illegible when filed

TABLE 5
REGULATORY PERSPECTIVE

| ID | Task Name | Duration | | Start | Finish | Predecessors | Resource Names |
|---|---|---|---|---|---|---|---|
| 0 | Regulatory | 314 | days | Thu Jan. 20, 2011 | Tue Apr. 3, 2012 | | |
| 1 | New Drug Application Process | 154 | days | Thu Jan. 20, 2011 | Tue Aug. 23, 2011 | | |
| 2 | Forms Preparation and Completion | 67 | days | Mon Feb. 28, 2011 | Tue May 31, 2011 | | |
| 3 | Application form: FDA form 356h | 3.35 | mons | Mon Feb. 28, 2011 | Tue May 31, 2011 | 36SS−3.35 mons | Regulatory |
| 4 | User fee cover sheet: FDA form 3397 | 3.35 | mons | Mon Feb. 28, 2011 | Tue May 31, 2011 | 36FS−3.35 mons | Regulatory |
| 5 | Cover Letter | 3.35 | mons | Mon Feb. 28, 2011 | Tue May 31, 2011 | 36FS−3.35 mons | Regulatory |
| 6 | Administrative Information | 154 | days | Thu Jan. 20, 2011 | Tue Aug. 23, 2011 | | |
| 7 | Contract/Sponsor/Applicant Information | 154 | days | Thu Jan. 20, 2011 | Tue Aug. 23, 2011 | | |
| 8 | Submit the tradename and packaging | 4.7 | mons | Thu Jan. 20, 2011 | Tue May 31, 2011 | 36FS−18.8 wks | Regulatory |
| | to FDA | | | | | | |
| 9 | FDA approval of the tradename and | 0 | mons | Tue Aug. 23, 2011 | Tue Aug. 23, 2011 | 8FS+3 mons | FDA |
| | packaging | | | | | | |
| 10 | Transfer of Obligation (Contract | 3.35 | mons | Mon Feb. 28, 2011 | Tue May 31, 2011 | 36FS−3.35 mons | Regulatory |
| | Research Organizations) | | | | | | |
| 11 | Debarment Certification | 3.35 | mons | Mon Feb. 28, 2011 | Tue May 31, 2011 | 36FS−3.35 mons | Regulatory |
| 12 | Financial certification and | 3.35 | mons | Mon Feb. 28, 2011 | Tue May 31, 2011 | 36FS−3.35 mons | Regulatory |
| | disclosure-Clinical | | | | | | |
| 13 | List of investigators-Clinical | 3.35 | mons | Mon Feb. 28, 2011 | Tue May 31, 2011 | 36FS−3.35 mons | Regulatory |
| 14 | Patent and exclusivity: | 67 | days | Mon Feb. 28, 2011 | Tue May 31, 2011 | | |
| 15 | Patent Information-Legal | 3.35 | mons | Mon Feb. 28, 2011 | Tue May 31, 2011 | 36FS−3.35 mons | Regulatory |
| 16 | Exclusivity request (Statement of | 3.35 | mons | Mon Feb. 28, 2011 | Tue May 31, 2011 | 36FS−3.35 mons | Regulatory |
| | claimed exclusivity) | | | | | | |
| 17 | References: | 67 | days | Mon Feb. 28, 2011 | Tue May 31, 2011 | | |
| 18 | Letters of authorization | 3.35 | mons | Mon Feb. 28, 2011 | Tue May 31, 2011 | 36FS−3.35 mons | Regulatory |
| 19 | List of IND's | 3.35 | mons | Mon Feb. 28, 2011 | Tue May 31, 2011 | 36FS−3.35 mons | Regulatory |
| 20 | Meetings | 30 | days | Thu Apr. 21, 2011 | Wed Jun. 1, 2011 | | |
| 21 | Pre NDA Meeting | 1 | day | Fri Apr. 29, 2011 | Fri Apr. 29, 2011 | 36SS−23 days | Regulatory |
| 22 | Corresponding regarding meetings | 30 | days | Thu Apr. 21, 2011 | Wed Jun. 1, 2011 | 36FS−31 days | Regulatory |
| | (interactions with FDA) | | | | | | |
| 23 | Pediatric administrative Information | 5 | days | Wed Jun. 1, 2011 | Tue Jun. 7, 2011 | | |
| 24 | Request for deferral/waiver of | 5 | days | Wed Jun. 1, 2011 | Tue Jun. 7, 2011 | 36 | Regulatory |
| | pediatric studies | | | | | | |
| 25 | Other correspondence | 67 | days | Mon Feb. 28, 2011 | Tue May 31, 2011 | | |
| 26 | Environmental assessment | 3.35 | mons | Mon Feb. 28, 2011 | Tue May 31, 2011 | 36FS−3.35 mons | Regulatory |
| 27 | Risk Management Plan | 3.35 | mons | Mon Feb. 28, 2011 | Tue May 31, 2011 | 36FS−3.35 mons | Regulatory |
| 28 | Compliance Statement-Clinical | 3.35 | mons | Mon Feb. 28, 2011 | Tue May 31, 2011 | 36FS−3.35 mons | Regulatory |
| 29 | Priority Review Justification | 3.35 | mons | Mon Feb. 28, 2011 | Tue May 31, 2011 | 36FS−3.35 mons | Regulatory |
| 30 | New Drug Application: Module 2-5 | 68 | days | Mon Feb. 28, 2011 | Wed Jun. 1, 2011 | | |
| 31 | New Drug Application Module 3: Quality | 3.35 | mons | Mon Feb. 28, 2011 | Tue May 31, 2011 | 36FS−3.35 mons | Regulatory |
| 32 | New Drug Application Module 4: | 3.35 | mons | Mon Feb. 28, 2011 | Tue May 31, 2011 | 36FS−3.35 mons | Regulatory |
| | Nonclinical Study Reports | | | | | | |
| 33 | New Drug Application Module 5: Clinical | 3.35 | mons | Mon Feb. 28, 2011 | Tue May 31, 2011 | 36FS−3.35 mons | Regulatory |
| | Study Reports | | | | | | |
| 34 | New Drug Application Module 2: Common | 3.35 | mons | Tue Mar. 1, 2011 | Wed Jun. 1, 2011 | 36FS−3.35 mons | Regulatory |
| | technical [symbol] | | | | | | |
| 35 | Submission of NDA | 220 | days | Wed Jun. 1, 2011 | Tue Apr. 3, 2012 | | Regulatory |
| 36 | Submission of NDA | 0 | days | Wed Jun. 1, 2011 | Wed Jun. 1, 2011 | | Regulatory |
| 37 | Acceptance of NDA by the FDA | 0 | days | Wed Jun. 1, 2011 | Wed Jun. 1, 2011 | 36 | FDA |
| 38 | Receive and respond to queries from FDA | 5.5 | mons | Wed Jun. 1, 2011 | Tue Nov. 1, 2011 | 36 | Regulatory, FDA |
| 39 | PDUFA Date | 0 | days | Tue Apr. 3, 2012 | Tue Apr. 3, 2012 | 36FS+11 mons | FDA |

[symbol]

indicates data missing or illegible when filed

TABLE 6
SALES PERSPECTIVE

| ID | Task Name | Duration | | Start | Finish | Predecessors | Resource Names |
|---|---|---|---|---|---|---|---|
| 1 | 1 Implementation Team Kick Off | 0 | days | Wed Jun. 1, 2011 | Wed Jun. 1, 2011 | | Sales Director |
| 2 | 2 PDUFA Date | 0 | days | Tue Apr. 3, 2012 | Tue Apr. 3, 2012 | 1FS+11 mons | |
| 3 | 3 Launch Implementation Plan Approval | 20 | days | Wed Apr. 4, 2012 | Tue May 1, 2012 | 2 | Sales Director |
| 4 | 4 Sales Force Size and Structure | 240 | days | Wed Jun. 1, 2011 | Tue May 1, 2012 | | |
| 5 | 4.1 Sales Force Planning and Deployment | 240 | days | Wed Jun. 1, 2011 | Tue May 1, 2012 | | |
| 6 | 4.1.1 Target analysis (Enhanced deciling) | 6 | wks | Wed Jun. 1, 2011 | Tue Jul. 12, 2011 | | Sales Training |
| 7 | 4.1.2 Designation of territories | 6 | wks | Wed Jul. 13, 2011 | Tue Aug. 23, 2011 | 6 | Sales Training |
| 8 | 4.1.3 Meeting to Review/Agree upon Target List | 8 | wks | Wed Aug. 24, 2011 | Tue Oct. 18, 2011 | 7 | Sales Training |
| 9 | 4.1.4 0 | 0 | days | Tue Oct. 18, 2011 | Tue Oct. 18, 2011 | 8 | Sales Training |
| 10 | 4.1.5 Assign call frequencies to targets | 2 | wks | Wed Oct. 19, 2011 | Tue Nov. 1, 2011 | 9 | Sales Training |
| 11 | 4.1.6 Prepare Final Target List | 4 | wks | Wed Nov. 2, 2011 | Tue Nov. 29, 2011 | 10 | Sales Training |
| 12 | 4.1.7 Final Target List to IS | 3 | days | Wed Nov. 30, 2011 | Fri Dec. 2, 2011 | 11 | Sales Training |
| 13 | 4.1.8 Programming/Downloading Targets into Sales [symbol] | 22 | days | Mon Dec. 5, 2011 | Tue Jan. 3, 2012 | 12 | Sales Training |
| 14 | 4.1.9 Realignment Complete | 2 | wks | Wed Jan. 4, 2012 | Tue Jan. 17, 2012 | 13 | Sales Training |
| 15 | 4.1.10 FSA System Update | 2 | wks | Wed Jan. 18, 2012 | Tue Jan. 31, 2012 | 14 | Sales Training |
| 16 | 4.1.11 Pilot Testing | 6 | wks | Wed Feb. 1, 2012 | Tue Mar. 13, 2012 | 15 | Sales Training |
| 17 | 4.1.12 Update: Targets, Call Frequencies, Deciles, and [symbol] | 4 | wks | Wed Mar. 14, 2012 | Tue Apr. 10, 2012 | 16 | Sales Training |
| 18 | 4.1.13 Load content data | 2 | wks | Wed Apr. 11, 2012 | Tue Apr. 24, 2012 | 17 | Sales Training |
| 19 | 4.1.14 Add product to the system | 1 | wk | Wed Apr. 25, 2012 | Tue May 1, 2012 | 18 | Sales Training |
| 20 | 5 Incentive Compensation Design and Communication | 57.5 | days | Fri Mar. 16, 2012 | Tue Jun. 5, 2012 | | |
| 21 | 5.1 Finalize and communicate goals organizationally | 1 | wk | Fri Mar. 16, 2012 | Thu Mar. 22, 2012 | 17SS | Sales Training |
| 22 | 5.2 Determine incentive objectives | 3.5 | wks | Fri Mar. 23, 2012 | Tue Apr. 17, 2012 | 21 | Sales Training |
| 23 | 5.3 Obtain feedback from RD's | 3.5 | wks | Tue Apr. 17, 2012 | Thu May 10, 2012 | 22 | Sales Training |
| 24 | 5.4 Make revisions to incentive program as needed | 3.5 | wks | Fri May 11, 2012 | Tue Jun. 5, 2012 | 23 | Sales Training |
| 25 | 5.5 Deliver the program to the Field Staff at Launch | 0 | days | Tue Jun. 5, 2012 | Tue Jun. 5, 2012 | 24 | Sales Training |
| 26 | 5.6 Develop Incentitive Compensation Tracking [symbol] | 3 | wks | Fri May 11, 2012 | Thu May 31, 2012 | 23 | |
| 27 | 6 Sales Training Activities | 257.5 | days | Wed Jun. 1, 2011 | Fri May 25, 2012 | | |
| 28 | 6.1 Pre PI Approval Sales Training | 257.5 | days | Wed Jun. 1, 2011 | Fri May 25, 2012 | | |
| 29 | 6.1.1 Account Management Training (POA 1) | 1 | day | Wed Jun. 1, 2011 | Wed Jun. 1, 2011 | | Training Director, Training [symbol] |
| 30 | 6.1.2 Assessment of field force support | 2.5 | days | Thu Jun. 2, 2011 | Mon Jun. 6, 2011 | 29 | Training Director, Training [symbol] |
| 31 | 6.1.3 Vendor selection including contracting & JDE app | 30 | days | Mon Jun. 6, 2011 | Mon Jul. 18, 2011 | 30 | Training Director, Training [symbol] |
| 32 | 6.1.4 Training Program Design | 7 | days | Mon Jul. 18, 2011 | Wed Jul. 27, 2011 | 31 | Training Director, Training [symbol] |
| 33 | 6.1.5 Design Approval | 3 | days | Wed Jul. 27, 2011 | Mon Aug. 1, 2011 | 32 | Training Director, Training [symbol] |
| 34 | 6.1.6 Content Development | 24 | days | Mon Aug. 1, 2011 | Fri Sep. 2, 2011 | 33 | Training Director, Training [symbol] |
| 35 | 6.1.7 Trainer Review & Comments | 4 | days | Fri Sep. 2, 2011 | Thu Sep. 8, 2011 | 34 | Training Director, Training [symbol] |
| 36 | 6.1.8 Review and Revisions | 3 | days | Thu Sep. 8, 2011 | Tue Sep. 13, 2011 | 35 | Training Director, Training [symbol] |
| 37 | 6.1.9 Final revisions | 1 | day | Tue Sep. 13, 2011 | Wed Sep. 14, 2011 | 36 | Training Director, Training [symbol] |
| 38 | 6.1.10 Training/Education in New Product for Sales [symbol] | 182 | days | Wed Sep. 14, 2011 | Fri May 25, 2012 | | |
| 39 | 6.1.10.1 Distribution of Materials to the Field | 3 | days | Wed Sep. 14, 2011 | Mon Sep. 19, 2011 | 37 | Training Director, Training [symbol] |
| 40 | 6.1.10.2 Home study Training Materials | 14 | days | Mon Sep. 19, 2011 | Fri Oct. 7, 2011 | 39 | Training Director, Training [symbol] |
| 41 | 6.1.10.3 In-House Training Materials | 5 | days | Fri Oct. 14, 2011 | Fri Oct. 21, 2011 | 40FS+5 days | Training Director, Training [symbol] |
| 42 | 6.1.10.4 Lead-time for Developing & Reproducing/ [symbol] | 45 | days | Fri Oct. 21, 2011 | Fri Dec. 23, 2011 | 41 | Training Director, Training [symbol] |
| 43 | 6.1.10.5 Advocacy Identification for planning | 6 | wks | Fri Dec. 23, 2011 | Fri Feb. 3, 2012 | 42 | Training Director, Training [symbol] |
| 44 | 6.1.10.6 Advocacy Briefings | 10 | days | Fri Feb. 3, 2012 | Fri Feb. 17, 2012 | 43 | Training Director, Training [symbol] |
| 45 | 6.1.10.7 Assess need for clinician education in [symbol] | 5 | days | Fri Feb. 17, 2012 | Fri Feb. 24, 2012 | 44 | Training Director, Training [symbol] |
| 46 | 6.1.10.8 Tie in with promotional speaker training | 20 | days | Fri Feb. 24, 2012 | Fri Mar. 23, 2012 | 45 | Training Director, Training [symbol] |
| 47 | 6.1.10.9 Printing Materials for the Field | 6 | days | Thu Mar. 22, 2012 | Fri Mar. 30, 2012 | 46FS−1 day | Training Director, Training [symbol] |
| 48 | 6.1.10.10 Home Study Distribution | 5 | days | Fri Apr. 6, 2012 | Fri Apr. 13, 2012 | 47FS+5 days | Training Director, Training [symbol] |
| 49 | 6.1.10.11 Reps Study and TestingTesting | 3 | wks | Fri May 4, 2012 | Fri May 25, 2012 | 48FS+15 days | Training Director, Training [symbol] |
| 50 | 6.1.11 Segmentation Training (Pre-POA 1 e-Learning) | 51 | days | Mon Sep. 19, 2011 | Tue Nov. 29, 2011 | | |
| 51 | 6.1.11.1 Receive and review Segmentation Research | 6 | wks | Mon Sep. 19, 2011 | Mon Oct. 31, 2011 | 39 | Market Research, Medical [symbol] |
| 52 | 6.1.11.2 Identify Key segment drivers | 1.5 | wks | Mon Oct. 31, 2011 | Wed Nov. 9, 2011 | 51 | Market Research, Medical [symbol] |
| 53 | 6.1.11.3 Supply content data to vendor for first [symbol] | 2 | days | Mon Oct. 31, 2011 | Wed Nov. 2, 2011 | 51 | Market Research, Medical [symbol] |
| 54 | 6.1.11.4 Develop training with brand specific [symbol] | 2 | wks | Mon Oct. 31, 2011 | Mon Nov. 14, 2011 | 52SS | Market Research, Medical [symbol] |
| 55 | 6.1.11.5 Create materials In-House by or an agency | 1 | wk | Mon Nov. 14, 2011 | Mon Nov. 21, 2011 | 54 | Agency, Market Research, [symbol] |
| 56 | 6.1.11.6 Finalize both concepts and design | 1 | day | Mon Nov. 21, 2011 | Tue Nov. 22, 2011 | 55 | Agency, Market Research, [symbol] |
| 57 | 6.1.11.7 Integrate material into the Sales training [symbol] | 1 | wk | Tue Nov. 22, 2011 | Tue Nov. 29, 2011 | 56 | Agency, Market Research, [symbol] |
| 58 | 6.1.12 Sales Training Segmentation Training for [symbol] | 42 | days | Mon Sep. 19, 2011 | Wed Nov. 16, 2011 | | |
| 59 | 6.1.12.1 Develop Segmentation Training training [symbol] | 20 | days | Mon Sep. 19, 2011 | Mon Oct. 17, 2011 | | Sales Training Manager |
| 60 | 6.1.12.1.1 e-Learning program (Pre PI) to Create [symbol] | 2 | days | Mon Sep. 19, 2011 | Wed Sep. 21, 2011 | 39 | Sales Training Manager |
| 61 | 6.1.12.1.2 Create series of key topics for [symbol] | 1 | wk | Wed Sep. 21, 2011 | Wed Sep. 28, 2011 | 60 | Sales Training Manager |
| 62 | 6.1.12.1.3 Create Key Account plan curriculum | 1 | wk | Wed Sep. 28, 2011 | Wed Oct. 5, 2011 | 61 | Sales Training Manager |
| 63 | 6.1.12.1.4 Identify tactical activities | 3 | days | Wed Oct. 5, 2011 | Mon Oct. 10, 2011 | 62 | Sales Training Manager |
| 64 | 6.1.12.1.5 Identify courseware, presentation and [symbol] | 5 | days | Mon Oct. 10, 2011 | Mon Oct. 17, 2011 | 63 | Sales Training Manager |
| 65 | 6.1.12.2 Develop Segmentation Training training [symbol] | 30 | days | Wed Oct. 5, 2011 | Wed Nov. 16, 2011 | | |
| 66 | 6.1.12.2.1 Create review of account and territorial | 2 | wks | Wed Oct. 5, 2011 | Wed Oct. 19, 2011 | 62 | Brand Management, Sales [symbol] |
| 67 | 6.1.12.2.2 Create a review of the Buying Ladder [symbol] | 2 | wks | Wed Oct. 19, 2011 | Wed Nov. 2, 2011 | 66 | Brand Management, Sales [symbol] |
| 68 | 6.1.12.2.3 Create key account plan curriculum | 2 | wks | Wed Nov. 2, 2011 | Wed Nov. 16, 2011 | 67 | |
| 69 | 6.2 Training Document Design (Home Study) | 50 | days | Wed Nov. 16, 2011 | Wed Jan. 25, 2012 | | |
| 70 | 6.2.1 Module 1 | 25 | days | Wed Nov. 16, 2011 | Wed Dec. 21, 2011 | | |
| 71 | 6.2.1.1 Agency to development Design Document | 4 | days | Wed Nov. 16, 2011 | Tue Nov. 22, 2011 | 68 | Sales Training Agency |
| 72 | 6.2.1.2 LMR to review Design Document | 5 | days | Tue Nov. 22, 2011 | Tue Nov. 29, 2011 | 71 | Sales Training Agency |
| 73 | 6.2.1.3 Call to review Design Document | 1 | day | Tue Nov. 29, 2011 | Wed Nov. 30, 2011 | 72 | Sales Training Agency |
| 74 | 6.2.1.4 Agency to make necessary changes | 5 | days | Wed Nov. 30, 2011 | Wed Dec. 7, 2011 | 73 | Sales Training Agency |
| 75 | 6.2.1.5 LMR to approve Design Document | 10 | days | Wed Dec. 7, 2011 | Wed Dec. 21, 2011 | 74 | Sales Training Agency |
| 76 | 6.2.2 Module 2 | 25 | days | Wed Dec. 21, 2011 | Wed Jan. 25, 2012 | | |
| 77 | 6.2.2.1 Agency to development Design Document | 4 | days | Wed Dec. 21, 2011 | Tue Dec. 27, 2011 | 75 | Sales Training Agency |
| 78 | 6.2.2.2 LMR to review Design Document | 5 | days | Tue Dec. 27, 2011 | Tue Jan. 3, 2012 | 77 | Sales Training Agency |
| 79 | 6.2.2.3 Call to review Design Document | 1 | day | Tue Jan. 3, 2012 | Wed Jan. 4, 2012 | 78 | Sales Training Agency |
| 80 | 6.2.2.4 Agency to make necessary changes | 5 | days | Wed Jan. 4, 2012 | Wed Jan. 11, 2012 | 79 | Sales Training Agency |
| 81 | 6.2.2.5 LMR to approve Design Document | 10 | days | Wed Jan. 11, 2012 | Wed Jan. 25, 2012 | 80 | Sales Training Agency |
| 82 | 6.3 Sales Training Content Development (Home Study) | 36 | days | Wed Dec. 21, 2011 | Thu Feb. 9, 2012 | | |
| 83 | 6.3.1 Development of Content Module 1 | 31 | days | Wed Dec. 21, 2011 | Thu Feb. 2, 2012 | | |
| 84 | 6.3.1.1 Agency to develop content | 10 | days | Wed Dec. 21, 2011 | Wed Jan. 4, 2012 | 75 | Sales Training Agency |
| 85 | 6.3.1.2 Content walkthrough with client | 5 | days | Wed Jan. 4, 2012 | Wed Jan. 11, 2012 | 84 | Sales Training Agency |
| 86 | 6.3.1.3 LMR to review content | 3 | days | Wed Jan. 11, 2012 | Mon Jan. 16, 2012 | 85 | Sales Training Agency |
| 87 | 6.3.1.4 Agency to incorporate feedback from [symbol] | 5 | days | Mon Jan. 16, 2012 | Mon Jan. 23, 2012 | 86 | Sales Training Agency |
| 88 | 6.3.1.5 LMR to review final content | 2 | days | Mon Jan. 23, 2012 | Wed Jan. 25, 2012 | 87 | Sales Training Agency |
| 89 | 6.3.1.6 Agency to make any final edits based on final | 1 | day | Wed Jan. 25, 2012 | Thu Jan. 26, 2012 | 88 | Sales Training Agency |
| 90 | 6.3.1.7 LMR to approve content | 5 | days | Thu Jan. 26, 2012 | Thu Feb. 2, 2012 | 89 | Sales Training Agency |
| 91 | 6.3.2 Develop of Contents Module 2 | 26 | days | Wed Jan. 4, 2012 | Thu Feb. 9, 2012 | | |
| 92 | 6.3.2.1 Agency to develop content | 10 | days | Wed Jan. 4, 2012 | Wed Jan. 18, 2012 | 84 | Sales Training Agency |
| 93 | 6.3.2.2 LMR to review content | 3 | days | Wed Jan. 18, 2012 | Mon Jan. 23, 2012 | 92 | Sales Training Agency |
| 94 | 6.3.2.3 Agency to incorporate feedback from content | 5 | days | Mon Jan. 23, 2012 | Mon Jan. 30, 2012 | 93 | Sales Training Agency |
| 95 | 6.3.2.4 LMR to review final content | 2 | days | Mon Jan. 30, 2012 | Wed Feb. 1, 2012 | 94 | Sales Training Agency |
| 96 | 6.3.2.5 Agency to make any final edits based on final | 1 | day | Wed Feb. 1, 2012 | Thu Feb. 2, 2012 | 95 | Sales Training Agency |
| 97 | 6.3.2.6 LMR to approve content | 5 | days | Thu Feb. 2, 2012 | Thu Feb. 9, 2012 | 96 | Sales Training Agency |
| 98 | 6.4 Training Documents Production (Home Study) | 28 | days | Thu Feb. 2, 2012 | Tue Mar. 13, 2012 | | |
| 99 | 6.4.1 Module 1 | 24 | days | Thu Feb. 2, 2012 | Wed Mar. 7, 2012 | | |
| 100 | 6.4.1.1 Graphics and programming | 6 | days | Thu Feb. 2, 2012 | Fri Feb. 10, 2012 | 90 | Sales Training Agency |
| 101 | 6.4.1.2 LMR to review online course | 5 | days | Fri Feb. 10, 2012 | Fri Feb. 17, 2012 | 100 | Sales Training Agency |
| 102 | 6.4.1.3 Agency to make edits based on client review | 1 | day | Fri Feb. 17, 2012 | Mon Feb. 20, 2012 | 101 | Sales Training Agency |
| 103 | 6.4.1.4 LMR to review online course | 5 | days | Mon Feb. 20, 2012 | Mon Feb. 27, 2012 | 102 | Sales Training Agency |
| 104 | 6.4.1.5 Agency to make final changes | 1 | day | Mon Feb. 27, 2012 | Tue Feb. 28, 2012 | 103 | Sales Training Agency |
| 105 | 6.4.1.6 LMR to approve course | 5 | days | Tue Feb. 28, 2012 | Tue Mar. 6, 2012 | 104 | Sales Training Agency |
| 106 | 6.4.1.7 Agency to send files to client | 1 | day | Tue Mar. 6, 2012 | Wed Mar. 7, 2012 | 105 | Sales Training Agency |
| 107 | 6.4.2 Module 2 | 23 | days | Thu Feb. 9, 2012 | Tue Mar. 13, 2012 | | |
| 108 | 6.4.2.1 Photo shoot and audio recording | 2 | days | Thu Feb. 9, 2012 | Mon Feb. 13, 2012 | 97 | Sales Training Agency |
| 109 | 6.4.2.2 Graphics and programming | 11 | days | Mon Feb. 13, 2012 | Tue Feb. 28, 2012 | 108 | Sales Training Agency |
| 110 | 6.4.2.3 LMR to review online course | 3 | days | Tue Feb. 28, 2012 | Fri Mar. 2, 2012 | 109 | Sales Training Agency |
| 111 | 6.4.2.4 Agency to make edits based on client review | 2 | days | Fri Mar. 2, 2012 | Tue Mar. 6, 2012 | 110 | Sales Training Agency |
| 112 | 6.4.2.5 LMR to review online course | 2 | days | Tue Mar. 6, 2012 | Thu Mar. 8, 2012 | 111 | Sales Training Agency |
| 113 | 6.4.2.6 Agency to make final changes | 1 | day | Thu Mar. 8, 2012 | Fri Mar. 9, 2012 | 112 | Sales Training Agency |
| 114 | 6.4.2.7 LMR to approve course | 1 | day | Fri Mar. 9, 2012 | Mon Mar. 12, 2012 | 113 | Sales Training Agency |
| 115 | 6.4.2.8 Agency to send files to client | 1 | day | Mon Mar. 12, 2012 | Tue Mar. 13, 2012 | 114 | Sales Training Agency |
| 116 | 6.5 Training Materials Graphics (Home Study) | 24 | days | Thu Feb. 9, 2012 | Wed Mar. 14, 2012 | | |
| 117 | 6.5.1 Interface concepts for review | 7 | days | Thu Feb. 9, 2012 | Mon Feb. 20, 2012 | 97 | Sales Training Agency |
| 118 | 6.5.2 Sales Training to review concepts/conference call | 5 | days | Mon Feb. 20, 2012 | Mon Feb. 27, 2012 | 117 | Sales Training Agency |
| 119 | 6.5.3 Agency to make final changes | 2 | days | Mon Feb. 27, 2012 | Wed Feb. 29, 2012 | 118 | Sales Training Agency |
| 120 | 6.5.4 Forward to LMR for approval | 5 | days | Wed Feb. 29, 2012 | Wed Mar. 7, 2012 | 119 | Sales Training Agency |
| 121 | 6.5.5 LMR to approve | 5 | days | Wed Mar. 7, 2012 | Wed Mar. 14, 2012 | 120 | Sales Training Agency |
| 122 | 7 Training Document Design for the Launch meeting: Work | 102.5 | days | Wed Jan. 18, 2012 | Fri Jun. 8, 2012 | | |
| 123 | 7.1 Design Document | 69.5 | days | Wed Jan. 18, 2012 | Tue Apr. 24, 2012 | | |
| 124 | 7.1.1 Agency to create Design Document | 20 | days | Wed Jan. 18, 2012 | Wed Feb. 15, 2012 | 92 | Sales Training Agency |
| 125 | 7.1.2 LMR to review Design Document | 5 | days | Wed Feb. 15, 2012 | Wed Feb. 22, 2012 | 124 | Sales Training Agency |
| 126 | 7.1.3 Conference call to review comments | 1 | day | Wed Feb. 22, 2012 | Thu Feb. 23, 2012 | 125 | Sales Training Agency |
| 127 | 7.1.4 Agency to make necessary changes | 10 | days | Wed Apr. 4, 2012 | Tue Apr. 17, 2012 | 2 | Sales Training Agency |
| 128 | 7.1.5 LMR to review and approve | 5 | days | Wed Apr. 18, 2012 | Tue Apr. 24, 2012 | 127 | Sales Training Agency |
| 129 | 7.2 Development of Materials | 33 | days | Wed Apr. 25, 2012 | Fri Jun. 8, 2012 | | |
| 130 | 7.2.1 Agency to develop 1st draft of materials | 8 | days | Wed Apr. 25, 2012 | Fri May 4, 2012 | 128 | Sales Training Agency |
| 131 | 7.2.2 LMR to review materials | 5 | days | Mon May 7, 2012 | Fri May 11, 2012 | 130 | Sales Training Agency |
| 132 | 7.2.3 Agency to make necessary changes and edit/desk | 4 | days | Mon May 14, 2012 | Thu May 17, 2012 | 131 | Sales Training Agency |
| 133 | 7.2.4 LMR to review final material | 5 | days | Fri May 18, 2012 | Thu May 24, 2012 | 132 | Sales Training Agency |
| 134 | 7.2.5 Agency to make final changes | 2 | days | Fri May 25, 2012 | Mon May 28, 2012 | 133 | Sales Training Agency |
| 135 | 7.2.6 LMR to approve materials | 5 | days | Tue May 29, 2012 | Mon Jun. 4, 2012 | 134 | Sales Training Agency |
| 136 | 7.2.7 Production of materials | 4 | days | Tue Jun. 5, 2012 | Fri Jun. 8, 2012 | 135 | Sales Training Agency |
| 137 | 8 Managed Markets Team Training | 231.33 | days | Tue Nov. 22, 2011 | Wed Oct. 10, 2012 | | |
| 138 | 8.1 Develop MM Team Training Curriculum | 16 | days | Tue Nov. 22, 2011 | Wed Dec. 14, 2011 | 71 | Managed Markets Director, |
| 139 | 8.2 Theraputic/Disease State Training | 16 | days | Wed Dec. 14, 2011 | Thu Jan. 5, 2012 | 138 | Managed Markets Director, |
| 140 | 8.3 Chart showing the comparative strengths and [symbol] | 16 | days | Thu Jan. 5, 2012 | Fri Jan. 27, 2012 | 139 | Managed Markets Director, |
| 141 | 8.4 Develop the Clinical Training for Product | 48 | days | Fri Jan. 27, 2012 | Wed Apr. 4, 2012 | 140 | Sales Training Agency |
| 142 | 8.5 MM Team Training on current Product Marketplace [symbol] | 1.33 | days | Wed Apr. 4, 2012 | Thu Apr. 5, 2012 | 141 | Managed Markets Director, |
| 143 | 8.6 Module I: Product Market Analysis AM and/or MSL [symbol] | 22.67 | days | Thu Apr. 5, 2012 | Tue May 8, 2012 | 142 | Managed Markets Director, |
| 144 | 8.7 Module II: Clinical New Product presentation for AM [symbol] | 22.67 | days | Tue May 8, 2012 | Fri Jun. 8, 2012 | 143 | Managed Markets Director, |
| 145 | 8.8 Timeline for completion of launch activities with [symbol] | 40 | days | Fri Jun. 8, 2012 | Fri Aug. 3, 2012 | 144 | Managed Markets Director |
| 146 | 8.9 Tracking mechanism for completion of launch [symbol] | 20 | days | Thu Apr. 5, 2012 | Thu May 3, 2012 | 143SS | Sales Operations, Managed [symbol] |
| 147 | 8.10 Training new Product research and clinical papers | 20 | days | Thu May 3, 2012 | Thu May 31, 2012 | 146 | Managed Markets Director, |
| 148 | 8.11 New Product Positioning in Managed Markets | 10 | days | Thu May 31, 2012 | Thu Jun. 14, 2012 | 147 | Brand Management, Sales [symbol] |
| 149 | 8.12 Training on Brand economics model | 10 | days | Thu Jun. 14, 2012 | Thu Jun. 28, 2012 | 148 | Sales Training Agency |
| 150 | 8.13 Making the clinical and economic case for New [symbol] | 10 | days | Thu Jun. 28, 2012 | Thu Jul. 12, 2012 | 149 | Health Economics Director, [symbol] |
| 151 | 8.14 Training on AMCP Dossier | 2 | wks | Thu Jul. 19, 2012 | Thu Aug. 2, 2012 | 149FS+15 days | Sales Training Agency |
| 152 | 8.15 MM Team Direction Document | 5 | days | Thu Aug. 2, 2012 | Thu Aug. 9, 2012 | 151 | Managed Markets Director, |
| 153 | 8.16 Managed Markets Team Training | 44 | days | Thu Aug. 9, 2012 | Wed Oct. 10, 2012 | | |
| 154 | 8.16.1 Update training material for Post Launch | 2 | days | Thu Aug. 9, 2012 | Mon Aug. 13, 2012 | 152 | Managed Markets Director, |
| 155 | 8.16.2 Managed Markets, workshop training at Team [symbol] | 33 | days | Mon Aug. 13, 2012 | Mon Sep. 24, 2012 | 154 | Managed Markets Director, |
| 156 | 8.16.3 Development of testing instrument | 10 | days | Mon Sep. 24, 2012 | Mon Oct. 8, 2012 | 155 | Managed Markets Director, |
| 157 | 8.16.4 Evaluation Instrument for training at the Team [symbol] | 2 | days | Mon Oct. 8, 2012 | Wed Oct. 10, 2012 | 156 | Managed Markets Director, |
| 158 | 9 POA Meeting Preparation | 199.5 | days | Wed Jun. 1, 2011 | Tue Mar. 6, 2012 | | |
| 159 | 9.1 Site Selection/Evaluation | 29 | days | Wed Jan. 25, 2012 | Tue Mar. 6, 2012 | | |
| 160 | 9.1.1 Notify Meeting Planning of POA 1 and the [symbol] | 1 | day | Wed Jan. 25, 2012 | Thu Jan. 26, 2012 | 81 | Sales Training Agency |
| 161 | 9.1.2 Meeting Planning to Secure Venue/Date w/Hotel | 15 | days | Thu Jan. 26, 2012 | Thu Feb. 16, 2012 | 160 | Sales Training Agency |
| 162 | 9.1.3 Hotel Contract- Draft | 6 | days | Thu Feb. 16, 2012 | Fri Feb. 24, 2012 | 161 | Sales Training Agency |
| 163 | 9.1.4 Hotel Contract- Legal Review | 6 | days | Fri Feb. 24, 2012 | Mon Mar. 5, 2012 | 162 | Sales Training Agency |
| 164 | 9.1.5 Hotel Contract- Finalize | 1 | day | Mon Mar. 5, 2012 | Tue Mar. 6, 2012 | 163 | Sales Training Agency |
| 165 | 9.2 Monthly Planing Meetings | 0 | days | Wed Jun. 1, 2011 | Wed Jun. 1, 2011 | | Sales Training Agency |
| 166 | 9.3 POA Meeting Documents and Materials Preparation | 22 | days | Wed Jan. 25, 2012 | Fri Feb. 24, 2012 | | |
| 167 | 9.3.1 Complete/Submit Meeting Request Form to Meet | 4 | days | Wed Jan. 25, 2012 | Tue Jan. 31, 2012 | 160SS | Sales Training Agency[25%] |
| 168 | 9.3.2 Objectives & Agenda- Prepare Drafts | 5 | days | Tue Jan. 31, 2012 | Tue Feb. 7, 2012 | 167 | Sales Training Agency[20%] |
| 169 | 9.3.3 Objectives & Agenda- Review/comment Drafts | 3 | days | Tue Feb. 7, 2012 | Fri Feb. 10, 2012 | 168 | Sales Training Agency[33%] |
| 170 | 9.3.4 Objectives & Agenda- Revise Drafts | 3 | days | Fri Feb. 10, 2012 | Wed Feb. 15, 2012 | 169 | Sales Training Agency[33%] |
| 171 | 9.3.5 Objectives & Agenda- Legal Review of Revised [symbol] | 5 | days | Wed Feb. 15, 2012 | Wed Feb. 22, 2012 | 170 | Sales Training Agency[20%] |
| 172 | 9.3.6 Objectives & Agenda- Finalize | 2 | days | Wed Feb. 22, 2012 | Fri Feb. 24, 2012 | 171 | Sales Training Agency |
| 173 | 10 Sates Force Training | 73.25 | days | Fri Feb. 24, 2012 | Wed Jun. 6, 2012 | 172 | |
| 174 | 10.1 Pre POA 1 Preparation | 73.25 | days | Fri Feb. 24, 2012 | Wed Jun. 6, 2012 | | |
| 175 | 10.1.1 Present concept for training program | 3 | days | Fri Feb. 24, 2012 | Wed Feb. 29, 2012 | | Sales Training |
| 176 | 10.1.2 Finalize training requirements for POA | 10 | days | Wed Feb. 29, 2012 | Wed Mar. 14, 2012 | 175 | Sales Training |
| 177 | 10.1.3 Select vendor for actual training development | 20 | days | Wed Mar. 28, 2012 | Wed Apr. 25, 2012 | 176, 178 | Sales Training |
| 178 | 10.1.4 Identify training methodologies, materials to be | 10 | days | Wed Mar. 14, 2012 | Wed Mar. 28, 2012 | 176 | Sales Training |
| 179 | 10.1.5 Review and revise as needed the draft materials | 20 | days | Wed Apr. 25, 2012 | Wed May 23, 2012 | 177, 178 | Sales Training |
| 180 | 10.1.6 Approve and finalize training materials and [symbol] | 5 | days | Wed May 23, 2012 | Wed May 30, 2012 | 179 | Sales Training |
| 181 | 10.1.7 Identify, select and train facilitators | 5 | days | Wed May 23, 2012 | Wed May 30, 2012 | 179 | Sales Training |
| 182 | 10.1.8 Schedule workshops and events | 5 | days | Wed May 23, 2012 | Wed May 30, 2012 | 180SS | Sales Training |
| 183 | 10.1.9 Produce and distribute draft POA meeting mate | 1 | day | Wed May 30, 2012 | Thu May 31, 2012 | 182 | Sales Training |
| 184 | 10.1.10 Present training program to Executives | 1 | day | Thu May 31, 2012 | Fri Jun. 1, 2012 | 183 | Sales Training |
| 185 | 10.1.11 Prepare Presentation Materials for LMR [symbol] | 1 | day | Fri Jun. 1, 2012 | Mon Jun. 4, 2012 | 184 | Sales Training Agency |
| 186 | 10.1.12 Submit draft materials for review and approval | 1 | day | Mon Jun. 4, 2012 | Tue Jun. 5, 2012 | 185 | Sales Training Agency |
| 187 | 10.1.13 Submit all approved presentation materials for | 1 | day | Tue Jun. 5, 2012 | Wed Jun. 6, 2012 | 186 | Sales Training Agency |
| 188 | 10.1.14 Complete presentation | 0.25 | days | Wed Jun. 6, 2012 | Wed Jun. 6, 2012 | 187 | Sales Director, Training [symbol] |
| 189 | 10.1.15 Preliminary workshop content walk through | 1 | day | Fri Feb. 24, 2012 | Mon Feb. 27, 2012 | | Medical Education Director, |
| 190 | 10.1.16 Workshop dry runs | 1 | day | Mon Feb. 27, 2012 | Tue Feb. 28, 2012 | 189 | Sales Director/Training [symbol] |
| 191 | 10.1.17 Provide POA 1 workshop content to Production | 1.67 | days | Tue Feb. 28, 2012 | Thu Mar. 1, 2012 | 190 | Sales Director/Training [symbol] |
| 192 | 10.1.18 Provide POA 1 workshop materials to Executive | 2.5 | days | Thu Mar. 1, 2012 | Mon Mar. 5, 2012 | 191 | Sales Training Agency |
| 193 | 10.1.19 Print and ship approved materials | 5 | days | Mon Mar. 5, 2012 | Mon Mar. 12, 2012 | 192 | Sales Training Agency |
| 194 | 10.1.20 Workshop run through | 1.25 | days | Mon Mar. 12, 2012 | Tue Mar. 13, 2012 | 193 | Production Agency |
| 195 | 10.1.21 Workshop rehearsals | 1.25 | days | Tue Mar. 13, 2012 | Thu Mar. 15, 2012 | 194 | Production Agency |
| 186 | 11 Managers Meeting-Regional Directors and District [symbol] | 1 | day | Tue Mar. 6, 2012 | Wed Mar. 7, 2012 | 164 | Sales Director |
| 197 | 12 POA 1 Meeting is conducted. | 0.5 | days | Wed Mar. 21, 2012 | Wed Mar. 21, 2012 | 196FS+2 wks | Production Agency, Sales [symbol] |
| 198 | 13 Launch Meeting Preparation | 95.77 | days | Wed Feb. 15, 2012 | Thu Jun. 28, 2012 | | |
| 199 | 13.1 Site Selection/Evaluation | 37 | days | Tue Mar. 6, 2012 | Thu Apr. 26, 2012 | | |
| 200 | 13.1.1 Notify Meeting Planning of Launch and the [symbol] | 1 | day | Tue Mar. 6, 2012 | Wed Mar. 7, 2012 | 164 | Sales Training Agency |
| 201 | 13.1.2 Meeting Planning to Secure Venue/Date w/ [symbol] | 23 | days | Wed Mar. 7, 2012 | Mon Apr. 9, 2012 | 200 | Sales Training Agency |
| 202 | 13.1.3 Hotel Contract- Draft | 6 | days | Mon Apr. 9, 2012 | Tue Apr. 17, 2012 | 201 | Sales Training Agency |
| 203 | 13.1.4 Hotel Contract- Legal Review | 6 | days | Tue Apr. 17, 2012 | Wed Apr. 25, 2012 | 202 | Sales Training Agency |
| 204 | 13.1.5 Hotel Contract- Finalize | 1 | day | Wed Apr. 25, 2012 | Thu Apr. 26, 2012 | 203 | Sales Training Agency |
| 205 | 13.2 Monthly Planing Meetings | 1 | day | Wed Feb. 15, 2012 | Thu Feb. 16, 2012 | 124 | Sales Training Agency |
| 206 | 13.3 Launch Meeting Documents and Materials [symbol] | 22 | days | Wed Mar. 7, 2012 | Fri Apr. 6, 2012 | | |
| 207 | 13.3.1 Complete/Submit Meeting Request Form to [symbol] | 4 | days | Wed Mar. 7, 2012 | Tue Mar. 13, 2012 | 200 | Sales Training Agency[25%] |
| 208 | 13.3.2 Objectives & Agenda- Prepare Drafts | 5 | days | Tue Mar. 13, 2012 | Tue Mar. 20, 2012 | 207 | Sales Training Agency[20%] |
| 209 | 13.3.3 Objectives & Agenda- Review/comment Drafts | 3 | days | Tue Mar. 20, 2012 | Fri Mar. 23, 2012 | 208 | Sales Training Agency[33%] |
| 210 | 13.3.4 Objectives & Agenda- Revise Drafts | 3 | days | Fri Mar. 23, 2012 | Wed Mar. 28, 2012 | 209 | Sales Training Agency[33%] |
| 211 | 13.3.5 Objectives & Agenda- Legal Review of Revised [symbol] | 5 | days | Wed Mar. 28, 2012 | Wed Apr. 4, 2012 | 210 | Sales Training Agency[20%] |
| 212 | 13.3.6 Objectives & Agenda- Finalize | 2 | days | Wed Apr. 4, 2012 | Fri Apr. 6, 2012 | 211 | Sales Training Agency |
| 213 | 13.4 Sales Force Training Workshops | 38.5 | days | Fri Apr. 6, 2012 | Wed May 30, 2012 | | |
| 214 | 13.4.1 Present concept for training program | 1.5 | days | Fri Apr. 6, 2012 | Mon Apr. 9, 2012 | 212 | Sales Director, Sales Training |
| 215 | 13.4.2 Finalize training requirements for Launch [symbol] | 5 | days | Tue Apr. 10, 2012 | Mon Apr. 16, 2012 | 214 | Sales Director, Sales Training |
| 216 | 13.4.3 Select vendor for actual training development | 10 | days | Tue Apr. 17, 2012 | Mon Apr. 30, 2012 | 215 | Sales Director, Sales Training |
| 217 | 13.4.4 Identify training methodologies, materials to be | 5 | days | Tue Apr. 17, 2012 | Mon Apr. 23, 2012 | 215 | Sales Director, Sales Training |
| 218 | 13.4.5 Review and revise as needed the draft materials | 7.5 | days | Tue Apr. 24, 2012 | Thu May 3, 2012 | 217 | Sales Director, Sales Training |
| 219 | 13.4.6 Approve and finalize training materials and [symbol] | 2.5 | days | Thu May 3, 2012 | Mon May 7, 2012 | 218 | Sales Director, Sales Training |
| 220 | 13.4.7 Identify, select and train facilitators | 2.5 | days | Thu May 3, 2012 | Mon May 7, 2012 | 218 | Sales Director, Sales Training |
| 221 | 13.4.8 Schedule workshops and events | 2.5 | days | Thu May 3, 2012 | Mon May 7, 2012 | 219SS | Sales Director, Sales Training |
| 222 | 13.4.9 Produce and distribute draft Launch meeting [symbol] | 2 | days | Tue May 8, 2012 | Wed May 9, 2012 | 221 | Sales Director, Sales Training |
| 223 | 13.4.10 Present training program to Executives | 2.5 | days | Thu May 10, 2012 | Mon May 14, 2012 | 222 | Sales Director, Sales Training |
| 224 | 13.4.11 Prepare Presentation Materials for LMR [symbol] | 3 | days | Thu May 10, 2012 | Mon May 14, 2012 | 222 | Sales Training Agency |
| 225 | 13.4.12 Submit draft materials for review and approval | 1 | day | Tue May 15, 2012 | Tue May 15, 2012 | 224 | Sales Training Agency |
| 226 | 13.4.13 LMR Review and Approval | 5 | days | Wed May 16, 2012 | Tue May 22, 2012 | 225 | Sales Training Agency |
| 227 | 13.4.14 Submit all approved presentation materials for | 2 | days | Wed May 23, 2012 | Thu May 24, 2012 | 226 | Sales Training Agency |
| 228 | 13.4.15 Complete presentation | 4 | days | Fri May 25, 2012 | Wed May 30, 2012 | 204, 227 | Sales Training Agency |
| 229 | 13.5 Final Launch Meeting Preparation | 24.27 | days | Fri May 25, 2012 | Thu Jun. 28, 2012 | | |
| 230 | 13.5.1 Preliminary workshop content walk through | 1 6 | days | Thu May 31, 2012 | Fri Jun. 1, 2012 | 228 | Medical Education Director, |
| 231 | 13.5.2 Provide Launch workshop content to Production | 6.67 | days | Fri Jun. 1, 2012 | Tue Jun. 12, 2012 | 230 | Sales Director, Sales Training |
| 232 | 13.5.3 Provide Launch Meeting workshop materials to [symbol] | 12 | days | Tue Jun. 12, 2012 | Thu Jun. 28, 2012 | 231 | Sales Director |
| 233 | 13.5.4 Print and ship approved materials | 6 | days | Fri May 25, 2012 | Fri Jun. 1, 2012 | 227 | Sales Training Agency |
| 234 | 13.5.5 Workshop run through at meeting site | 2 | days | Mon Jun. 4, 2012 | Tue Jun. 5, 2012 | 233 | Production Agency |
| 235 | 13.5.6 Workshop rehearsals at meeting site | 8 | days | Mon Jun. 4, 2012 | Wed Jun. 13, 2012 | 233 | Production Agency |
| 236 | 14 Managers Meeting-Regional Directors and District [symbol] | 1 | day | Thu Jun. 28, 2012 | Fri Jun. 29, 2012 | 232 | Sales Director |
| 237 | 15 Launch Meeting is conducted. | 2 | days | Tue Jul. 10, 2012 | Thu Jul. 12, 2012 | 236FS+1.35 wks | Brand Management, [symbol] |

[symbol]

indicates data missing or illegible when filed

TABLE 7
SUPPLY CHAIN PERSPECTIVE

| ID | Task Name | Duration | | Start | Finish | Predecessors | Resource Names |
|---|---|---|---|---|---|---|---|
| 0 | Supply Chain | 395.27 | days | Wed Jun. 1, 2011 | Wed Dec. 5, 2012 | | |
| 1 | Supply Forecast | 3 | days | Wed Jun. 1, 2011 | Fri Jun. 3, 2011 | | |
| 2 | Customer Allocations/Quantities | 3 | days | Wed Jun. 1, 2011 | Fri Jun. 3, 2011 | | |
| 3 | Survey Key Retail Customers for an estimate of [symbol] | 1 | day | Wed Jun. 1, 2011 | Wed Jun. 1, 2011 | | Distribution |
| 4 | Identify and recommend package configuration [symbol] | 1 | day | Thu Jun. 2, 2011 | Thu Jun. 2, 2011 | 3 | Distribution |
| 5 | Develop package configuration | 1 | day | Fri Jun. 3, 2011 | Fri Jun. 3, 2011 | 4 | Distribution |
| 6 | Packaging | 392.27 | days | Mon Jun. 6, 2011 | Wed Dec. 5, 2012 | | |
| 7 | Samples arrival at Manufacturing/Packaging Facility | 45.94 | days | Mon Jun. 6, 2011 | Mon Aug. 8, 2011 | 5 | Manufacturing |
| 8 | Ordering Test Components | 100 | days | Mon Jun. 6, 2011 | Fri Oct. 21, 2011 | | |
| 9 | Test Cartons Ordered | 12 | days | Mon Jun. 6, 2011 | Tue Jun. 21, 2011 | 5 | Manufacturing |
| 10 | Test Cartons Arrival | 36 | days | Wed Jun. 22, 2011 | Wed Aug. 10, 2011 | 9 | Manufacturing |
| 11 | QC Release Test Carton | 5 | days | Thu Aug. 11, 2011 | Wed Aug. 17, 2011 | 10 | Manufacturing |
| 12 | Test Inserts Ordered | 18 | days | Thu Aug. 18, 2011 | Mon Sep. 12, 2011 | 11 | Manufacturing |
| 13 | Test Inserts Arrival | 26 | days | Tue Sep. 13, 2011 | Tue Oct. 18, 2011 | 12 | Manufacturing |
| 14 | QC Release Test Inserts | 3 | days | Wed Oct. 19, 2011 | Fri Oct. 21, 2011 | 13 | Manufacturing |
| 15 | Equipment Adjusted (Including Level, rails, gaps, [symbol] | 41 | days | Mon Oct. 24, 2011 | Mon Dec. 19, 2011 | 14 | Manufacturing |
| 16 | IQ Execution Completed | 26 | days | Tue Dec. 20, 2011 | Tue Jan. 24, 2012 | 15 | Manufacturing |
| 17 | IQ Report | 1 | day | Wed Jan. 25, 2012 | Wed Jan. 25, 2012 | 16 | Manufacturing |
| 18 | DMT 2006-010, MA350 Execution | 0.33 | days | Thu Jan. 26, 2012 | Thu Jan. 26, 2012 | 17 | Manufacturing |
| 19 | Write DMT 2006-010 Summary Report | 1 | day | Thu Jan. 26, 2012 | Fri Jan. 27, 2012 | 18 | Manufacturing |
| 20 | Draft Updated SOP for Cartoner | 1 | day | Fri Jan. 27, 2012 | Mon Jan. 30, 2012 | 19 | Manufacturing |
| 21 | Approval of the Updated SOP for Cartoner | 1 | day | Mon Jan. 30, 2012 | Tue Jan. 31, 2012 | 20 | Manufacturing |
| 22 | Train and document effective for SOP Cartoner | 14 | days | Tue Jan. 31, 2012 | Mon Feb. 20, 2012 | 21 | Manufacturing |
| 23 | Update SOP | 14 | days | Mon Feb. 20, 2012 | Fri Mar. 9, 2012 | 22 | Manufacturing |
| 24 | Train and Document effective SOP | 1 | day | Fri Mar. 9, 2012 | Mon Mar. 12, 2012 | 23 | Manufacturing |
| 25 | PQ for Cartoner, Authorized and Effective | 47.94 | days | Mon Mar. 12, 2012 | Thu May 17, 2012 | 24 | Manufacturing |
| 26 | Cartoner ready for inspection | 0 | days | Thu May 17, 2012 | Thu May 17, 2012 | 25 | Manufacturing |
| 27 | Write DMT for BA300 & approved | 4 | days | Thu May 17, 2012 | Wed May 23, 2012 | 26 | Manufacturing |
| 28 | Execute DMT for BA300 | 4 | days | Wed May 23, 2012 | Tue May 29, 2012 | 27 | Manufacturing |
| 29 | DMT report for the BA300 | 1 | day | Tue May 29, 2012 | Wed May 30, 2012 | 28 | Manufacturing |
| 30 | Submit change control for approval | 1 | day | Wed May 30, 2012 | Thu May 31, 2012 | 29 | Manufacturing |
| 31 | Draft Updated SOP for BA300 Cartoner | 4 | days | Thu May 31, 2012 | Wed Jun. 6, 2012 | 30 | Manufacturing |
| 32 | Train and document effective for SOP BA300 [symbol] | 1 | day | Wed Jun. 6, 2012 | Thu Jun. 7, 2012 | 31 | Manufacturing |
| 33 | FDA Approval of the Updated SOP for BA300 [symbol] | 0 | days | Thu Jun. 7, 2012 | Thu Jun. 7, 2012 | 32 | Manufacturing |
| 34 | Packing on mainline #1 | 28 | days | Thu Jun. 7, 2012 | Tue Jul. 17, 2012 | | |
| 35 | Change control and risk assessment approval | 1 | day | Thu Jun. 7, 2012 | Fri Jun. 8, 2012 | 33 | Manufacturing |
| 36 | Qualification of Line #1 (TSD) | 21 | days | Thu Jun. 7, 2012 | Fri Jul. 6, 2012 | | |
| 37 | DMT engineering study | 4 | days | Thu Jun. 7, 2012 | Wed Jun. 13, 2012 | 33 | Manufacturing |
| 38 | Draft SOP for Tablet Filler (Pkg Maintenance [symbol] | 0.8 | wks | Wed Jun. 13, 2012 | Tue Jun. 19, 2012 | 37 | Manufacturing |
| 39 | Approval & Authorization of the SOP for Tablet | 1 | wk | Tue Jun. 19, 2012 | Tue Jun. 26, 2012 | 38 | Manufacturing |
| 40 | Train and document effective for SOP Tablet [symbol] | 1 | wk | Tue Jun. 26, 2012 | Tue Jul. 3, 2012 | 39 | Manufacturing |
| 41 | Protocol addendum IOQ: Tablet Filler, [symbol] | 2 | days | Tue Jul. 3, 2012 | Thu Jul. 5, 2012 | 40 | Manufacturing |
| 42 | Protocol IQ HEPA Vacuum, Approved and [symbol] | 0 | days | Thu Jul. 5, 2012 | Thu Jul. 5, 2012 | 41 | Manufacturing |
| 43 | Execution complete | 0 | days | Thu Jul. 5, 2012 | Thu Jul. 5, 2012 | 42 | Manufacturing |
| 44 | Addendum OQ Qualification Summary Report | 1 | day | Thu Jul. 5, 2012 | Fri Jul. 6, 2012 | 43 | Manufacturing |
| 45 | Quality (AQS) | 7 | days | Fri Jul. 6, 2012 | Tue Jul. 17, 2012 | | |
| 46 | Draft SOP PA-QC 3010 Update | 0.8 | wks | Fri Jul. 6, 2012 | Thu Jul. 12, 2012 | 44 | Manufacturing |
| 47 | Approve & Authorize - SOP PA-QC 3010 [symbol] | 0 | days | Thu Jul. 12, 2012 | Thu Jul. 12, 2012 | 46 | Manufacturing |
| 48 | Train and document effective SOP PA-QC 3010 | 1 | day | Thu Jul. 12, 2012 | Fri Jul. 13, 2012 | 47 | Manufacturing |
| 49 | Update Incoming procedure for New Product | 1 | day | Fri Jul. 13, 2012 | Mon Jul. 16, 2012 | 48 | Manufacturing |
| 50 | Product production complete to produce extra | 1 | day | Mon Jul. 16, 2012 | Tue Jul. 17, 2012 | 49 | Manufacturing |
| 51 | Draft PQ Line 1 (TSD) | 101 | days | Tue Jul. 17, 2012 | Wed Dec. 5, 2012 | | |
| 52 | Packaging of Stability Samples for Process [symbol] | 64 | days | Tue Jul. 17, 2012 | Mon Oct. 15, 2012 | 50 | Manufacturing |
| 53 | PQ authorized and effective | 0 | days | Mon Oct. 15, 2012 | Mon Oct. 15, 2012 | 52 | Manufacturing |
| 54 | PQ Execution | 36 | days | Mon Oct. 15, 2012 | Tue Dec. 4, 2012 | 53 | Manufacturing |
| 55 | Plant approval per FDA | 1 | day | Tue Dec. 4, 2012 | Wed Dec. 5, 2012 | 54 | Manufacturing |
| 56 | Initial Trade product packaging runs | 267.25 | days | Wed Jun. 1, 2011 | Fri Jun. 8, 2012 | | |
| 57 | Drug listing complete for importation, including [symbol] | 10 | days | Mon Apr. 9, 2012 | Fri Apr. 20, 2012 | 1FS+11 mons | Supply Chain |
| 58 | Order package inserts and labels for production run | 1 | day | Mon Apr. 23, 2012 | Mon Apr. 23, 2012 | 57 | Supply Chain |
| 59 | Receive package Inserts and labeling for [symbol] | 19 | days | Mon Apr. 23, 2012 | Fri May 18, 2012 | | |
| 60 | Stability bottling | 19 | days | Mon Apr. 23, 2012 | Fri May 18, 2012 | | |
| 61 | Dispatch of product from each validation [symbol] | 0 | days | Mon Apr. 23, 2012 | Mon Apr. 23, 2012 | 58 | Supply Chain |
| 62 | Importation & FDA release | 15 | days | Tue Apr. 24, 2012 | Mon May 14, 2012 | 61 | Supply Chain |
| 63 | Packaging Facility QC release | 4 | days | Tue May 15, 2012 | Fri May 18, 2012 | 62 | Supply Chain |
| 64 | Batch D | 20.25 | days | Mon Apr. 9, 2012 | Mon May 7, 2012 | | |
| 65 | Complete initial product shipment from factory | 0 | days | Mon Apr. 9, 2012 | Mon Apr. 9, 2012 | 57SS | Supply Chain |
| 66 | Import (incl FDA release) | 15 | days | Mon Apr. 9, 2012 | Fri Apr. 27, 2012 | 65 | Supply Chain |
| 67 | QC release | 1 | day | Mon Apr. 30, 2012 | Mon Apr. 30, 2012 | 66 | Supply Chain |
| 68 | Work order scheduling/kitting/release to floor | 1 | day | Tue May 1, 2012 | Tue May 1, 2012 | 67 | Supply Chain |
| 69 | Initial full production run | 0.25 | days | Wed May 2, 2012 | Wed May 2, 2012 | 68 | Supply Chain |
| 70 | QA release | 3 | days | Wed May 2, 2012 | Mon May 7, 2012 | 69 | Supply Chain |
| 71 | First lot for distribution | 0 | days | Mon May 7, 2012 | Mon May 7, 2012 | 70 | Supply Chain |
| 72 | Initial bulk manufacture | 267.25 | days | Wed Jun. 1, 2011 | Fri Jun. 8, 2012 | | |
| 73 | Batch G | 24 | days | Mon May 7, 2012 | Fri Jun. 8, 2012 | | |
| 74 | Prepare shipment of Initial order from factory | 0 | days | Mon May 7, 2012 | Mon May 7, 2012 | 70 | Supply Chain |
| 75 | Import (incl FDA release) | 15 | days | Mon May 7, 2012 | Mon May 28, 2012 | 74 | Supply Chain |
| 76 | QC release | 3 | days | Mon May 28, 2012 | Thu May 31, 2012 | 75 | Supply Chain |
| 77 | Work order scheduling/kitting/release to floor | 2 | days | Thu May 31, 2012 | Mon Jun. 4, 2012 | 76 | Supply Chain |
| 78 | Second full production run | 1 | day | Mon Jun. 4, 2012 | Tue Jun. 5, 2012 | 77 | Supply Chain |
| 79 | QA release | 3 | days | Tue Jun. 5, 2012 | Fri Jun. 8, 2012 | 78 | Supply Chain |
| 80 | Release for distribution | 0 | days | Fri Jun. 8, 2012 | Fri Jun. 8, 2012 | 79 | Supply Chain |
| 81 | Batch B | 24 | days | Wed Jun. 1, 2011 | Mon Jul. 4, 2011 | | |
| 82 | Prepare shipment of initial order from factory | 0 | days | Wed Jun. 1, 2011 | Wed Jun. 1, 2011 | | Supply Chain |
| 83 | Import (incl FDA release) | 15 | days | Wed Jun. 1, 2011 | Tue Jun. 21, 2011 | 82 | Supply Chain |
| 84 | QC release | 3 | days | Wed Jun. 22, 2011 | Fri Jun. 24, 2011 | 83 | Supply Chain |
| 85 | Work order scheduling/kitting/release to floor | 2 | days | Mon Jun. 27, 2011 | Tue Jun. 28, 2011 | 84 | Supply Chain |
| 86 | Second full production run | 1 | day | Wed Jun. 29, 2011 | Wed Jun. 29, 2011 | 85 | Supply Chain |
| 87 | QA release | 3 | days | Thu Jun. 30, 2011 | Mon Jul. 4, 2011 | 86 | Supply Chain |
| 88 | Release for distribution | 0 | days | Mon Jul. 4, 2011 | Mon Jul. 4, 2011 | 87 | Supply Chain |
| 89 | Next bulk manufacture | 24 | days | Wed Jun. 1, 2011 | Mon Jul. 4, 2011 | | |
| 90 | Prepare shipment of initial order from factory | 0 | days | Wed Jun. 1, 2011 | Wed Jun. 1, 2011 | | Supply Chain |
| 91 | Import (incl FDA release) | 15 | days | Wed Jun. 1, 2011 | Tue Jun. 21, 2011 | 90 | Supply Chain |
| 92 | QC release | 3 | days | Wed Jun. 22, 2011 | Fri Jun. 24, 2011 | 91 | Supply Chain |
| 93 | Work order scheduling/kitting/release to floor | 2 | days | Mon Jun. 27, 2011 | Tue Jun. 28, 2011 | 92 | Supply Chain |
| 94 | Second full production run | 1 | day | Wed Jun. 29, 2011 | Wed Jun. 29, 2011 | 93 | Supply Chain |
| 95 | QA release | 3 | days | Thu Jun. 30, 2011 | Mon Jul. 4, 2011 | 94 | Supply Chain |
| 96 | Release for distribution | 0 | days | Mon Jul. 4, 2011 | Mon Jul. 4, 2011 | 95 | Supply Chain |
| 97 | Sample Packages | 62.5 | days | Wed Jun. 1, 2011 | Fri Aug. 26, 2011 | | |
| 98 | Batch C | 30.5 | days | Wed Jun. 1, 2011 | Wed Jul. 13, 2011 | | |
| 99 | Start samples batch G | 0 | days | Wed Jun. 1, 2011 | Wed Jun. 1, 2011 | | Supply Chain |
| 100 | Factory release and prepare shipment | 5 | days | Wed Jun. 1, 2011 | Tue Jun. 7, 2011 | 99 | Supply Chain |
| 101 | Import (incl FDA release) | 15 | days | Wed Jun. 8, 2011 | Tue Jun. 28, 2011 | 100 | Supply Chain |
| 102 | QC release | 3 | days | Wed Jun. 29, 2011 | Fri Jul. 1, 2011 | 101 | Supply Chain |
| 103 | Work order scheduling/kitting/release to floor | 2 | days | Mon Jul. 4, 2011 | Tue Jul. 5, 2011 | 102 | Supply Chain |
| 104 | Carton | 2.5 | days | Wed Jul. 6, 2011 | Fri Jul. 8, 2011 | 103 | Supply Chain |
| 105 | QA release | 3 | days | Fri Jul. 8, 2011 | Wed Jul. 13, 2011 | 104 | Supply Chain |
| 106 | Release for distribution | 0 | days | Wed Jul. 13, 2011 | Wed Jul. 13, 2011 | 105 | Supply Chain |
| 107 | Batch D | 32 | days | Wed Jul. 13, 2011 | Fri Aug. 26, 2011 | | |
| 108 | Start samples batch H | 0 | days | Wed Jul. 13, 2011 | Wed Jul. 13, 2011 | 106 | Supply Chain |
| 109 | Factory release and prepare shipment | 10 | days | Wed Jul. 13, 2011 | Wed Jul. 27, 2011 | 108 | Supply Chain |
| 110 | Import (incl FDA release) | 15 | days | Wed Jul. 27, 2011 | Wed Aug. 17, 2011 | 109 | Supply Chain |
| 111 | QC release | 1 | day | Wed Aug. 17, 2011 | Thu Aug. 18, 2011 | 110 | Supply Chain |
| 112 | Work order scheduling/kitting/release to floor | 1 | day | Thu Aug. 18, 2011 | Fri Aug. 19, 2011 | 111 | Supply Chain |
| 113 | Carton | 2 | days | Fri Aug. 19, 2011 | Tue Aug. 23, 2011 | 112 | Supply Chain |
| 114 | QA release | 3 | days | Tue Aug. 23, 2011 | Fri Aug. 26, 2011 | 113 | Supply Chain |
| 115 | Release samples | 0 | days | Fri Aug. 26, 2011 | Fri Aug. 26, 2011 | 114 | Supply Chain |
| 116 | Validation batches for commercial use | 113.5 | days | Wed Jun. 1, 2011 | Mon Nov. 7, 2011 | | |
| 117 | Batch 1 | 6 | days | Wed Jun. 1, 2011 | Wed Jun. 8, 2011 | | |
| 118 | Factory complete shipment of zero bulk tabs | 0 | days | Wed Jun. 1, 2011 | Wed Jun. 1, 2011 | | Supply Chain |
| 119 | Import (incl FDA release) | 1 | day | Wed Jun. 1, 2011 | Wed Jun. 1, 2011 | 118 | Supply Chain |
| 120 | QC release | 1 | day | Thu Jun. 2, 2011 | Thu Jun. 2, 2011 | 119 | Supply Chain |
| 121 | Work order scheduling/kitting/release to floor | 1 | day | Fri Jun. 3, 2011 | Fri Jun. 3, 2011 | 120 | Supply Chain |
| 122 | Bottle packs for September Trade Release | 1 | day | Mon Jun. 6, 2011 | Mon Jun. 6, 2011 | 121 | Supply Chain |
| 123 | QA release | 1 | day | Tue Jun. 7, 2011 | Tue Jun. 7, 2011 | 122 | Supply Chain |
| 124 | Bottles ready for distribution | 1 | day | Wed Jun. 8, 2011 | Wed Jun. 8, 2011 | 123 | Supply Chain |
| 125 | Batch 2 | 43.5 | days | Wed Jun. 8, 2011 | Tue Aug. 9, 2011 | | |
| 126 | Start samples batch A | 0 | days | Wed Jun. 8, 2011 | Wed Jun. 8, 2011 | 124 | Supply Chain |
| 127 | Factory release and prepare shipment | 10 | days | Thu Jun. 9, 2011 | Wed Jun. 22, 2011 | 126 | Supply Chain |
| 128 | Import (incl FDA release) | 15 | days | Thu Jun. 23, 2011 | Wed Jul. 13, 2011 | 127 | Supply Chain |
| 129 | QC release | 3 | days | Thu Jul. 14, 2011 | Mon Jul. 18, 2011 | 128 | Supply Chain |
| 130 | Work order scheduling/kitting/release to floor | 2 | days | Tue Jul. 19, 2011 | Wed Jul. 20, 2011 | 129 | Supply Chain |
| 131 | Carton | 10.5 | days | Thu Jul. 21, 2011 | Thu Aug. 4, 2011 | 130 | Supply Chain |
| 132 | QA release | 3 | days | Thu Aug. 4, 2011 | Tue Aug. 9, 2011 | 131 | Supply Chain |
| 133 | First lot of samples available for distribution | 0 | days | Tue Aug. 9, 2011 | Tue Aug. 9, 2011 | 132 | Supply Chain |
| 134 | Batch 3 | 64 | days | Tue Aug. 9, 2011 | Mon Nov. 7, 2011 | | |
| 135 | Start samples batch B | 0 | days | Tue Aug. 9, 2011 | Tue Aug. 9, 2011 | 133 | Supply Chain |
| 136 | Factory release and prepare shipment | 20 | days | Tue Aug. 9, 2011 | Tue Sep. 6, 2011 | 135 | Supply Chain |
| 137 | Import (incl FDA release) | 20 | days | Tue Sep. 6, 2011 | Tue Oct. 4, 2011 | 136 | Supply Chain |
| 138 | QC release | 3 | days | Tue Oct. 4, 2011 | Fri Oct. 7, 2011 | 137 | Supply Chain |
| 139 | Work order scheduling/kitting/release to floor | 2 | days | Fri Oct. 7, 2011 | Tue Oct. 11, 2011 | 138 | Supply Chain |
| 140 | Carton | 16 | days | Tue Oct. 11, 2011 | Wed Nov. 2, 2011 | 139 | Supply Chain |
| 141 | QA release | 3 | days | Wed Nov. 2, 2011 | Mon Nov. 7, 2011 | 140 | Supply Chain |
| 142 | Second lot of samples available for distribution | 0 | days | Mon Nov. 7, 2011 | Mon Nov. 7, 2011 | 141 | Supply Chain |
| 143 | Customer Presentations for Medical and/or Brand [symbol] | 54.5 | days | Mon Apr. 9, 2012 | Fri Jun. 22, 2012 | | |
| 144 | Develop Direct Customer initial order allocation for | 22 | days | Mon Apr. 9, 2012 | Tue May 8, 2012 | 1FS+11 mons | Distribution |
| 145 | Present Deal Terms to customers and receive order | 16 | days | Wed May 9, 2012 | Wed May 30, 2012 | 144 | Distribution |
| 146 | Develop and present to the customer the stocking [symbol] | 1 | day | Thu May 31, 2012 | Thu May 31, 2012 | 145 | Distribution |
| 147 | Notify all pricing services of launch of New Product | 3 | days | Fri Jun. 1, 2012 | Tue Jun. 5, 2012 | 146 | Distribution |
| 148 | Complete HDMA form for each presentation of [symbol] | 2.5 | wks | Wed Jun. 6, 2012 | Fri Jun. 22, 2012 | 147 | Distribution |
| 149 | Develop documents for the wholesale community | 83 | days | Fri Feb. 24, 2012 | Wed Jun. 20, 2012 | | |
| 150 | Product Fact Sheet | 2.5 | mons | Fri Feb. 24, 2012 | Fri May 4, 2012 | | Distribution |
| 151 | Wholesaler Sell Sheet | 1 | mon | Fri May 4, 2012 | Fri Jun. 1, 2012 | 150 | Distribution |
| 152 | Wholesaler Announcement Letter and Sheet | 1 | day | Fri Jun. 1, 2012 | Mon Jun. 4, 2012 | 151 | Distribution |
| 153 | Develop Wholesaler Communication and Training | 2 | wks | Mon Jun. 4, 20112 | Mon Jun. 18, 2012 | 152 | Distribution |
| 154 | Wholesaler Communication and Training | 2 | days | Mon Jun. 18, 2012 | Wed Jun. 20, 2012 | 153 | Distribution |

[symbol]

indicates data missing or illegible when filed

Example Pharmaceutical Product Commercialization Reports

The following tables (tables 8-12) represent example reports that may be accessible through the reports button 440 of FIG. 4, for example. The example reports may change depending on the specific project activities and timelines.

TABLE 8
LATE TO FINISH REPORT

| | | | % Work | |
|---|---|---|---|---|
| Name | Start | Finish | Complete | Resource Names |
| Formulate launch project sub teams | Wed 6/1/1 [symbol] | Tue 12/27/ [symbol] | 42% | |
| Brand name | Wed 6/1/1 [symbol] | Mon 10/31 [symbol] | 29% | |
| Brand name | Wed 6/1/1 [symbol] | Thu Jun. 2, 2011 | 50% | Brand Management, Agency-Brand Nam [symbol] |
| Brand Name Research | Wed 6/1/1 [symbol] | Wed 6/15/ [symbol] | 50% | Brand Management, Agency-Brand Nam [symbol] |
| Brand Name Development | Wed 6/1/1 [symbol] | Wed 6/15/ [symbol] | 50% | Brand Management, Agency-Brand Nam [symbol] |
| Brand name Testing | Mon 8/15/ [symbol] | Mon 8/29/ [symbol] | 50% | Brand Management, Agency-Brand Nam [symbol] |
| Brand Name Approved for NDA Submi [symbol] | Mon 8/29/ [symbol] | Mon 8/29/ [symbol] | 50% | Brand Management, Executive Manager |
| Brand Logo development | Thu 7/28/1 [symbol] | Tue 12/27/ [symbol] | 75% | |
| Brand Logo development | Thu 7/28/1 [symbol] | Fri Jul. 29, 2011 | 75% | Ad Agency |
| Agency submission | Mon 10/31 [symbol] | Mon 11/14 [symbol] | 75% | Ad Agency |
| Create logo | Mon 11/14 [symbol] | Mon 11/21 [symbol] | 75% | Ad Agency |
| Marketing comments | Mon 11/21 [symbol] | Mon 11/28 [symbol] | 75% | Ad Agency |
| Create Logo | Mon 11/28 [symbol] | Mon 12/5/ [symbol] | 75% | Ad Agency |
| LMR submission for review and appr [symbol] | Mon 12/5/ [symbol] | Tue 12/6/1 [symbol] | 75% | Ad Agency |
| LMR Approval comments | Tue 12/6/1 [symbol] | Wed 12/14 [symbol] | 75% | Ad Agency |
| Final Approval submission | Wed 12/14 [symbol] | Mon 12/19 [symbol] | 75% | Ad Agency |
| Final Approval received | Mon 12/19 [symbol] | Mon 12/26 [symbol] | 75% | Ad Agency |
| Agency Release | Mon 12/26 [symbol] | Tue 12/27/ [symbol] | 75% | Ad Agency |
| Delivery Date for product | Tue 12/27/ [symbol] | Tue 12/27/ [symbol] | 75% | Ad Agency |

[symbol]

indicates data missing or illegible when filed

TABLE 9
LATE TO START REPORT

| Name | Duration | Start | Finish | Resource Names |
|---|---|---|---|---|
| Project Kickoff | 0 days | Wed 6/1/1 [symbol] | Wed 6/1/1 [symbol] | |
| NDA submission | 0 days | Wed 6/1/1 [symbol] | Wed 6/1/1 [symbol] | |
| Product Launch Date | 0 days | Fri Jan. 21, 2011 | Fri Jan. 21, 2011 | |
| Establish Project Team | 0 days | Wed 6/1/1 [symbol] | Wed 6/1/1 [symbol] | Brand Management |
| Formulate launch project sub teams | 149 days? | Wed 6/1/1 [symbol] | Tue 12/27/ [symbol] | |
| Brand name | 108 days? | Wed 6/1/1 [symbol] | Mon 10/31 [symbol] | |
| Brand name | 1 day | Wed | Thu | Brand Management, Agency-Brand |
| | | Jun. 1, 2011 | Jun. 2, 2011 | Name |
| Brand Name Research | 0.5 mons | Wed | Wed | Brand Management, Agency-Brand |
| | | Jun. 1, 2011 | Jun. 15, 2011 | Name |
| Brand Name Development | 0.5 mons | Wed | Wed | Brand Management, Agency-Brand |
| | | Jun. 1, 2011 | Jun. 15, 2011 | Name |
| Brand name Testing | 0.5 mons | Mon | Mon | Brand Management, Agency-Brand |
| | | Aug. 15, 2011 | Aug. 29, 2011 | Name |
| Brand Name Approved for NDA Submission | 0 days? | Mon | Mon | Brand Management, Executive |
| | | Aug. 29, 2011 | Aug. 29, 2011 | Management, Regulatory |
| Brand Name Approval | 9 wks | Mon 8/29/ [symbol] | Mon 10/31 [symbol] | FDA |
| Brand Logo development | 108 days | Thu 7/28/1 [symbol] | Tue 12/27/ [symbol] | |
| Brand Logo development | 1 day | Thu 7/28/1 [symbol] | Fri Jul. 29, 2011 | Ad Agency |
| Data Generation (Marketing) | 533.13 day [symbol] | Fri Jan. 21, 2011 | Wed 2/6/1 [symbol] | |
| Data Generation (Marketing) | 1 day | Thu | Fri | Brand Management, Market |
| | | Jun. 9, 2011 | Jun. 10, 2011 | Research |
| MARKET RESEARCH PROJECTS | 533.13 day [symbol] | Fri Jan. 21, 2011 | Wed 2/6/1 [symbol] | |
| MARKET RESEARCH PROJECTS | 1 day | Fri Jun. 10, 2011 | Mon 6/13/ [symbol] | Brand Management, Medical Direct |
| Segmentation/key drivers Market Research | 115 days | Fri | Thu | Market Research |
| | | Jan. 21, 2011 | Jun. 30, 2011 | |
| Worldwide Strategic Alignment | 679.2 days | Wed 3/9/1 [symbol] | Tue 10/15/ [symbol] | |
| Competitive landscape | 20 days | Wed 3/9/1 [symbol] | Wed 4/6/1 [symbol] | Brand Management |
| Worldwide Strategic Rollout | 0 days | Fri Jan. 21, 2011 | Fri Jan. 21, 2011 | Executive Management |
| Annotated Visual Aid | 893 days | Fri Jan. 21, 2011 | Tue 6/24/1 [symbol] | |
| Agency begins linking concept to Pre DDMAC | 21 days | Fri | Fri | Market Research, Ad Agency |
| vis aid | | Jan. 21, 2011 | Feb. 18, 2011 | |
| Marketing submission | 1 day | Mon 2/21/ [symbol] | Mon 2/21/ [symbol] | Market Research, Ad Agency |
| Marketing comments | 5 days | Fri Jan. 21, 2011 | Thu 1/27/1 [symbol] | Ad Agency |
| LMR Approval Submisison | 2 days | Fri Jan. 28, 2011 | Mon 1/31/ [symbol] | Ad Agency |
| Marketing Approval | 7 days | Tue Feb. 1, 2011 | Wed 2/9/1 [symbol] | Ad Agency |
| Agency refinements | 3 days | Wed 2/16/ [symbol] | Fri Feb. 18, 2011 | Ad Agency |
| Conduct US research | 2 days | Fri Feb. 25, 2011 | Mon 2/28/ [symbol] | Ad Agency |
| US debrief | 1 day | Tue Mar. 1, 2011 | Tue Mar. 1, 2011 | Ad Agency |
| Internal changes and Agency updates to US | 4 days | Fri Mar. 4, 2011 | Wed 3/9/1 [symbol] | Ad Agency |
| LMR Approval Review and approval (2 weeks | 7 days | Mon | Tue | Regulatory, Medical |
| for LMR Approval review and approval) | | Mar. 14, 2011 | Mar. 22, 2011 | Director, Legal, Brand Management |
| Final approvals | 0 days | Tue 3/22/1 [symbol] | Tue 3/22/1 [symbol] | Executive Management |
| Prepare for submission to DDMAC to | 5 days | Wed | Tue | Brand Management, Regulatory |
| Regulatory | | Mar. 23, 2011 | Mar. 29, 2011 | |
| Submission to Regulatory for inclusion in the | 0 days | Wed | Wed | Regulatory, Brand |
| IPC (DDMAC) | | Mar. 30, 2011 | Mar. 30, 2011 | Management, Market Research |
| Receive DDMAC response | 0 days | Wed 6/22/ [symbol] | Wed 6/22/ [symbol] | Regulatory, Brand Management, Ma [symbol] |
| Promotional Convention Panel (8) | 441.5 days | Thu 6/30/1 [symbol] | Fri Mar. 8, 2013 | |
| Pre Market Theraputic | 9 mons | Thu | Wed | Ad Agency, Medical Director |
| Pub/Advertorials/Disease State Publication 1 | | Jun. 30, 2011 | Mar. 7, 2012 | |
| Pre Market Theraputic | 8 mons | Thu | Wed | Ad Agency, Medical Director |
| Pub/Advertorials/Disease State Publication 2 | | Jun. 30, 2011 | Feb. 8, 2012 | |
| US Product Monograph | 204.87 day [symbol] | Wed 8/24/ [symbol] | Tue 6/5/1 [symbol] | |
| Submitted to client | 1 day? | Wed 8/24/ [symbol] | Thu 8/25/1 [symbol] | Ad Agency |
| Comments received from Medical | 13 days | Thu 8/25/1 [symbol] | Tue 9/13/1 [symbol] | Ad Agency, Medical |
| Comments due back from Brand | 3.33 days | Tue 9/13/1 [symbol] | Fri Sep. 16, 2011 | Ad Agency, Medical, Brand Manager |
| Incorporate Brand Comments | 3 days | Fri Sep. 16, 2011 | Wed 9/21/1 [symbol] | Ad Agency, Medical |
| Submit to editorial for review | 1 day? | Wed 9/21/ [symbol] | Thu 9/22/1 [symbol] | Ad Agency, Medical |
| Editorial review complete | 4 days | Thu 9/22/1 [symbol] | Wed 9/28/ [symbol] | Ad Agency, Medical |
| Internal scientific review complete | 6 days | Wed 9/28/ [symbol] | Thu 10/6/1 [symbol] | Medical |
| Brand MOA Animation | 272.87 day [symbol] | Wed 6/1/1 [symbol] | Fri 6/15/1 [symbol] | |
| Agency develops script outline | 23 days | Wed 6/1/1 [symbol] | Mon 7/4/1 [symbol] | Medical Agency |
| Agency submits script outline to client | 5 days | Mon 7/4/1 [symbol] | Mon 7/11/ [symbol] | Medical Agency, Brand Manageme [symbol] |
| Agency receives consolidated comments | 1 day | Mon 7/11/ [symbol] | Tue 7/12/1 [symbol] | Ad Agency |
| Script Development with Storyboards | 222.87 day | Tue 7/12/1 [symbol] | Thu 5/17/1 [symbol] | |
| Agency develops 1st draft script and | 5 days | Tue | Tue | Medical Agency |
| characters | | Jul. 12, 2011 | Jul. 19, 2011 | |
| Agency submits script and characters to | 5 days | Tue | Tue | Medical Agency |
| client | | Jul. 19, 2011 | Jul. 26, 2011 | |
| Agency receives consolidated comments | 5 days | Tue 7/26/1 [symbol] | Tue Aug. 2, 2011 | Medical Agency |
| Conventions and Exhibits | 57 days | Wed 6/1/1 [symbol] | Fri 8/19/1 [symbol] | |
| Conventions and Events Strategy | 10 days | Wed 6/1/1 [symbol] | Wed 6/15/ [symbol] | |
| Develop convention schedule | 10 days | Wed 6/1/1 [symbol] | Wed 6/15/ [symbol] | |
| Convention 1 | 2 wks | Wed 6/1/1 [symbol] | Wed 6/15/ [symbol] | Ad Agency, Brand Management, Co [symbol] |
| Convention 2 | 2 wks | Wed 6/1/1 [symbol] | Wed 6/15/ [symbol] | Ad Agency, Brand Management, Co [symbol] |
| Convention 3 | 2 wks | Wed 6/1/1 [symbol] | Wed 6/15/ [symbol] | Ad Agency, Brand Management, Co [symbol] |
| Convention 4 | 2 wks | Wed 6/1/1 [symbol] | Wed 6/15/ [symbol] | Ad Agency, Brand Management, Co [symbol] |
| Special marketing Initiatives | 57 days | Wed 6/1/1 [symbol] | Fri 8/19/1 [symbol] | |
| Marketing submission | 2 days | Wed 6/1/1 [symbol] | Fri Jun. 3, 2011 | Ad Agency, Regulatory, Medical, |
| | | | | Bra [symbol] |
| Marketing comments | 10 days | Fri Jun. 3/2011 | Fri Jun. 17, 2011 | Ad Agency |
| LMR Approval submission | 8 days | Tue 6/28/1 [symbol] | Fri Jun. 8, 2011 | Ad Agency |
| LMR Approval comments | 10 days | Fri Jul. 8, 2011 | Fri Jul. 22, 2011 | Ad Agency |
| Approval submission | 0 days | Fri Jul. 22, 2011 | Fri Jul. 22, 2011 | Ad Agency, Regulatory, Medical, |
| | | | | Bra [symbol] |
| Agency Release | 4 wks | Fri Jul. 22, 2011 | Fri Aug. 19, 2011 | Ad Agency, Brand Management, Co [symbol] |

[symbol]

indicates data missing or illegible when filed

TABLE 10
WORK PORTFOLIO REPORT BY SUBJECT MATTER EXPERT

| | | | % Work |
|---|---|---|---|
| Activity Name | Start | Finish | Complete |
| Resource Names: Ad Agency, Market Research | Wed 10/3/1 [symbol] | Fri Oct. 5, 2012 | 0% |
| Revised creative brief from Agency | Wed 10/3/ [symbol] | Fri Oct. 5, 2012 | 0% |
| Resource Names: Brand Management, Ad Agency, Market Research | Fri Aug. 17, 2012 | Wed 10/3/1 [symbol] | 0% |
| Developing Positioning Options | Fri Aug. 17, 2012 | Mon 8/27/ [symbol] | 0% |
| Qualitative Positioning Research | Mon 8/27/ [symbol] | Tue 9/18/1 [symbol] | 0% |
| Quantitative Positioning Research | Tue 9/18/1 [symbol] | Wed 10/3/ [symbol] | 0% |
| Resource Names: Brand Management, Market Research | Thu Jun. 9, 2011 | Mon 10/8/1 [symbol] | 0% |
| Data Generation (Marketing) | Thu Jun. 9, 2011 | Fri Jun. 10, 2011 | 0% |
| Conduct Research, gather data and analyze the results in preparation | Mon | Thu | 0% |
| for the development of the Local Brand Plan | Jul. 30, 2012 | Aug. 16, 2012 | |
| Approvals completed | Fri Oct. 5, 2012 | Mon 10/8/ [symbol] | 0% |
| Resource Names: Brand Management, Medical Director, Market Research | Fri Jun. 10, 2011 | Tue 4/24/1 [symbol] | 0% |
| MARKET RESEARCH PROJECTS | Fri Jun. 10, 2011 | Mon 6/13/ [symbol] | 0% |
| Target Product Profile | Tue Jan. 3, 2012 | Tue 1/31/1 [symbol] | 0% |
| Patient Treatment Flow (US/Global) | Tue Jan. 3, 2012 | Tue 1/31/1 [symbol] | 0% |
| Identify Key Influencers | Tue 3/27/1 [symbol] | Tue 4/24/1 [symbol] | 0% |
| Web and Publication Research | Tue 1/31/1 [symbol] | Tue 2/28/1 [symbol] | 0% |
| Resource Names: Managed Markets, Market Research, Brand Management | Tue 1/31/1 [symbol] | Tue 3/27/1 [symbol] | 0% |
| Buying Process and Value driver customer research | Tue 1/31/1 [symbol] | Tue 3/27/1 [symbol] | 0% |
| Resource Names: Market Research | Fri Jan. 21, 2011 | Thu 6/21/1 [symbol] | 0% |
| Physician (Market) insight exploratory research forecast 2: Preferen [symbol] | Tue 1/31/1 [symbol] | Thu 3/29/1 [symbol] | 0% |
| Fielding of US research | Tue 3/27/1 [symbol] | Tue Apr. 3, 2012 | 0% |
| Debrief of US research | Thu 4/12/1 [symbol] | Fri Apr. 13, 2012 | 0% |
| Collect data and develop Global presentation | Tue 4/17/1 [symbol] | Wed 4/18/ [symbol] | 0% |
| Final Presentation | Tue 4/17/1 [symbol] | Tue 4/17/1 [symbol] | 0% |
| Segmentation/key drivers Market Research | Fri Jan. 21, 2011 | Thu 6/30/1 [symbol] | 0% |
| Physician Insight Mining | Tue 3/27/1 [symbol] | Tue 5/15/1 [symbol] | 0% |
| Physician Insight: Preference Share Drivers | Tue 1/31/1 [symbol] | Tue 3/27/1 [symbol] | 0% |
| Guide development and approval | Tue 4/17/1 [symbol] | Wed 5/30/ [symbol] | 0% |
| Fielding | Wed 5/30/ [symbol] | Wed 6/20/ [symbol] | 0% |
| Final presentation | Wed 6/20/ [symbol] | Thu 6/21/1 [symbol] | 0% |
| Unmet Needs/Attributes (seg) | Tue 1/31/1 [symbol] | Wed 2/1/1 [symbol] | 0% |
| Resource Names: Market Research, Ad Agency | Fri Jan. 21, 2011 | Fri May 10, 2013 | 0% |
| Agency development/review and approval for testing | Tue 1/31/1 [symbol] | Tue 2/14/1 [symbol] | 0% |
| Revise and finalize the creative brief | Fri Apr. 13, 2012 | Mon 4/16/ [symbol] | 0% |
| Agency begins linking concept to Pre DDMAC vis aid | Fri Mar. 8, 2013 | Tue Apr. 9, 2013 | 0% |
| Marketing submission | Tue Apr. 9, 2013 | Fri May 10, 2013 | 0% |
| Agency begins linking concept to Pre DDMAC vis aid | Fri Jan. 21, 2011 | Fri Feb. 18, 2011 | 0% |
| Marketing submission | Mon 2/21/ [symbol] | Mon 2/21/ [symbol] | 0% |
| Resource Names: Market Research, Ad Agency, Brand Management | Tue Jan. 8, 2013 | Fri Jan. 11, 2013 | 0% |
| Debrief of US Concept Testing | Tue Jan. 8, 2013 | Fri Jan. 11, 2013 | 0% |
| Resource Names: Market Research, Brand Management | Tue 3/27/1 [symbol] | Tue 6/24/1 [symbol] | 0% |
| Identify key opportunities | Tue 3/27/1 [symbol] | Tue Apr. 3, 2012 | 0% |
| Brand Reminders (File and Go) | Tue 9/17/1 [symbol] | Tue 6/24/1 [symbol] | 0% |
| Resource Names: Medical, Ad Agency, Brand Management, Market Research | Tue 9/25/1 [symbol] | Thu 10/25/1 [symbol] | 0% |
| Promotional message development | Tue 9/25/1 [symbol] | Thu 10/25/ [symbol] | 0% |
| Resource Names: Regulatory, Brand Management, Market Research | Wed 3/30/1 [symbol] | Thu 5/23/1 [symbol] | 0% |
| Submission to Regulatory for inclusion in the IPC (DDMAC) | Mon 4/22/ [symbol] | Thu 5/23/1 [symbol] | 0% |
| Submission to Regulatory for inclusion in the IPC (DDMAC) | Wed 3/30/ [symbol] | Wed 3/30/ [symbol] | 0% |
| Receive DDMAC response | Wed 6/22/ [symbol] | Wed 6/22/ [symbol] | 0% |

[symbol]

indicates data missing or illegible when filed

TABLE 11
WORK STARTING IN THE NEXT TWO WEEKS REPORT

| | | | | Resource |
|---|---|---|---|---|
| Name | Duration | Start | Finish | Names |
| Data | 1 day | Thu Jun. 9, 2011 | Fri Jun. | Brand |
| Generation | | | 10, 2011 | Management, |
| (Marketing) | | | | Market |
| | | | | Resear [symbol] |
| MARKET | 1 day | Fri Jun. 10, 2011 | Mon | Brand |
| RESEARCH | | | 6/13/ [symbol] | Management, |
| PROJECTS | | | | Medical |
| | | | | Direct [symbol] |
| Marketing | 10 days | Fri Jun. 3, 2011 | Fri Jun. | Ad Agency |
| comments | | | 17, 2011 | |

[symbol]

indicates data missing or illegible when filed

TABLE 12
SPOTLIGHT REPORT

| | | | % Work | | |
|---|---|---|---|---|---|
| Name | Start | Finish | Complete | Spotlight | Resource Names |
| Project Kickoff | Wed 6/1/1 [symbol] | Wed 6/1/1 [symbol] | 50% | [symbol] | |
| NDA submission | Wed 6/1/1 [symbol] | Wed 6/1/1 [symbol] | 50% | [symbol] | |
| Product Launch Date | Fri Jan. 21, 2011 | Fri Jan. 21, 2011 | 50% | [symbol] | |
| Establish Project Team | Wed 6/1/1 [symbol] | Wed 6/1/1 [symbol] | 50% | [symbol] | Brand Management |
| Formulate launch project sub teams | Wed 6/1/1 [symbol] | Tue 12/27/ [symbol] | 28% | | |
| Brand name | Wed 6/1/1 [symbol] | Mon 10/31 [symbol] | 20% | | |
| Brand Name Development | Wed 6/1/1 [symbol] | Wed 6/15/ [symbol] | 25% | [symbol] | Brand Management, |
| | | | | | Agency-Brand Nam [symbol] |
| Brand name Testing | Mon 8/15/ [symbol] | Mon 8/29/ [symbol] | 25% | [symbol] | Brand Management, |
| | | | | | Agency-Brand Nam [symbol] |
| Brand Name Approved for NDA Subm [symbol] | Mon 8/29/ [symbol] | Mon 8/29/ [symbol] | 25% | [symbol] | Brand Management, |
| | | | | | Executive Manager |
| Brand Name Approval | Mon 8/29/ [symbol] | Mon 10/31 [symbol] | 25% | [symbol] | FDA |
| Brand Logo development | Thu 7/28/1 [symbol] | Tue 12/27/ [symbol] | 48% | | |
| Brand Logo development | Thu 7/28/1 [symbol] | Fri Jul. 29, 2011 | 75% | [symbol] | Ad Agency |
| Agency submission | Mon 10/31 [symbol] | Mon 11/14 [symbol] | 75% | [symbol] | Ad Agency |
| Create logo | Mon 11/14 [symbol] | Mon 11/21 [symbol] | 75% | [symbol] | Ad Agency |
| Marketing comments | Mon 11/21 [symbol] | Mon 11/28 [symbol] | 75% | [symbol] | Ad Agency |
| Create Logo | Mon 11/28 [symbol] | Mon 12/5/ [symbol] | 75% | [symbol] | Ad Agency |
| LMR submission for review and appr [symbol] | Mon 12/5/ [symbol] | Tue 12/6/1 [symbol] | 75% | [symbol] | Ad Agency |

[symbol]

indicates data missing or illegible when filed

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product, such as, for example, a scientific modeling product. It may be downloadable from a network, for example, a website, as a stand-alone product or as an add-in package for installation in an existing software application. It may also be available as a client-server software application, or as a web-enabled software application.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents.

What is claimed is:

1. A computer-implemented method for commercialization of a pharmaceutical product, the method comprising:
receiving pharmaceutical product date information by a computer;
receiving pharmaceutical product resource name information by the computer;
receiving pharmaceutical product resource allocation information by the computer;
calculating, by the computer, one or more execution dates based on the date information;
calculating, by the computer, tasks, milestones, and deliverables based on multiple stages of pharmaceutical commercialization, the one or more execution dates, the resource name information, and the resource allocation information;
calculating linkages between the tasks, the milestones, or the deliverables, wherein the linkages comprise dependencies, predecessors, or successors to schedule the commercialization of the pharmaceutical product; and
calculating, by the computer, a workflow structure using the resource name information, the tasks, the milestones, the deliverables, resource allocation information, and the date information.

2. The method of claim 1, further comprising:
customizing the tasks, the milestones, and the deliverables based on updated resource allocation information.

3. The method of claim 1, further comprising:
calculating a report, wherein the report comprises at least one of resource names, the tasks, the milestones, the deliverables, and the one or more execution dates based on a specialized pharmaceutical functional area.

4. The method of claim 3, wherein the specialized pharmaceutical functional area comprises at least one of:
brand management, sales, compliance, medical affairs, regulatory affairs, communications, managed markets, or supply chain.

5. The method of claim 3, wherein the report comprises information on a plurality of stages of the commercialization of the pharmaceutical product with a brand centric approach to the commercialization of the pharmaceutical product.

6. The method of claim 3, wherein the report comprises a visual representation of the commercialization of the pharmaceutical product depicting the current stage of the commercialization of the pharmaceutical product.

7. The method of claim 6, wherein the visual representation of the commercialization of the pharmaceutical product comprises at least one of:
a timeline, a spotlight report, a tracking Gantt chart, a current activities report, a two weeks activity report, a one-month report, a late report, a baseline compared to actual report, or a work portfolio report.

8. The method of claim 1, wherein commercialization of the pharmaceutical product comprises at least one of: launching the pharmaceutical product, pharmaceutical product strategy change, a line extension of the pharmaceutical product, or a new indication for the pharmaceutical product.

9. The method of claim 1, wherein the pharmaceutical product resource name information comprises at least one of:
project title, subproject title, product name, company name, project leader name, subproject director names, or manager names.

10. The method of claim 1, wherein the pharmaceutical product date information comprises at least one of:
a project start date, a new drug application (NDA) date, a prescription drug user fee act date (PDUFA), a product launch date, or a duration of time between two or more tasks, milestones, or deliverables.

11. The method of claim 1, further comprising:
receiving logo information or a product or launch vision statement.

12. The method of claim 1, further comprising:
receiving updated date information; and
recalculating the tasks, the milestones, or the deliverables based on the updated date information.

13. The method of claim 12, further comprising:
transmitting an updated report based on the updated date information.

14. The method of claim 13, wherein the updated report comprises at least one of:
a timeline, a spotlight report, a tracking Gantt chart, a current activities report, a two-week report, a one-month report, a late report, a baseline compared to actual report, or a work portfolio report.

15. The method of claim 1, wherein the resource allocation information comprises pharmaceutical product launch funding information, company resource information, company funding information, or company personnel information.

16. The method of claim 3, wherein the report is transmitted to one of: a marketing director, a pharmaceutical firm, a marketing firm, a consulting firm, an advertising agency, a venture capital provider, or a hedge fund provider.

17. The method of claim 1, wherein the multiple stages of pharmaceutical commercialization comprise at least one of:
recommended tasks; recommended milestones; recommended deliverables; recommended time durations; or time between the tasks, the milestones, or the deliverables.

18. The method of claim 1, wherein the tasks comprise at least one of:
develop target product profile, develop patient treatment flow, develop market map, national advisory boards, brand plan, clinical publications planning, conventions strategy, or events strategy.

19. The method of claim 1, wherein the milestones comprise at least one of:
brand name, government approval of product labeling, product launch meeting, sales force training, sales force certification, quality controlled product available for distribution, or product approval press release

20. The method of claim 1, wherein the deliverables comprise at least one of:
publications of pivotal studies, promotional visual aid, journal ads, pharmacy monograph, speaker bureau presentation deck, mechanism of action video, distribution channel sell sheets.

21. The method of claim 1, further comprising transmitting the workflow structure based on the tasks, the milestones, and the deliverables.

22. A tangible non-transitory computer-readable storage media for storing computer-executable instructions executable by processing logic, the media storing one or more instructions for steps comprising:
receiving pharmaceutical product data by a computer, wherein the pharmaceutical product data comprises information on pharmaceutical functional areas, dates, and resource name information;
calculating, by the computer, tasks, milestones, and deliverables based on multiple stages of pharmaceutical commercialization and the pharmaceutical product data;
calculating linkages between the tasks, the milestones, or the deliverables;
creating a pharmaceutical commercialization report using the tasks, the milestones, or the deliverables based on specialized pharmaceutical functional areas, wherein the pharmaceutical commercialization report comprises the multiple stages of pharmaceutical commercialization and a brand centric approach to the pharmaceutical commercialization; and
transmitting the pharmaceutical commercialization report.

23. A computer-implemented system for managing commercialization of a pharmaceutical product, the system comprising:
a storage device;
an input device configured to receive pharmaceutical product data, wherein the pharmaceutical product data comprises pharmaceutical dates and pharmaceutical product name information based on pharmaceutical functional areas;
a processor configured to:
calculate tasks, milestones, or deliverables based on multiple stages of pharmaceutical commercialization and the pharmaceutical product data;
calculate dependencies or predecessors between the tasks, the milestones, or the deliverables to execute the commercialization of the pharmaceutical product;
calculate a timeline using the tasks, the milestones, or the deliverables based on pharmaceutical dates;
calculate a pharmaceutical commercialization report using the tasks, the milestones, or the deliverables based on a stage of commercialization of the multiple stages of pharmaceutical commercialization and pharmaceutical functional area; and
an output device configured to display a visual representation of the commercialization of the pharmaceutical product depicting the stage of commercialization.
